(19) United States
(12) Patent Application Publication
(10) Pub. No.: US 2024/0130359 A1
(43) Pub. Date: Apr. 25, 2024

(54) ANTIMICROBIAL COATING COMPOSITIONS

(71) Applicant: Polaroid IP B.V., Enschede (NL)

(72) Inventors: Stephen Robert Herchen, Plymouth, MA (US); Rong-Chang Liang, Cupertino, CA (US); Christian Ewald Janssen, Recklinghausen (DE)

(73) Assignee: Polaroid IP B.V., Enschede (NL)

(21) Appl. No.: 18/373,683

(22) Filed: Sep. 27, 2023

Related U.S. Application Data
(60) Provisional application No. 63/410,722, filed on Sep. 28, 2022.

(51) Int. Cl. A01N 25/04; A01N 43/64; A01N 47/10; A01P 1/00

(52) U.S. Cl. CPC A01N 25/04; A01N 43/64; A01N 47/10; A01P 1/00

(57) ABSTRACT

Described herein are quaternary ammonium polymers and interpenetrating polymer networks and compositions thereof with broad spectrum antimicrobial properties that produce fast acting, long lasting, non-toxic and non-allergenic colorless and transparent durable surface coatings that are resistant to water and common solvents. The surface coatings are easy and cost effective to produce from readily-available materials using versatile synthesis enabling a wide range of chemical variations. They are readily applied to a wide range of surfaces and materials, and no materials leach out of the coatings.

### CROSS-REFERENCE TO RELATED APPLICATIONS

This application claims the benefit of priority to U.S. Provisional Patent Application No. 63/410,722, filed Sep. 28, 2022, which is hereby incorporated by reference herein in its entirety.

### FIELD

The embodiments of the present disclosure relate to broad spectrum antimicrobial coating compositions and methods of using the same. More specifically, embodiments of the present disclosure relate to quaternary ammonium polymer structures and formulations with broad spectrum antibacterial and antiviral properties.

### BACKGROUND

Infectious diseases including influenza kill millions of people globally per year and sicken hundreds of millions. Since around 2020, the world has experienced a global COVID-19 pandemic caused by a highly transmissible novel coronavirus, severe acute respiratory syndrome coronavirus 2 (SARS-CoV-2).

The SARS-CoV-2 coronavirus and/or other viruses before it, have been shown to be transmitted from person to person as airborne droplets but may also be transmissible by touching surfaces contaminated with the virus. A 2020 study done at two major urban U.S. hospitals¹ concluded that there was a 36% decline in healthcare-associated infections when commonly touched surfaces (keyboards, countertops, railings, chairs, etc.) were coated with a disinfectant. Indeed, disinfecting surfaces was adopted as a widespread health safety practice during the COVID-19 pandemic but with limited effectiveness because antiviral coatings become ineffective after a short time requiring costly and labor-intensive frequent re-application.

Over the years, there have been numerous antimicrobial polymers developed in an attempt to provide more effective antibacterial/antiviral surface coatings. A recent review by Jarach et al. (2020)² highlights some of the different polymer approaches to this problem. These polymers include nanoparticles with attached or adsorbed drugs, nanoparticles with embedded antiviral metals, naturally occurring polymers such as chitosan, silica particles with adsorbed quaternary ammonium salts and quaternary polyethyleneimines (PEIs).

Desirable antimicrobial surface coatings would have the following properties: (i) broad spectrum antimicrobial activity at a low Minimum Inhibition Concentration (MIC); (ii) fast acting; (iii) long lasting; (iv) non-toxic and nonallergenic; (v) no materials leaching out of the coating; (vi) acceptable color, transparency and appearance as a surface coating; (vii) easy application to a wide range of surfaces and materials; (viii) durability and resistance to water, alcohol and common solvents; and (ix) easy and cost effective to produce.

As appreciated by the inventors of the present application, conventional antimicrobial surface coatings lack many of the above-listed characteristics. Accordingly, there is a need for improved antimicrobial surface coating compositions.

### SUMMARY

The embodiments of the present technology provide water-based quaternary ammonium polymeric coating formulations that can be applied to a wide range of surfaces to render them broadly antimicrobial. Unlike conventional coatings, the water-based coatings disclosed herein (i) exhibit broad spectrum antimicrobial activity at a low Minimum Inhibition Concentration (MIC); (ii) are fast acting; (iii) long lasting; (iv) non-toxic and nonallergenic; (v) have no materials leaching out of the coating; (vi) have acceptable color, transparency and appearance as a surface coating; (vii) are easy to apply to a wide range of surfaces and materials; (viii) produce durable surface coatings that are resistant to water, alcohol and common solvents; and (ix) are easy and cost-effective to produce.

In one aspect, described herein is a use of a reactive low molecular-weight quaternary ammonium salt comprising a long-chain hydrophobic group that renders the salt with high surface activity and emulsification efficacy in water. Upon reacting the reactive quaternary ammonium salt with a multifunctional crosslinker (such as a polyisocyanate) and optionally an oligomeric polyol and/or chain extender, the resultant reaction mixture becomes readily emulsifiable in water with excellent emulsion stability, particularly in the presence of a water-soluble polymer as a protective colloid. The resultant emulsion can be coated or sprayed onto a variety of surfaces or substrates while the chain extension or crosslinking reactions are continuing in the oil phase to form a highly durable antimicrobial coating after the film is dried and optionally post-cured. In some embodiments, the reactive low molecular-weight quaternary ammonium salt comprises a long-chain hydrophobic group on a nitrogen of the quaternary ammonium salt.

In another aspect, described herein is a use of a reactive water-soluble protective colloid that forms an interpenetration network with the antimicrobial polymers in the oil phase to further improve the durability of the resultant coating.

In another aspect, described herein is a use of a surface-active polyol in the oil phase to further improve the emulsion stability, reduce the particle size of the resultant emulsion, and improve the coating quality.

In another aspect, described herein is a use of a blocking agent to protect the reaction product of the reactive surface-active quaternary ammonium salt with the multifunctional crosslinker before the emulsification step to further improve the emulsion stability and processability or green-time of the emulsion. The blocking agent is de-blocked optionally in the presence of a catalyst or sensitizer, by for example, heat or radiation during or after the drying and/or post curing steps to obtain a durable coating.

The antimicrobial efficiency of organic solvent-based antimicrobial coatings generally decreases with an increasing crosslinking density of the coating. A high degree of crosslinking is often required for acceptable coating properties including durability and resistance against organic solvents, alcohol, water, detergent and various disinfection solutions and processes. Unfortunately, the bioactive functional group in the organic solvent-based coatings tends to be trapped in the crosslinking network when the degree of crosslinking is high. Unlike such organic solvent-based antimicrobial coatings, the high surface activity of the reactive quaternary ammonium salt of the present technology allows the bioactive functional group including quaternary ammonium group to diffuse to the interface of the emulsion droplet, and in turn the surface of the resultant coating. As a result, durable coatings with desirable physical and chemical properties as well as a high antimicrobial efficiency can be achieved at the same time through use of the present technology.

In an aspect, an antimicrobial composition is provided comprising an oil-in-water emulsion, the oil-in-water emulsion comprising (i) an oil phase comprising a first adduct of a first multifunctional crosslinker and a first quaternary ammonium salt, wherein the first quaternary ammonium salt has a reactive linking group to react with the first multifunctional crosslinker; optionally a polyol; a polyethyleneimine intermediate, or a second adduct of the polyethyleneimine intermediate and a second multifunctional crosslinker; and optionally a third multifunctional crosslinker; and (ii) an aqueous phase comprising a water-soluble polymer, wherein the polyethyleneimine intermediate comprises optionally substituted hydroxyalkylene functionality that reacts with the first adduct and, if present, the second multifunctional crosslinker; and nitrogen atoms present in the polyethyleneimine intermediate are at least partially quaternized.

In an aspect, the water-soluble polymer is crosslinked with (a) the first multifunctional crosslinker as incorporated in the first adduct; (b) when present, the second multifunctional crosslinker as incorporated in the second adduct; (c) when present, the third multifunctional crosslinker; or (d) any combination of two or more thereof.

In an aspect, the first quaternary ammonium salt has a chemical structure of

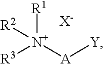

wherein
R¹ is selected from a group consisting of —(C₈-C₃₀ alkyl), —(C₈-C₃₀ heteroalkyl), —(C₈-C₃₀ heteroalkyl)-(C₆-C₁₀ aryl), —(C₆-C₁₀ aryl), —(C₆-C₁₀ aryl)-(C₈-C₃₀ alkyl), —(C₆-C₁₀ aryl)-(C₈-C₃₀ heteroalkyl), —(CR^{m}Rⁿ)ₓ₁₀—W¹⁰—(CR^{p}R^{q})_{y10}—H, and —(CR^{m}Rⁿ)ₓ₁₁—W¹¹-(CR^{p}R^{q})_{y11}H—; wherein —(C₈-C₃₀ heteroalkyl), —(C₈-C₃₀ heteroalkyl)-(C₆-C₁₀ aryl), and —(C₆-C₁₀ aryl)-(C₈-C₃₀ heteroalkyl) have 1 to 4 heteroatoms independently selected from O, S, and Si;
R² is selected from a group consisting of —(C₁-C₄ alkyl), —(C₁-C₄ heteroalkyl), —(C₁-C₄ heteroalkyl)-(C₆-C₁₀ aryl), —(C₆-C₁₀ aryl), —(C₆-C₁₀ aryl)-(C₁-C₄ alkyl), —(C₆-C₁₀ aryl)-(C₁-C₄ heteroalkyl), —(CR^{m}Rⁿ)ₓ₂₀—W²⁰—(CR^{p}R^{q})_{y20}—H, and —(CR^{m}Rⁿ)ₓ₂₁—W²¹—(CR^{p}R^{q})_{y21}—H; wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 2 heteroatoms independently selected from O, S, and Si;
R³ is selected from a group consisting of —(C₁-C₃₀ alkyl), —(C₁-C₃₀ heteroalkyl), —(C₁-C₃₀ heteroalkyl)-(C₆-C₁₀ aryl), —(C₆-C₁₀ aryl), —(C₆-C₁₀ aryl)-(C₁-C₃₀ alkyl), —(C₆-C₁₀ aryl)-(C₁-C₃₀ heteroalkyl); —(CR^{m}Rⁿ)ₓ₃₀—W³⁰—(CR^{p}R^{q})_{y30}—H, and —(CR^{m}Rⁿ)ₓ₃₁—W³¹—(CR^{p}R^{q})_{y31}—H; wherein —(C₁-C₃₀ heteroalkyl), —(C₁-C₃₀ heteroalkyl)-(C₆-C₁₀ aryl), and —(C₆-C₁₀ aryl)-(C₁-C₃₀ heteroalkyl) have 1 to 4 heteroatoms independently selected from O, S, and Si;
A is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m}Rⁿ)ₓ₄₀—W⁴⁰—(CR^{p}R^{q})_{y40}—, and —(CR^{m}Rⁿ)ₓ₄₁—W⁴¹—(CR^{p}R^{q})_{y41}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m}, Rⁿ, R^{p}, and R^{q} is independently selected from H and C₁-C₄ alkyl; W¹⁰, W²⁰, W³⁰ and W⁴⁰ are independently selected from —C(O)—; —C(O)O—; —OC(O)—; —C(O)NH—; and —NHC(O)—;
W¹¹, W²¹, W³¹ and W⁴¹ are independently selected from 5- to 6-membered cycloalkyl, C₆-C₁ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x10 is an integer from 1 to 30 and y10 is an integer from 0 to 29, wherein 8≤(x10+y10)≤30;
x11 is an integer from 1 to 30 and y11 is an integer from 0 to 29, wherein 8≤(x11+y11)≤30;
x20 is an integer from 1 to 4 and y20 is an integer from 0 to 3, wherein x20+y20≤4;
x21 is an integer from 1 to 4 and y21 is an integer from 0 to 3, wherein x21+y21≤4;
x30 is an integer from 1 to 30 and y30 is an integer from 0 to 29, wherein x30+y30≤30;
x31 is an integer from 1 to 30 and y31 is an integer from 0 to 29, wherein x31+y31≤30;
x40 is an integer from 1 to 19 and y40 is an integer from 1 to 19, wherein 3≤(x40+y40)≤20;
x41 is an integer from 1 to 20, and y41 is an integer from 0 to 19, wherein 3≤(x41+y41)≤20;
Y is selected from a group consisting of —OH, —NHR⁴, —SH, —CO₂H, —C(O)NHR⁴, —C(S)NHR⁴,

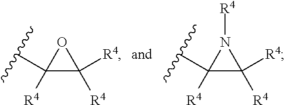

each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

In an aspect, R¹ is selected from a group consisting of —(C₁₂-C₃₀ alkyl), —(C₁₂-C₃₀ heteroalkyl), —(C₁₂-C₃₀ alkyl)-(C₆-C₁₀ aryl), —(C₁₂-C₃₀ heteroalkyl)-(C₆-C₁₀ aryl), —(C₆-C₁₀ aryl)-(C₁₂-C₃₀ alkyl), and —(C₆-C₁₀ aryl)-(C₁₂-C₃₀ heteroalkyl); wherein —(C₁₂-C₃₀ heteroalkyl), —(C₁₂-C₃₀ heteroalkyl)-(C₆-C₁₀ aryl), and —(C₆-C₁₀ aryl)-(C₁₂-C₃₀ heteroalkyl) have 1 to 4 heteroatoms independently selected from O, S, and Si.

In an aspect, R³ is selected from a group consisting of —(C₁-C₄ alkyl), —(C₁-C₄ heteroalkyl), —(C₁-C₄ alkyl)-(C₆-C₁₀ aryl), —(C₁-C₄ heteroalkyl)-(C₆-C₁₀ aryl), —(C₆-C₁₀ aryl)-(C₁-C₄ alkyl), and —(C₆-C₁₀ aryl)-(C₁-C₄ heteroalkyl); wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 4 heteroatoms independently selected from O, S, and Si.

In an aspect, R² and R³ are methyl.

In an aspect, A is —(CH₂)ₘ— or —(CH₂CHR⁵—O—)ₙCH₂CHR⁵—, wherein m is an integer from 2 to 20; n is 0, 1, 2, 3, 4, or 5; and each R⁵ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

In an aspect, each R⁵ is independently H or methyl.

In an aspect, the first quaternary ammonium salt is

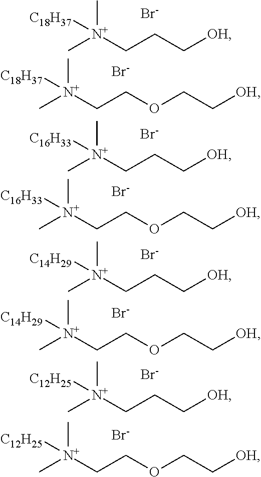

or a combination of two or more thereof.

In an aspect, the first quaternary ammonium salt is present in the oil phase in an amount of about 1% to about 50% by weight based on the dry weight of the oil phase.

In an aspect, the first quaternary ammonium salt is present in the oil phase in an amount of about 5% to about 25% by weight based on the dry weight of the oil phase.

In an aspect, the first multifunctional crosslinker, incorporated into the first adduct, is present in the oil phase in an amount of about 2% to about 25% by weight based on the dry weight of the oil phase.

In an aspect, the first multifunctional crosslinker, incorporated into the first adduct, is present in the oil phase in an amount of about 5% to about 20% by weight based on the dry weight of the oil phase.

In an aspect, the second multifunctional crosslinker, incorporated into the second adduct, is present in the oil phase in an amount of about 0.1% to about 10% by weight based on the dry weight of the oil phase.

In an aspect, the second multifunctional crosslinker, incorporated into the second adduct, is present in the oil phase in an amount of about 2% to about 8% by weight based on the dry weight of the oil phase

In an aspect, the third multifunctional crosslinker is present in the oil phase in an amount of about 0.1% to about 20% by weight based on the dry weight of the oil phase.

In an aspect, the third multifunctional crosslinker is present in the oil phase in an amount of about 2% to about 15% by weight based on the dry weight of the oil phase.

In an aspect, the first multifunctional crosslinker is a first polyisocyanate; the second multifunctional crosslinker, when present, is a second polyisocyanate; the third multifunctional crosslinker, when present, is a third polyisocyanate; and the first polyisocyanate, the second polyisocyanate, and the third polyisocyanate are different.

In an aspect, the first multifunctional crosslinker is a first polyisocyanate; the second multifunctional crosslinker, when present, is a second polyisocyanate; the third multifunctional crosslinker, when present, is a third polyisocyanate; and the first polyisocyanate, the second polyisocyanate, and the third polyisocyanate are the same.

In an aspect, each of the first, second, and third polyisocyanates has an average isocyanate functionality of 2 to 5.

In an aspect, each of the first, second, and third polyisocyanates has an average isocyanate functionality of 3 to 4.

In an aspect, each of the first, second, and third polyisocyanates is prepared from a diisocyanate independently selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In an aspect, each of the first, second, and third polyisocyanates is independently selected from a group consisting of DESMODUR® N-3300, DESMODUR® N-100, DESMODUR® Z4470SN, WANNATE® T series polyisocyanates, and LUPRANATE® M series polyisocyanates.

In an aspect, the first adduct has an average isocyanate functionality of 2 to 3.

In an aspect, the first adduct has an average isocyanate functionality of about 2.05 to about 2.3.

In an aspect, reactive isocyanate functionality on the first adduct is protected with a blocking agent.

In an aspect, the blocking agent is selected from a group consisting of oximes, phenols, malonates, alcohols, lactams, dicarbonyl compounds, hydroxamates, bisulfite addition compounds, hydroxylamines, esters of p-hydroxybenzoic acid and salicylic acid.

In an aspect, the blocking agent is selected from a group consisting of acetone oxime, methyl ethyl ketone oxime, sodium bisulfite, diethyl malonate, and 3,5-dimethylpyrazole.

In an aspect, the antimicrobial composition further comprising a de-blocking agent.

In an aspect, the de-blocking agent is selected from a group consisting of organotin, organobismuth, and tert-amines.

In an aspect, the first adduct is present in the oil phase in an amount of about 5% to about 70% by weight based on the dry weight of the oil phase.

In an aspect, the second adduct is present in the oil phase in an amount of about 1% to about 30% by weight based on the dry weight of the oil phase.

In an aspect, the second adduct is present in the oil phase in an amount of about 3% to about 15% by weight based on the dry weight of the oil phase.

In an aspect, the oil phase further comprises an organic solvent or diluent.

In an aspect, the organic solvent or diluent in the oil phase is water miscible.

In an aspect, the organic solvent or diluent is acetone.

In an aspect, the organic solvent or diluent is present in the oil phase in an amount of about 5% to about 35% by weight based on the weight of the oil phase.

In an aspect, the organic solvent or diluent is present in the oil phase in an amount of about 10% to about 30% by weight based on the weight of the oil phase.

In an aspect, the polyol, when present, is selected from a group consisting of polyether polyols, polyester polyols, polyacrylic polyols, polymethacrylic polyols, polycaprolactone polyols, polybutadiene polyols, poly(acrylonitrile-co-butadiene) polyols, polysiloxane polyols, a copolymer of any two or more thereof, and a combination of any two or more thereof.

In an aspect, the polyol is selected from a group consisting of poly(tetramethylene glycol), polyethylene glycol, polypropylene glycol, poly(ethylene glycol-b-propylene glycol-b-ethylene glycol), and poly(propylene glycol-b-polyethylene glycol-b-propylene glycol).

In an aspect, the polyol has a weight average molecular weight from about 300 to about 3000.

In an aspect, the polyol has a weight average molecular weight from about 400 to about 2000.

In an aspect, the polyol has a weight average molecular weight from about 600 to about 1500.

In an aspect, the polyol is present in the oil phase in an amount of about 1% to about 40% by weight based on the dry weight of the oil phase.

In an aspect, the polyol is present in the oil phase in an amount of about 5% to about 25% by weight based on the dry weight of the oil phase.

In an aspect, the water-soluble polymer is selected from a group consisting of hydroxyethyl cellulose (HEC), hydroxypropyl cellulose, polyvinyl alcohol, poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyacrylamide, polyethyleneimine intermediate, a copolymer of two or more thereof, a copolymer of one or more thereof with polyvinylpyrrolidone poly(glycidyl acrylate) or with poly(glycidyl methacrylate), and a combination or blend of two or more thereof.

In an aspect, the water-soluble polymer is hydroxyethyl cellulose or a hydrophobically modified derivative thereof.

In an aspect, the water-soluble polymer is a polyethyleneimine intermediate.

In an aspect, the water-soluble polymer is present in the aqueous phase in amount of about 0.5% to about 15% by weight of the dry weight of the oil phase.

In an aspect, the water-soluble polymer is present in the aqueous phase in amount of about 3% to about 12% by weight of the dry weight of the oil phase.

In an aspect, the water-soluble polymer is present in the aqueous phase in amount of about 5% to about 10% by weight of the dry weight of the oil phase.

In an aspect, the aqueous phase further comprises a surfactant.

In an aspect, the surfactant is a non-ionic surfactant.

In an aspect, the non-ionic surfactant has an average HLB (hydrophilic-lipophilic balance) value of about 12 to about 15.

In an aspect, the non-ionic surfactant is selected from TRITON™ X-114 ((1,1,3,3-tetramethylbutyl)phenyl-polyethylene glycol), SILWET™ L-7604 (siloxane polyalkyleneoxide copolymer), and a combination thereof.

In an aspect, the surfactant is present in the aqueous phase in an amount of about 0.05% to about 2% by weight based on the dry weight of the oil phase.

In an aspect, the surfactant is present in the aqueous phase in an amount of about 0.1% to about 1% by weight based on the dry weight of the oil phase.

In an aspect, the aqueous phase further comprises a defoamer or antifoamer.

In an aspect, the defoamer is FOAMSTAR® ST 2410 (star polymer-based defoamer).

In an aspect, a random polymer or interpenetrating polymer network is produced from random polymerization/crosslinking of the first adduct; the polyethyleneimine intermediate or the second adduct; when present, the polyol; the water-soluble polymer, if reactive; and, when present, the third multifunctional crosslinker.

In an aspect, the oil phase further comprises a third adduct of the first multifunctional crosslinker and a second quaternary ammonium salt

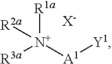

wherein R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m1}Rⁿ¹)ₓ₄₂—W⁴²—(CR^{p1}R^{q1})_{y42}-, and —(CR^{m1}Rⁿ¹)ₓ₄₃—W⁴³—(CR^{p1}R^{q1})_{y43}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a},

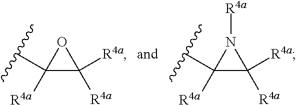

each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

In an aspect, the oil phase further comprises a third adduct of a fourth multifunctional crosslinker and a second quaternary ammonium salt

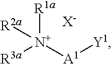

wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m1}Rⁿ¹)ₓ₄₂—W⁴²—(CR^{p1}R^{q1})_{y42}-, and —(CR^{m1}Rⁿ¹)ₓ₄₃—W⁴³—(CR^{p1}R^{q1})_{y43}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a},

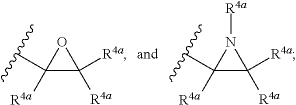

each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

In an aspect, the fourth multifunctional crosslinker is different from the first multifunctional crosslinker and, when present, from the second multifunctional crosslinker, and, when present, from the third multifunctional crosslinker.

In an aspect, the fourth polyisocyanate is present in the oil phase in an amount of about 0.1% to about 15% by weight based on the dry weight of the oil phase.

In an aspect, the fourth multifunctional crosslinker is a fourth polyisocyanate.

In an aspect, the fourth polyisocyanate has an average isocyanate functionality of 2 to 5.

In an aspect, the fourth polyisocyanate is prepared from a diisocyanate selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In an aspect, the fourth polyisocyanate is selected from a group consisting of DESMODUR® N-3300, DESMODUR® N-100, DESMODUR® Z4470SN, WANNATE® T series polyisocyanates, and LUPRANATE® M series polyisocyanates.

In an aspect, the second quaternary ammonium salt is

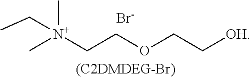

In an aspect, the second quaternary ammonium salt is present in the oil phase in an amount of about 1% to about 15% by weight based on the dry weight of the oil phase.

In an aspect, the second quaternary ammonium salt is present in the oil phase in an amount of about 3% to about 10% by weight based on the dry weight of the oil phase.

In an aspect, the third adduct has an average isocyanate functionality of 2 to 3.

In an aspect, the third adduct has an average isocyanate functionality of about 2.05 to about 2.3.

In an aspect, the third adduct is present in the oil phase in an amount of about 2% to about 30% by weight based on the dry weight of the oil phase.

In an aspect, reactive isocyanate functionality on the third adduct is protected with a blocking agent.

In an aspect, the blocking agent for the reactive isocyanate functionality on the third adduct is selected from a group consisting of oximes, phenols, malonates, alcohols, lactams, dicarbonyl compounds, hydroxamates, bisulfite addition compounds, hydroxylamines, esters of p-hydroxybenzoic acid and salicylic acid.

In an aspect, the blocking agent for the reactive isocyanate functionality on the third adduct is selected from a group consisting of acetone oxime, methyl ethyl ketone oxime, sodium bisulfite, diethyl malonate, and 3,5-dimethylpyrazole.

In an aspect, a random polymer or interpenetrating polymer network is produced from random polymerization/crosslinking of the first adduct; the polyethyleneimine intermediate or the second adduct; the third adduct; when present, the polyol; the water-soluble polymer, if reactive; and, when present, the third multifunctional crosslinker.

In an aspect, the oil phase further comprises a chain extender selected from a group consisting of HO—(CₙH₂ₙ)—OH and HO—(CₙH₂ₙ₋₂)—OH, or a combination thereof, wherein n is an integral between 2 and 8.

In an aspect, the chain extender is propanediol, 1,4-butanediol, neopentyl glycol, hexanediol, cyclohexane dimethanol, or a combination of two or more thereof.

In an aspect, the chain extender is present in the oil phase in an amount of up to about 10% by weight based on the dry weight of the oil phase.

In an aspect, the chain extender is present in the oil phase in an amount of about 0.5% to about 10% by weight based on the dry weight of the oil phase.

In an aspect, a random polymer or interpenetrating polymer network is produced from random polymerization/crosslinking of the first adduct; the polyethyleneimine intermediate or the second adduct; when present, the third adduct; when present, the polyol; the chain extender; the water-soluble polymer, if reactive; and, when present, the third multifunctional crosslinker.

In an aspect, the polyethyleneimine intermediate is present in the oil phase in an amount of about 0.1% to about 50% by weight based on the dry weight of the oil phase.

In an aspect, the hydroxyalkylene functionality is optionally substituted with C₁-C₆ alkyl optionally substituted with a substituent selected from —N⁺(R²⁰)₃X⁻, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); and each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In an aspect, the hydroxyalkylene functionality is hydroxyethylene, hydroxypropylene, hydroxybutylene, or an oligomer thereof.

In an aspect, the polyethyleneimine intermediate comprises a reaction product of reagents comprising a polyethyleneimine, a mono-epoxide, and an alkylating agent, wherein the mono-epoxide is optionally substituted with C₁-C₆ alkyl optionally substituted with a substituent selected from —(C₆-C₁₀ aryl), and —(C₁-C₆ alkoxy) optionally substituted with hydroxy, C₁-C₆ alkoxy, C₆-C₁₀ aryl optionally substituted with C₁-C₆ alkyl, and carboxy.

In an aspect, the mono-epoxide is a C₁-C₆ alkyl epoxide.

In an aspect, the C₁-C₆ alkyl epoxide is selected from the group consisting of propyl epoxide, butyl epoxide, and hexyl epoxide.

In an aspect, the polyethyleneimine intermediate comprises a reaction product of reagents comprising a polyethyleneimine, a mono-epoxide, and optionally an alkylating agent; the mono-epoxide is substituted with —(C₁-C₆ alkyl)-N⁺(R²⁰)₃X⁻; each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); and each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In an aspect, the alkylating agent comprises one or more R²¹-LG, wherein each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH; and each LG is a leaving group.

In an aspect, the alkylating agent is benzyl halide or hexyl halide.

In an aspect, the polyethyleneimine intermediate comprises a reaction product of reagents comprising a polyethyleneimine and a haloalkanol.

In an aspect, the haloalkanol is X³⁰—(C₂-C₆ alkylene)-OH, wherein X³⁰ is Cl, Br, or I.

In an aspect, the reagents for the reaction product comprised in the polyethyleneimine intermediate further comprise a monoisocyanate.

In an aspect, the monoisocyanate comprises one or more R³⁰—NCO, wherein each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently C₁-C₆ alkyl; and each R^{b} and each R^{c} are independently selected from —(C₁-C₆ alkyl) and —Si(C₁-C₆ alkyl)₃.

In an aspect, the monoisocyanate comprises octylisocyanate, octadecylisocyanate, or a combination thereof.

In an aspect, the polyethyleneimine has a molecular weight of about 300 to about 270,000 daltons.

In an aspect, the polyethyleneimine has a molecular weight of about 10,000 to about 200,000 daltons.

In an aspect, the polyethyleneimine has a molecular weight of about 25,000 to about 120,000 daltons.

In an aspect, the polyethyleneimine is branched.

In an aspect, the polyethyleneimine is hyperbranched.

In an aspect, the polyethyleneimine has a ratio of primary to secondary to tertiary amines of about 1:2:1 to about 1:1:1.

In an aspect, the polyethyleneimine has a ratio of primary to secondary to tertiary amines of about 1:1:0.7.

In an aspect, the polyethyleneimine intermediate is selected from

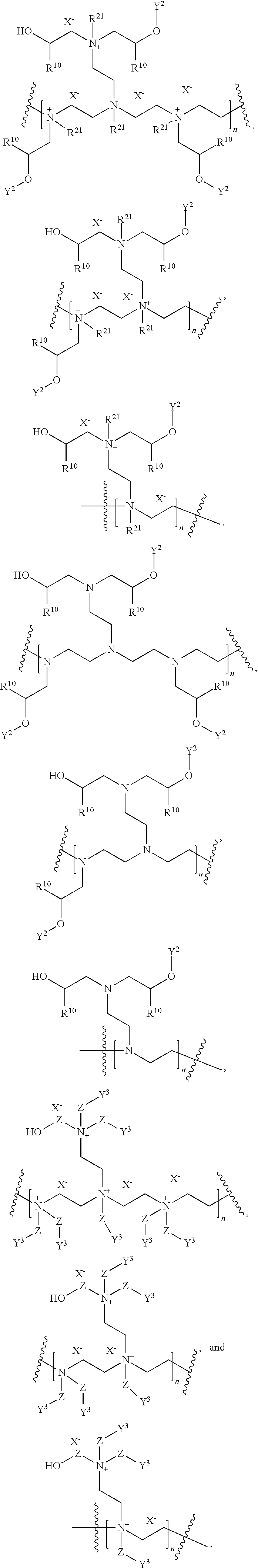

or a copolymer of any two or more thereof, wherein:
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000, preferably an integer independently selected from 10 to 1000;
Z is —(C₂-C₆ alkylene)-;
each R¹⁰ is independently selected from hydrogen; C₁-C₆ alkyl optionally substituted with a substituent selected from —N⁺(R²⁰)₃X⁻, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently —(C₁-C₆ alkyl); and each R^{b} and each R^{c} are independently selected from —(C₁-C₆ alkyl) and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy, then the polyethyleneimine intermediate is selected from

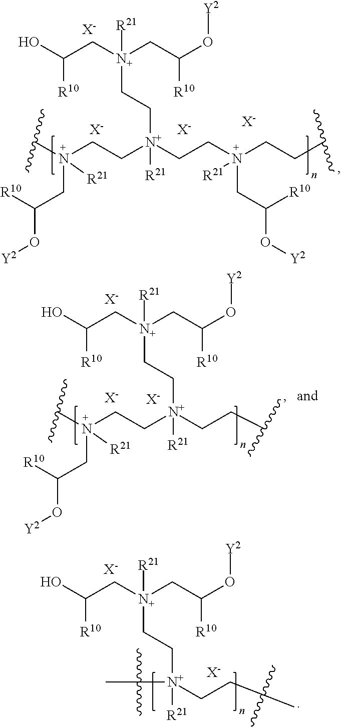

In an aspect, the polyethyleneimine intermediate is

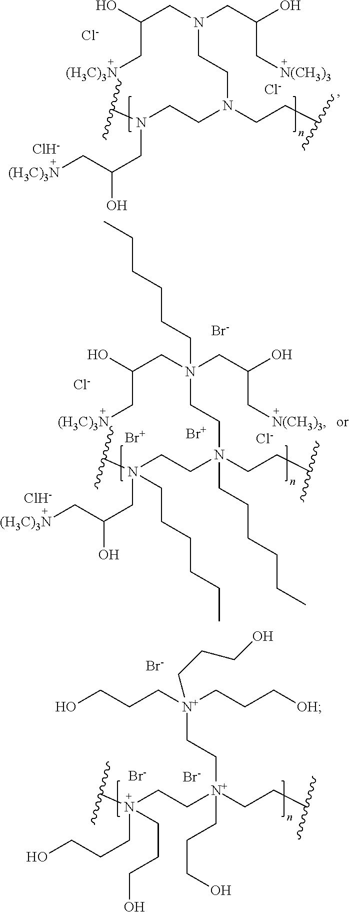

wherein each n is an integer independently selected from 1 to 3000, preferably an integer independently selected from 10 to 1000.

In an aspect, at least 20% of the nitrogen atoms of the polyethyleneimine intermediate are quaternized.

In an aspect, the second adduct is of formula (I):

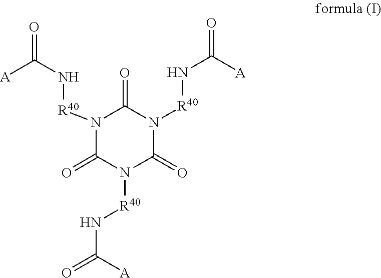

wherein:
each A is independently selected from

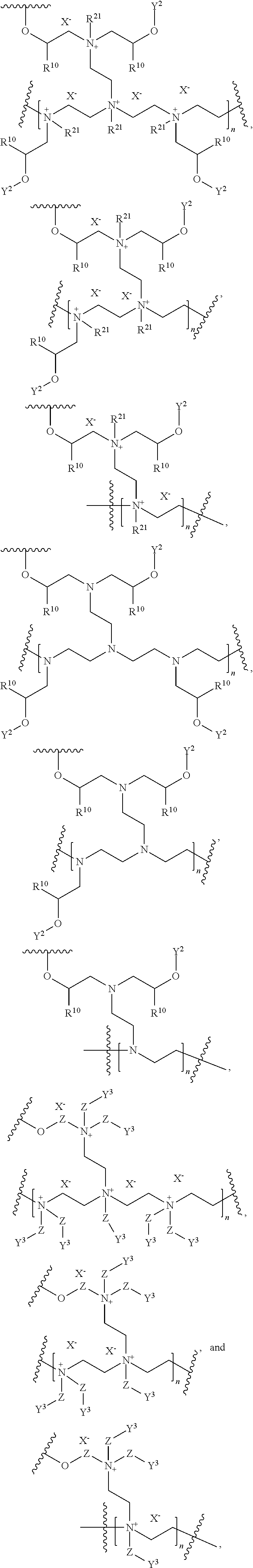

or a copolymer of any two or more thereof; and attachment of each A forms a carbamate linkage;
each Y³ is independently H or —O—Y², wherein every Y³ cannot be H
each Y² is independently H or —C(O)—NHR³⁰, wherein every Y² cannot be —C(O)—NHR³⁰;
each n is an integer independently selected from 1 to 3000, preferably an integer independently selected from 10 to 1000;
Z is —(C₂-C₆ alkylene)-;
each R¹⁰ is independently selected from hydrogen; C₁-C₆ alkyl optionally substituted with a substituent selected from —N⁺(R²⁰)₃X⁻, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3)

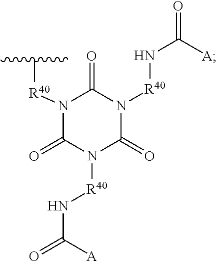

wherein
each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy, then each A is independently selected from

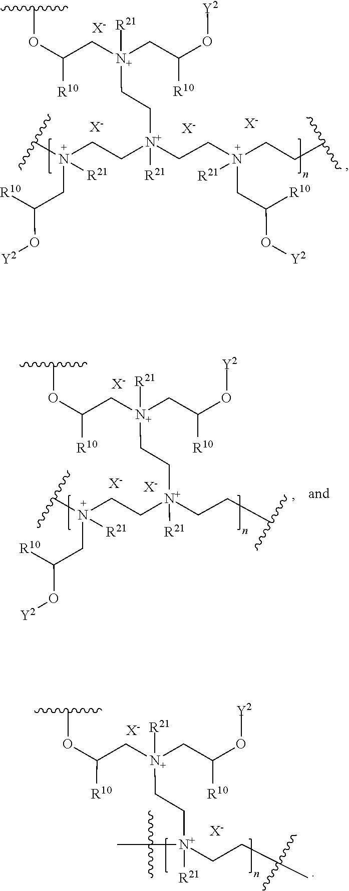

In an aspect, the second adduct is of formula (II):

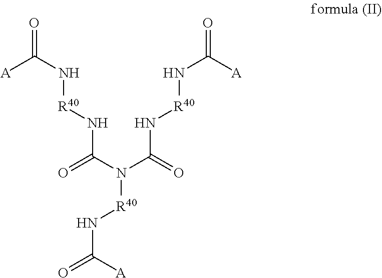

wherein:
each A is independently selected from

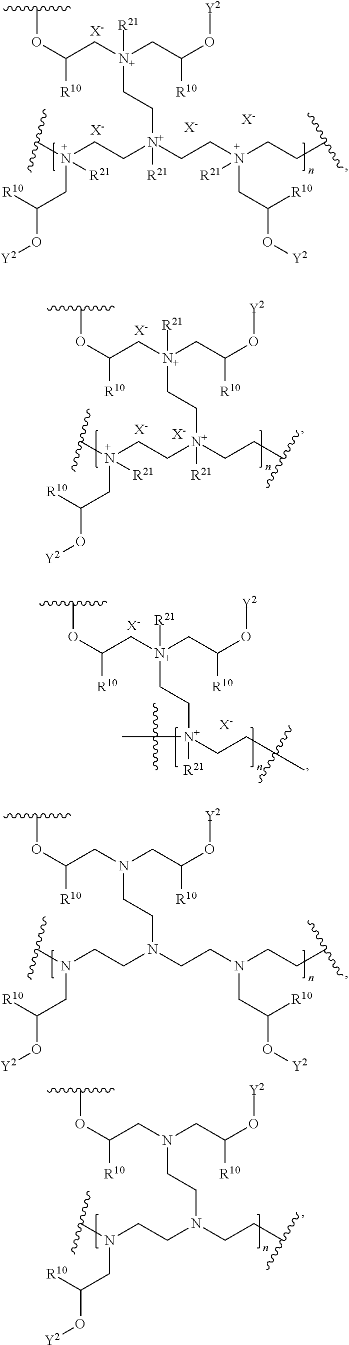

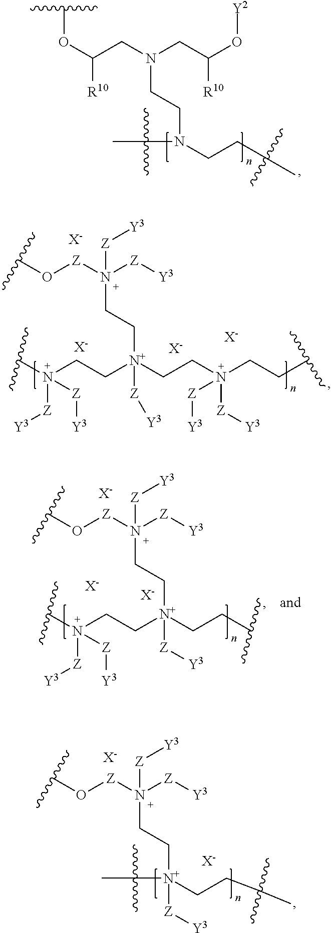

or a copolymer of any two or more thereof; and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰; each n is an integer independently selected from 1 to 3000, preferably an integer independently selected from 10 to 1000;
Z is —(C₂-C₆ alkylene)-;
each R¹⁰ is independently selected from hydrogen; C₁-C₆ alkyl optionally substituted with a substituent selected from —N⁺(R²⁰)₃X⁻, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3)

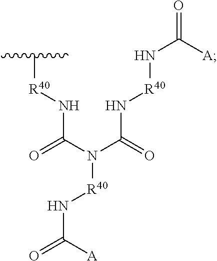

wherein
each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy, then each A is independently selected from

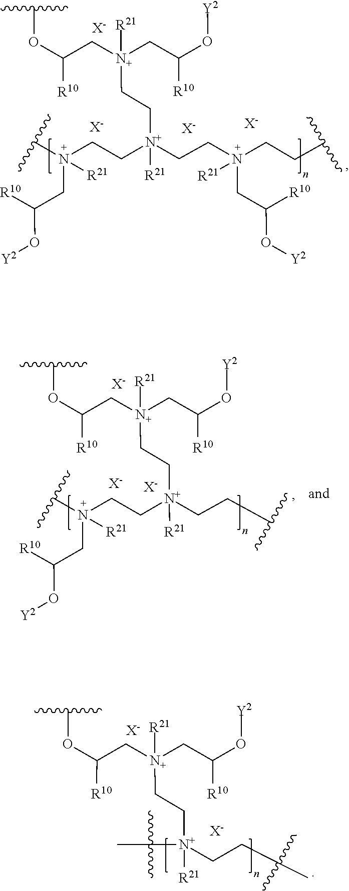

A polymer or interpenetrating polymer network is provided comprising a random polymerization/crosslinking product of reagents comprising (i) a first adduct of a first multifunctional crosslinker and a first quaternary ammonium salt; (ii) a polyol; (iii) a polyethyleneimine intermediate or a second adduct of the polyethyleneimine intermediate and a second multifunctional crosslinker; and (iv) optionally a third multifunctional crosslinker.

In an aspect, in the polymer or interpenetrating polymer network, the first quaternary ammonium salt has a chemical structure of

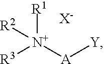

wherein
R¹ is selected from a group consisting of —(C₈-C₃₀ alkyl), —(C₈-C₃₀ heteroalkyl), —(C₈-C₃₀ heteroalkyl)-(C₆-C₁₀ aryl), —(C₆-C₁₀ aryl), —(C₆-C₁₀ aryl)-(C₈-C₃₀ alkyl), —(C₆-C₁₀ aryl)-(C₈-C₃₀ heteroalkyl), —(CR^{m}Rⁿ)ₓ₁₀—W¹⁰—(CR^{p}R^{q})_{y10}—H, and —(CR^{m}Rⁿ)ₓ₁₁—W¹¹—(CR^{p}R^{q})_{y11} H—; wherein —(C₈-C₃₀ heteroalkyl), —(C₈-C₃₀ heteroalkyl)-(C₆-C₁₀ aryl), and —(C₆-C₁₀ aryl)-(C₈-C₃₀ heteroalkyl) have 1 to 4 heteroatoms independently selected from O, S, and Si;
R² is selected from a group consisting of —(C₁-C₄ alkyl), —(C₁-C₄ heteroalkyl), —(C₁-C₄ heteroalkyl)-(C₆-C₁₀ aryl), —(C₆-C₁₀ aryl), —(C₆-C₁₀ aryl)-(C₁-C₄ alkyl), —(C₆-C₁₀ aryl)-(C₁-C₄ heteroalkyl); —(CR^{m}Rⁿ)ₓ₂₀—W²⁰—(CR^{p}R^{q})_{y20}—H, and —(CR^{m}Rⁿ)ₓ₂₁—W²¹—(CR^{p}R^{q})_{y21}—H; wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 4 heteroatoms independently selected from O, S, and Si;
R³ is selected from a group consisting of —(C₁-C₃₀ alkyl), —(C₁-C₃₀ heteroalkyl), —(C₁-C₃₀ heteroalkyl)-(C₆-C₁₀ aryl), —(C₆-C₁₀ aryl), —(C₆-C₁₀ aryl)-(C₁-C₃₀ alkyl), —(C₆-C₁₀ aryl)-(C₁-C₃₀ heteroalkyl), —(CR^{m}Rⁿ)ₓ₃₀—W³⁰—(CR^{p}R^{q})_{y30}—H, and —(CR^{m}Rⁿ)ₓ₃₁—W³¹—(CR^{p}R^{q})_{y31}—H; wherein —(C₁-C₃₀ heteroalkyl), —(C₁-C₃₀ heteroalkyl)-(C₆-C₁₀ aryl), and —(C₆-C₁₀ aryl)-(C₁-C₃₀ heteroalkyl) have 1 to 4 heteroatoms independently selected from O, S, and Si;
A is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m}Rⁿ)ₓ₄₀—W⁴⁰—(CR^{p}R^{q})_{y40}—, and —(CR^{m}Rⁿ)ₓ₄₁—W⁴¹—(CR^{p}R^{q})_{y41}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m}, Rⁿ, R^{p}, and R^{q} is independently selected from H and C₁-C₄ alkyl;
W¹⁰, W²⁰, W³⁰ and W⁴⁰ are independently selected from —C(O)—; —C(O)O—; —OC(O)—; —C(O)NH—; and —NHC(O)—;
W¹¹, W²¹, W³¹, and W⁴¹ are independently selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x10 is an integer from 1 to 30 and y10 is an integer from 0 to 29, wherein 8≤(x10+y10)≤30;
x11 is an integer from 1 to 30 and y11 is an integer from 0 to 29, wherein 8≤(x11+y11)≤30;
x20 is an integer from 1 to 4 and y20 is an integer from 0 to 3, wherein x20+y20≤4;
x21 is an integer from 1 to 4 and y21 is an integer from 0 to 3, wherein x21+y21≤4;
x30 is an integer from 1 to 30 and y30 is an integer from 0 to 29, wherein x30+y30≤30;
x31 is an integer from 1 to 30 and y31 is an integer from 0 to 29, wherein x31+y31≤30;
x40 is an integer from 1 to 19 and y40 is an integer from 1 to 19, wherein 3≤(x40+y40)≤20;
x41 is an integer from 1 to 20, and y41 is an integer from 0 to 19, wherein 3≤(x41+y41)≤20; Y is selected from a group consisting of —OH, —NHR⁴, —SH, —CO₂H, —C(O)NHR⁴, —C(S)NHR⁴,

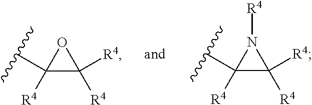

each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

In an aspect of the polymer or interpenetrating polymer network, R¹ is selected from a group consisting of —(C₁₂-C₃₀ alkyl), —(C₁₂-C₃₀ heteroalkyl), —(C₁₂-C₃₀ alkyl)-(C₆-C₁₀ aryl), —(C₁₂-C₃₀ heteroalkyl)-(C₆-C₁₀ aryl), —(C₆-C₁₀ aryl)-(C₁₂-C₃₀ alkyl), and —(C₆-C₁₀ aryl)-(C₁₂-C₃₀ heteroalkyl); wherein —(C₁₂-C₃₀ heteroalkyl), —(C₁₂-C₃₀ heteroalkyl)-(C₆-C₁₀ aryl), and —(C₆-C₁₀ aryl)-(C₁₂-C₃₀ heteroalkyl) have 1 to 4 heteroatoms independently selected from O, S, and Si.

In an aspect of the polymer or interpenetrating polymer network, R³ is selected from a group consisting of —(C₁-C₄ alkyl), —(C₁-C₄ heteroalkyl), —(C₁-C₄ alkyl)-(C₆-C₁₀ aryl), —(C₁-C₄ heteroalkyl)-(C₆-C₁₀ aryl), —(C₆-C₁₀ aryl)-(C₁-C₄ alkyl), and —(C₆-C₁₀ aryl)-(C₁-C₄ heteroalkyl); wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 4 heteroatoms independently selected from O, S, and Si.

In an aspect of the polymer or interpenetrating polymer network, R² and R³ are methyl.

In an aspect of the polymer or interpenetrating polymer network, A is —(CH₂)ₘ— or —(CH₂CHR⁵—O—)ₙCH₂CHR⁵—, wherein m is an integer from 2 to 20; n is 0, 1, 2, 3, 4, or 5; and each R⁵ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

In an aspect of the polymer or interpenetrating polymer network, R⁵ is H or methyl.

In an aspect of the polymer or interpenetrating polymer network, the first quaternary ammonium salt is

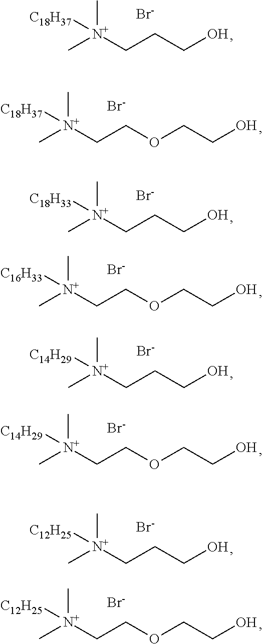

or a combination of two or more thereof.

In an aspect of the polymer or interpenetrating polymer network, the first quaternary ammonium salt is present in the dried polymer or interpenetrating polymer network in an amount of about 1 wt. % to about 50 wt. %.

In an aspect of the polymer or interpenetrating polymer network, the first multifunctional crosslinker is a first polyisocyanate; the second multifunctional crosslinker, when present, is a second polyisocyanate; the third multifunctional crosslinker, when present, is a third polyisocyanate; and the first polyisocyanate, the second polyisocyanate, and the third polyisocyanate are different.

In an aspect of the polymer or interpenetrating polymer network, the first multifunctional crosslinker is a first polyisocyanate; the second multifunctional crosslinker, when present, is a second polyisocyanate; the third multifunctional crosslinker, when present, is a third polyisocyanate; and the first polyisocyanate, the second polyisocyanate, and the third polyisocyanate are the same.

In an aspect of the polymer or interpenetrating polymer network, each of the first, second, and third polyisocyanates has an average isocyanate functionality of 2 to 5.

In an aspect of the polymer or interpenetrating polymer network, each of the first, second, and third polyisocyanates has an average isocyanate functionality of 3 to 4.

In an aspect of the polymer or interpenetrating polymer network, each of the first, second, and third polyisocyanates is prepared from a diisocyanate independently selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In an aspect of the polymer or interpenetrating polymer network, each of the first, second, and third polyisocyanates is independently selected from a group consisting of DESMODUR® N-3300, DESMODUR® N-100, DESMODUR® Z4470SN, WANNATE® T series polyisocyanates, and LUPRANATE® M series polyisocyanates.

In an aspect of the polymer or interpenetrating polymer network, the first multifunctional crosslinker is present in the dried polymer or interpenetrating polymer network in an amount of about 2 wt. % to about 25 wt. %.

In an aspect of the polymer or interpenetrating polymer network, the second multifunctional crosslinker is present in the dried polymer or interpenetrating polymer network in an amount of about 0.1 wt. % to about 10 wt. %.

In an aspect of the polymer or interpenetrating polymer network, the third multifunctional crosslinker is present in the dried polymer or interpenetrating polymer network in an amount of about 0.1 wt. % to about 20 wt. %.

In an aspect of the polymer or interpenetrating polymer network, the first adduct has an average isocyanate functionality of 2 to 3.

In an aspect of the polymer or interpenetrating polymer network, the first adduct has an average isocyanate functionality of about 2.05 to about 2.3.

In an aspect of the polymer or interpenetrating polymer network, the polyol is selected from a group consisting of polyether polyols, polyester polyols, polyacrylic polyols, polymethacrylic polyols, polycaprolactone polyols, polybutadiene polyols, poly(acrylonitrile-co-butadiene) polyols, polysiloxane polyols, a copolymer of any two or more thereof, and a combination of any two or more thereof.

In an aspect of the polymer or interpenetrating polymer network, the polyol is selected from a group consisting of poly(tetramethylene glycol), polyethylene glycol, polypropylene glycol, poly(ethylene glycol-b-propylene glycol-b-ethylene glycol), and poly(propylene glycol-b-polyethylene glycol-b-propylene glycol).

In an aspect of the polymer or interpenetrating polymer network, the polyol has a weight average molecular weight from about 300 to about 3000.

In an aspect of the polymer or interpenetrating polymer network, the polyol has a weight average molecular weight from about 400 to about 2000.

In an aspect of the polymer or interpenetrating polymer network, the polyol has a weight average molecular weight from about 600 to about 1500.

In an aspect of the polymer or interpenetrating polymer network, the polyol is present in the dried polymer or interpenetrating polymer network in an amount of about 1 wt. % to about 40 wt. %.

In an aspect of the polymer or interpenetrating polymer network, the reagents further comprise a third adduct of the first multifunctional crosslinker and a second quaternary ammonium salt

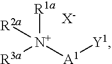

wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m}Rⁿ)ₓ₄₂—W⁴²—(CR^{p1}R^{q1})_{y42}-, and —(CR^{m1}Rⁿ¹)ₓ₄₃—W³—(CR^{p1}R^{g1})_{y43}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a},

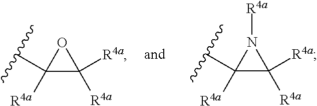

each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

In an aspect of the polymer or interpenetrating polymer network, the reagents further comprise a third adduct of a fourth multifunctional crosslinker and a second quaternary ammonium salt

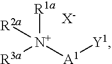

wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m}Rⁿ)ₓ₄₂—W⁴²—(CR^{p1}R^{q1})_{y42}-, and —(CR^{m1}Rⁿ¹)ₓ₄₃—W⁴³—(CR^{p1}R^{q1})_{y43}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20; Y¹ is selected from a group consisting of —OH, —NHR^{4a}, —SH, —CO₂H, —C(O)NHR^{4a}, —C(S)NHR^{4a},

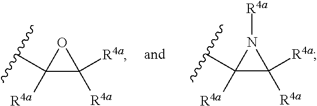

each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

In an aspect, the fourth multifunctional crosslinker is present in the dried polymer or interpenetrating polymer network in an amount of about 0.1 wt. % to about 15 wt. %.

In an aspect of the polymer or interpenetrating polymer network, the fourth multifunctional crosslinker is different from the first multifunctional crosslinker and, when present, from the second multifunctional crosslinker, and, when present, from the third multifunctional crosslinker.

In an aspect of the polymer or interpenetrating polymer network, the fourth multifunctional crosslinker is a fourth polyisocyanate.

In an aspect of the polymer or interpenetrating polymer network, the fourth polyisocyanate is prepared from a diisocyanate selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In an aspect of the polymer or interpenetrating polymer network, the fourth polyisocyanate is selected from the group consisting of DESMODUR® N-3300, DESMODUR® N-100, DESMODUR® Z4470SN, WANNATE® T series polyisocyanates, and LUPRANATE® M series polyisocyanates.

In an aspect of the polymer or interpenetrating polymer network, the second quaternary ammonium salt is

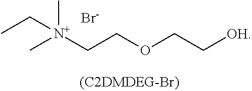

In an aspect of the polymer or interpenetrating polymer network, the second quaternary ammonium salt is present in the dried polymer or interpenetrating polymer network in an amount of about 1 wt. % to about 15 wt. %.

In an aspect of the polymer or interpenetrating polymer network, the third adduct has an average isocyanate functionality of 2 to 3.

In an aspect of the polymer or interpenetrating polymer network, the third adduct has an average isocyanate functionality of about 2.05 to about 2.3.

In an aspect of the polymer or interpenetrating polymer network, the third adduct is present in the dried polymer or interpenetrating polymer network in an amount of about 2 wt. % to about 30 wt. %

In an aspect of the polymer or interpenetrating polymer network, the polyethyleneimine intermediate is present in the dried polymer or interpenetrating polymer network in an amount of about 0.1 wt. % to about 50 wt. %.

In an aspect of the polymer or interpenetrating polymer network, the polyethyleneimine intermediate comprises optionally substituted hydroxyalkylene functionality that reacts with the first adduct and, if present, the second multifunctional crosslinker.

In an aspect of the polymer or interpenetrating polymer network, hydroxyalkylene functionality is optionally substituted with C₁-C₆ alkyl optionally substituted with a substituent selected from —N⁺(R²⁰)₃X⁻, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); and each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In an aspect of the polymer or interpenetrating polymer network, the hydroxyalkylene functionality is hydroxyethylene, hydroxypropylene, hydroxybutylene, or an oligomer thereof.

In an aspect of the polymer or interpenetrating polymer network, the polyethyleneimine intermediate comprises a reaction product of reagents comprising a polyethyleneimine, a mono-epoxide, and an alkylating agent, wherein the mono-epoxide is optionally substituted with C₁-C₆ alkyl optionally substituted with a substituent selected from —(C₆-C₁₀ aryl), and —(C₁-C₆ alkoxy) optionally substituted with hydroxy, C₁-C₆ alkoxy, C₆-C₁₀ aryl optionally substituted with C₁-C₆ alkyl, and carboxy.

In an aspect of the polymer or interpenetrating polymer network, the mono-epoxide is a C₁-C₆ alkyl epoxide.

In an aspect of the polymer or interpenetrating polymer network, the C₁-C₆ alkyl epoxide is selected from the group consisting of propyl epoxide, butyl epoxide, and hexyl epoxide.

In an aspect of the polymer or interpenetrating polymer network, the polyethyleneimine intermediate comprises a reaction product of reagents comprising a polyethyleneimine, a mono-epoxide, and optionally an alkylating agent; the mono-epoxide is substituted with —(C₁-C₆ alkyl)-N⁺(R²⁰)₃X⁻; each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); and each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In an aspect of the polymer or interpenetrating polymer network, the alkylating agent comprises one or more R²¹-LG, wherein each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH; and each LG is a leaving group.

In an aspect of the polymer or interpenetrating polymer network, the alkylating agent is benzyl halide or hexyl halide.

In an aspect of the polymer or interpenetrating polymer network, the polyethyleneimine intermediate comprises a reaction product of reagents comprising a polyethyleneimine and a haloalkanol.

In an aspect of the polymer or interpenetrating polymer network, the haloalkanol is X³⁰—(C₂-C₆ alkylene)-OH, wherein X³⁰ is Cl, Br, or I.

In an aspect of the polymer or interpenetrating polymer network, the reagents for the reaction product comprised in the polyethyleneimine intermediate further comprise a monoisocyanate.

In an aspect of the polymer or interpenetrating polymer network, the monoisocyanate comprises one or more R³⁰—NCO, wherein each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently C₁-C₆ alkyl; and each R^{b} and each R^{c} are independently selected from —(C₁-C₆ alkyl) and —Si(C₁-C₆ alkyl)₃.

In an aspect of the polymer or interpenetrating polymer network, the monoisocyanate comprises octylisocyanate, octadecylisocyanate, or a combination thereof.

In an aspect of the polymer or interpenetrating polymer network, the polyethyleneimine has a molecular weight of about 300 to about 270,000 daltons.

In an aspect of the polymer or interpenetrating polymer network, the polyethyleneimine has a molecular weight of about 10,000 to about 200,000 daltons.

In an aspect of the polymer or interpenetrating polymer network, the polyethyleneimine has a molecular weight of about 25,000 to about 120,000 daltons.

In an aspect of the polymer or interpenetrating polymer network, the polyethyleneimine is branched.

In an aspect of the polymer or interpenetrating polymer network, the polyethyleneimine is hyperbranched.

In an aspect of the polymer or interpenetrating polymer network, the polyethyleneimine has a ratio of primary to secondary to tertiary amines of about 1:2:1 to about 1:1:1.

In an aspect of the polymer or interpenetrating polymer network, the polyethyleneimine has a ratio of primary to secondary to tertiary amines of about 1:1:0.7.

In an aspect of the polymer or interpenetrating polymer network, the polyethyleneimine intermediate is selected from

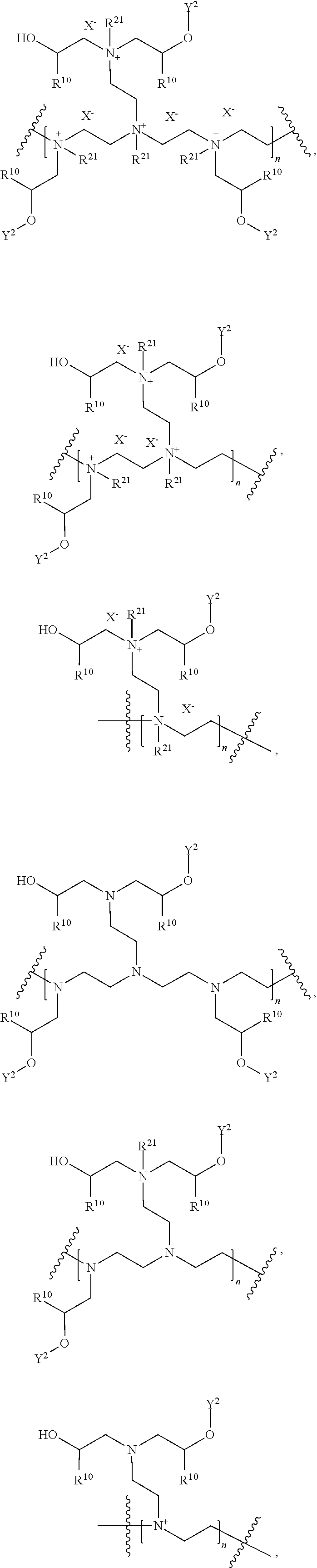

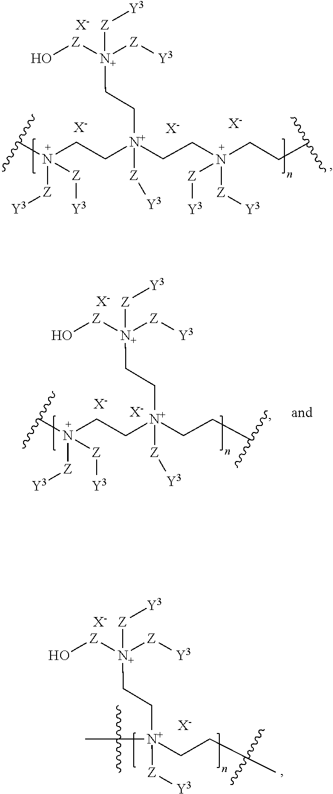

or a copolymer of any two or more thereof,
wherein:
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000, preferably an integer independently selected from 10 to 1000;
Z is —(C₂-C₆ alkylene)-;
each R¹⁰ is independently selected from hydrogen; C₁-C₆ alkyl optionally substituted with a substituent selected from —N(R²⁰)₃, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently —(C₁-C₆ alkyl); and each R^{b} and each R^{c} are independently selected from —(C₁-C₆ alkyl) and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy, then the polyethyleneimine intermediate is selected from

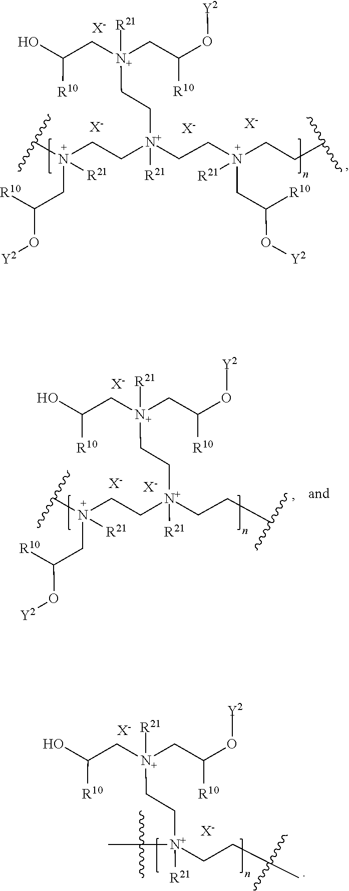

In an aspect of the polymer or interpenetrating polymer network, the polyethyleneimine intermediate is

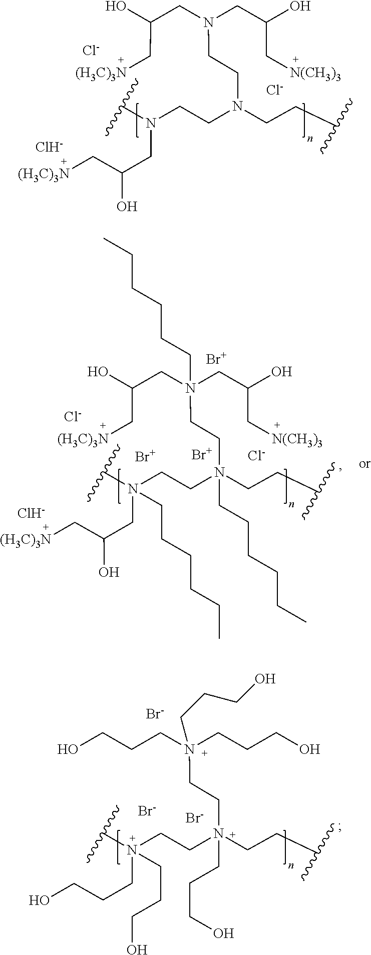

wherein each n is an integer independently selected from 1 to 3000, preferably an integer independently selected from 10 to 1000.

In an aspect of the polymer or interpenetrating polymer network, the second adduct is of formula (I):

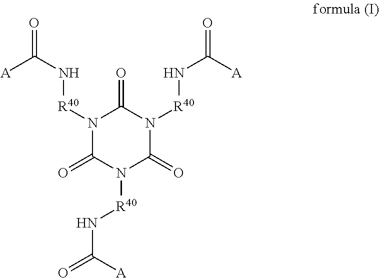

wherein
each A is independently selected from

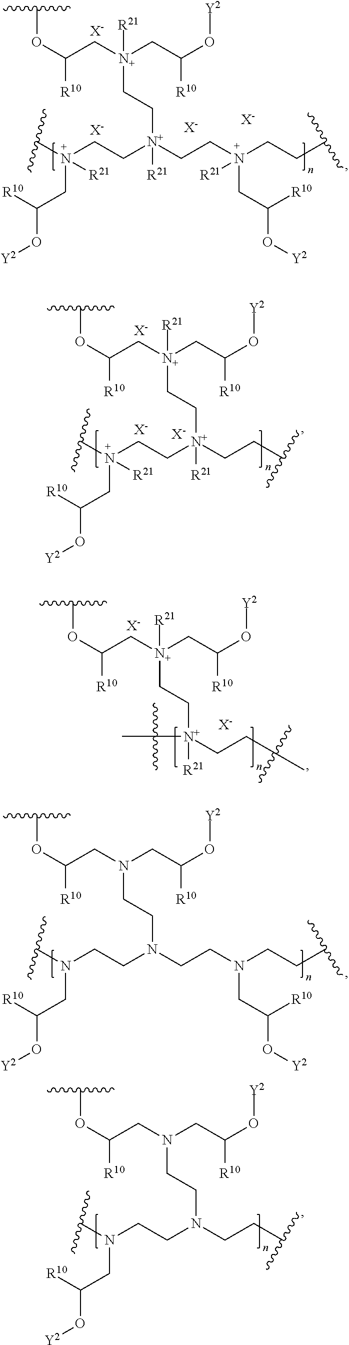

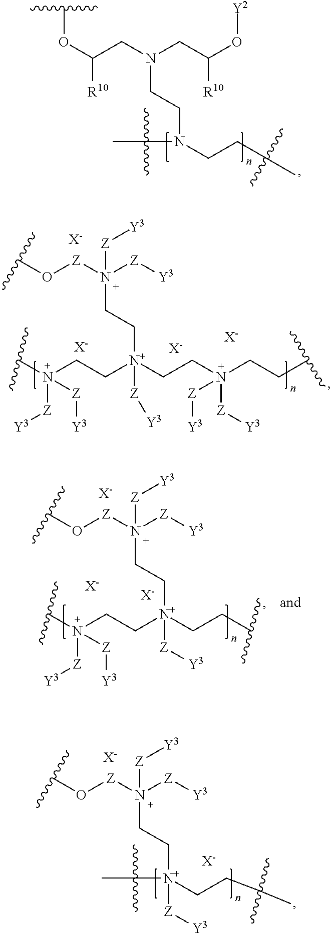

or a copolymer of any two or more thereof; and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000, preferably an integer independently selected from 10 to 1000;
Z is —(C₂-C₆ alkylene)-;
each R¹⁰ is independently selected from hydrogen; C₁-C₆ alkyl optionally substituted with a substituent selected from —N(R²⁰)₃, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3)

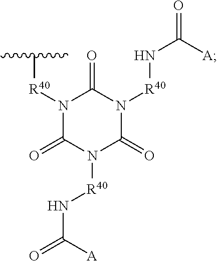

wherein each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(O₁—C₆ alkyl), and carboxy, then each A is independently selected from

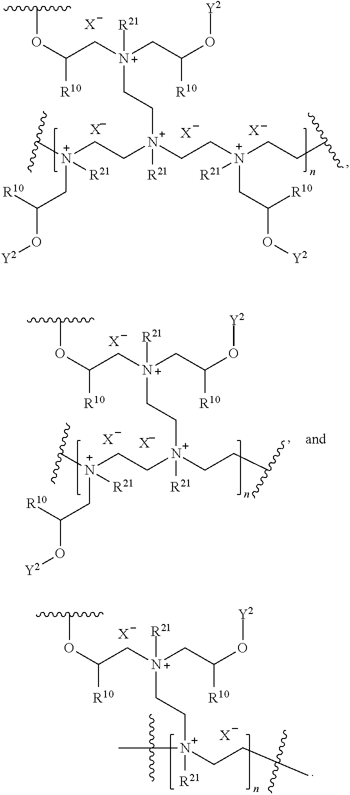

In an aspect of the polymer or interpenetrating polymer network, the second adduct is of formula (II):

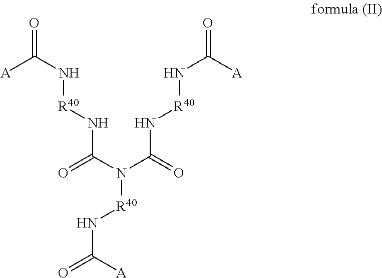

wherein:
each A is independently selected from

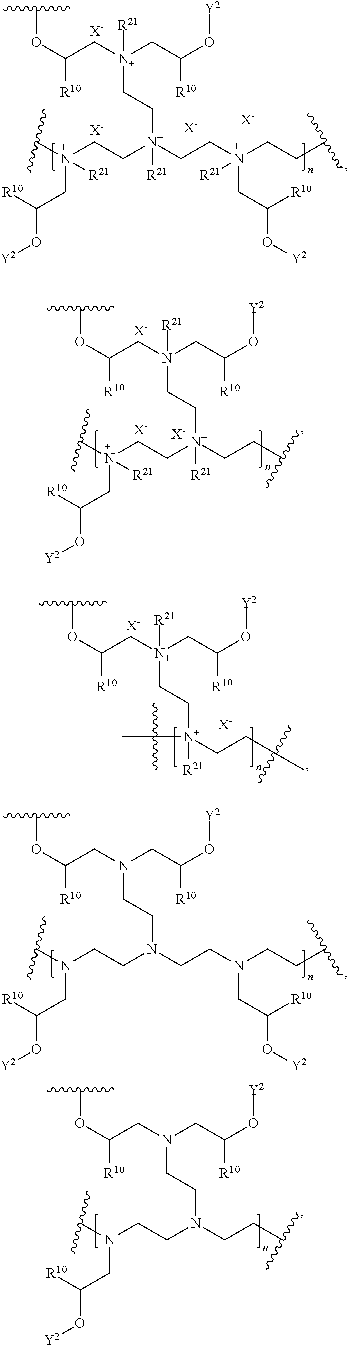

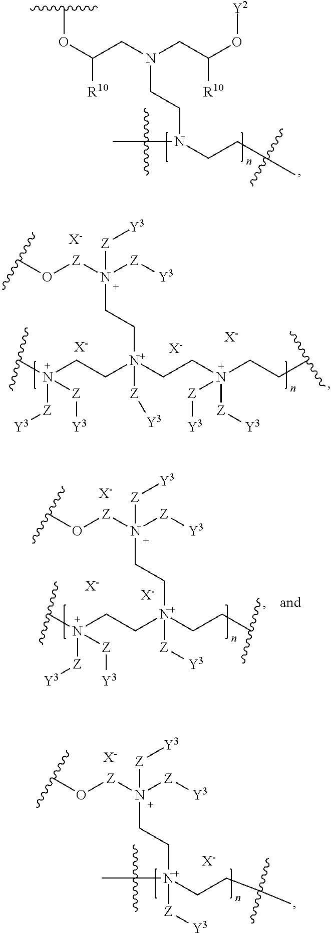

or a copolymer of any two or more thereof; and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000, preferably an integer independently selected from 10 to 1000;
Z is —(C₂-C₆ alkylene)-;
each R¹⁰ is independently selected from hydrogen; C₁-C₆ alkyl optionally substituted with a substituent selected from —N(R²⁰)₃, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3)

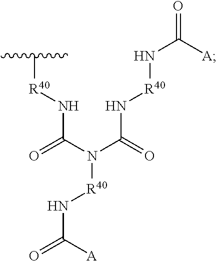

wherein
each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(O₁—C₆ alkyl), and carboxy, then each A is independently selected from

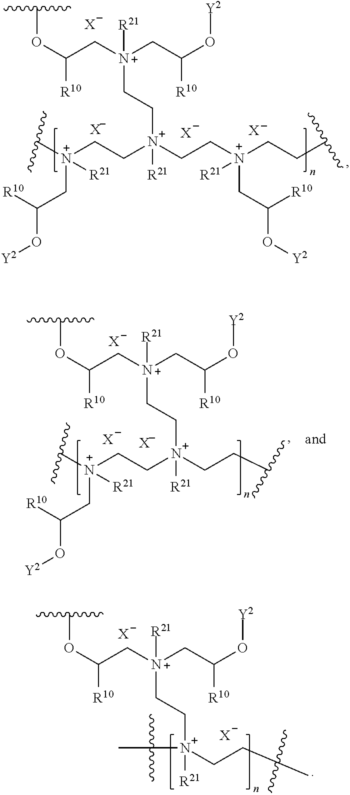

In an aspect of the polymer or interpenetrating polymer network, the second adduct is present in the dried polymer or interpenetrating polymer network in an amount of about 1 wt. % to about 30 wt. %.

In an aspect of the polymer or interpenetrating polymer network, the reagents for the random polymerization/crosslinking product comprised in the polymer or interpenetrating polymer network further comprise a water-soluble polymer.

In an aspect of the polymer or interpenetrating polymer network, the water-soluble polymer is crosslinked with (a) the first multifunctional crosslinker as incorporated in the first adduct; (b) when present, the second multifunctional crosslinker as incorporated in the second adduct; (c) when present, the third multifunctional crosslinker; or (d) any combination of two or more thereof.

In an aspect of the polymer or interpenetrating polymer network, the water-soluble polymer is present in the dried polymer or interpenetrating polymer network in an amount of about 0.5 wt. % to about 15 wt. %.

In an aspect of the polymer or interpenetrating polymer network, the water-soluble polymer is selected from a group consisting of hydroxyethyl cellulose (HEC), hydroxypropyl cellulose, polyvinyl alcohol, poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyacrylamide, polyethyleneimine intermediate, a copolymer of two or more thereof, a copolymer of one or more thereof with polyvinylpyrrolidone poly(glycidyl acrylate) or with poly(glycidyl methacrylate), and a combination or blend of two or more thereof.

In an aspect of the polymer or interpenetrating polymer network, the water-soluble polymer is hydroxyethyl cellulose or a hydrophobically modified derivative thereof.

In an aspect of the polymer or interpenetrating polymer network, the water-soluble polymer is another polyethyleneimine intermediate.

In an aspect of the polymer or interpenetrating polymer network, the reagents for the random polymerization/crosslinking product comprised in the polymer or interpenetrating polymer network further comprise a chain extender selected from a group consisting of HO—(CₙH₂ₙ)—OH and HO—(CₙH₂ₙ₋₂)—OH, or a combination thereof, wherein n is an integral between 2 and 8.

In an aspect of the polymer or interpenetrating polymer network, the chain extender is propanediol, 1,4-butanediol, neopentyl glycol, hexanediol, cyclohexane dimethanol, or a combination of two or more thereof.

In an aspect of the polymer or interpenetrating polymer network, the chain extender is present in the dried polymer or interpenetrating polymer network in an amount of about 0.5 wt. % to about 10 wt. %.

In an aspect, a composition comprising the polymer or interpenetrating polymer network as described above is provided.

In an aspect, provided is an antimicrobial compound selected from:

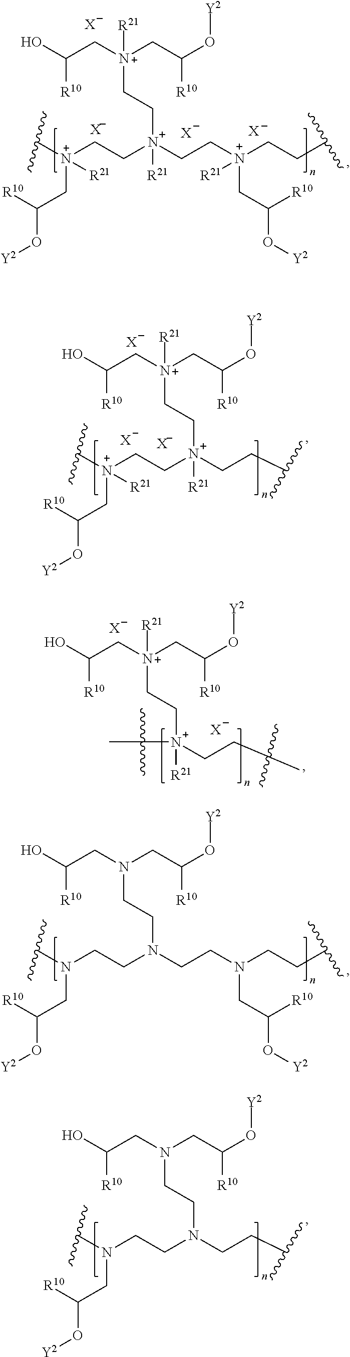

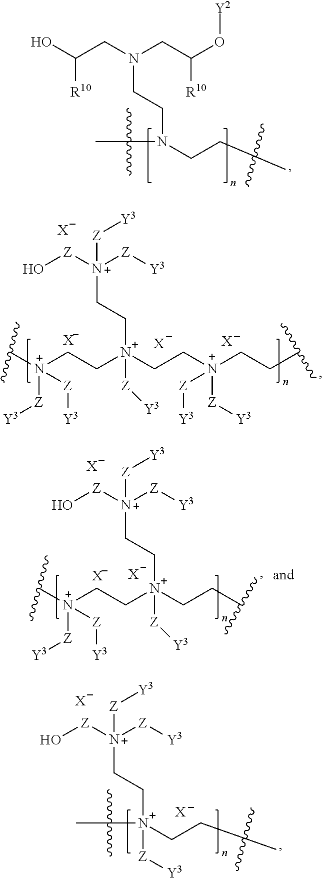

or a copolymer of any two or more thereof, wherein:
each Y³ is independently H or —O—Y², wherein every Y³ cannot be H;
each Y² is independently H or —C(O)—NHR³⁰, wherein every Y² cannot be —C(O)—NHR³⁰; each n is an integer independently selected from 1 to 3000, preferably an integer independently selected from 10 to 1000;
Z is —(C₂-C₆ alkylene)-;
each R¹⁰ is C₁-C₆ alkyl substituted with —N⁺(R²⁰)₃X⁻, and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently —(C₁-C₆ alkyl); and each R^{b} and each R^{c} are independently selected from —(C₁-C₆ alkyl) and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In an aspect, in the preceding antimicrobial compound, each Y² is H.

In an aspect, in the preceding antimicrobial compound, the compound is

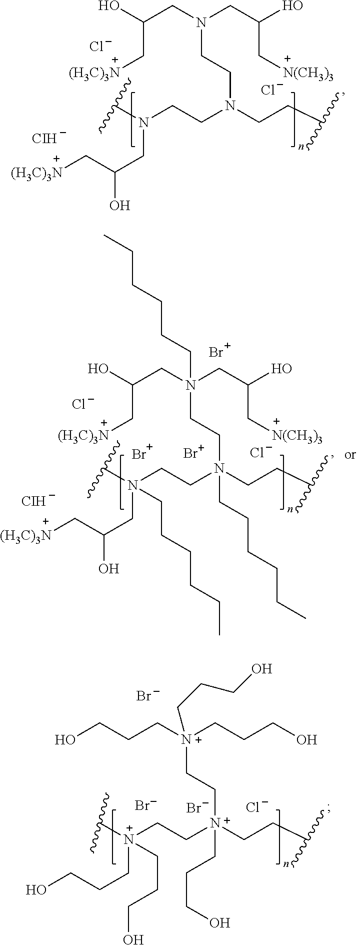

wherein each n is an integer independently selected from 1 to 3000, preferably an integer independently selected from 10 to 1000.

In an aspect, provided is a random polymerization product of a polyethyleneimine intermediate and a crosslinker, wherein the polyethyleneimine intermediate is selected from:

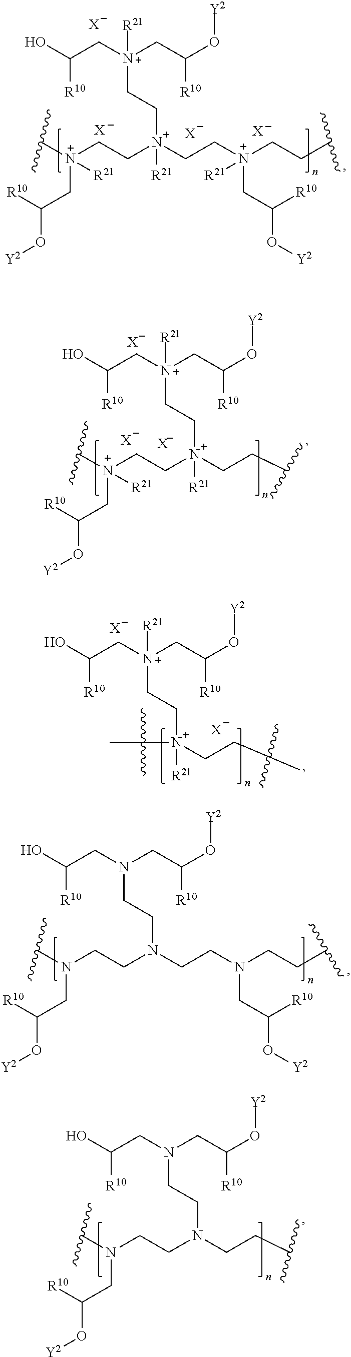

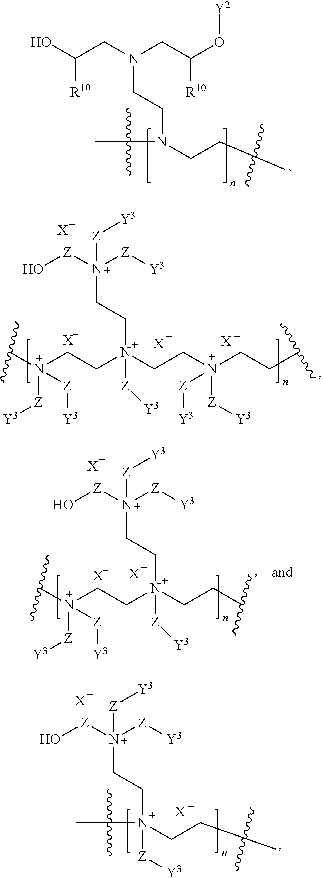

or a copolymer of any two or more thereof, wherein:
each Y³ is independently H or —O—Y², wherein every Y³ cannot be H;
each Y² is independently H or —C(O)—NHR³⁰, wherein every Y² cannot be —C(O)—NHR³⁰; each n is an integer independently selected from 1 to 3000, preferably an integer independently selected from 10 to 1000;
Z is —(C₂-C₆ alkylene)-;
each R¹⁰ is C₁-C₆ alkyl substituted with —N⁺(R²⁰)₃X⁻, and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently —(C₁-C₆ alkyl); and each R^{b} and each R^{c} are independently selected from —(C₁-C₆ alkyl) and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In an aspect of the random polymerization product, the crosslinker is a polyisocyanate.

In an aspect of the random polymerization product, the polyisocyanate is prepared from a diisocyanate independently selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In an aspect of the random polymerization product, the polyisocyanate is independently selected from a group consisting of DESMODUR® N-3300, DESMODUR® N-100, DESMODUR® Z4470SN, WANNATE® T series polyisocyanates, and LUPRANATE® M series polyisocyanates.

In an aspect of the random polymerization product, the random polymerization product is of formula (I):

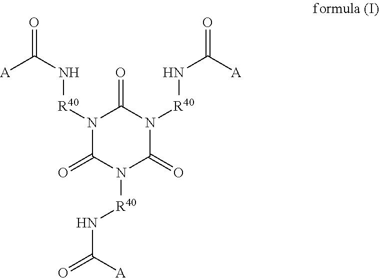

wherein:
each A is independently selected from

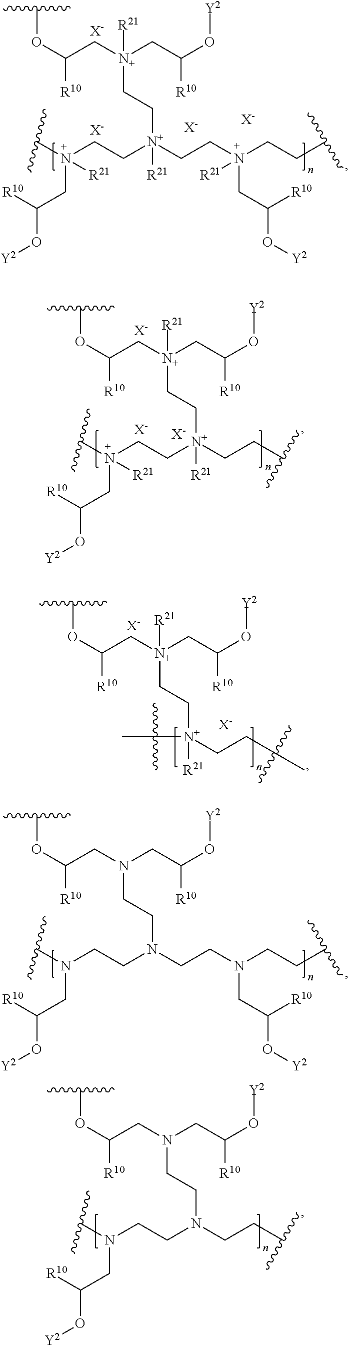

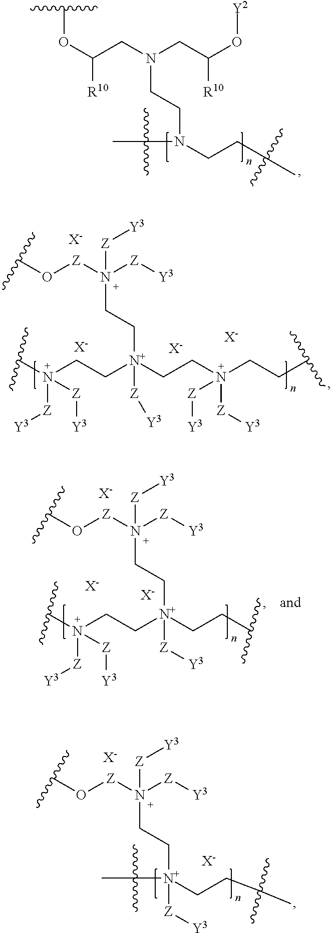

or a copolymer of any two or more thereof; and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000, preferably an integer independently selected from 10 to 1000;
Z is —(C₂-C₆ alkylene)-;
each R¹⁰ is C₁-C₆ alkyl substituted with —N⁺(R²⁰)₃X⁻, and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3)

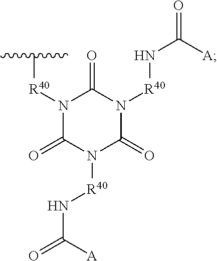

wherein
each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In an aspect of the random polymerization product, the random polymerization product is of formula (II):

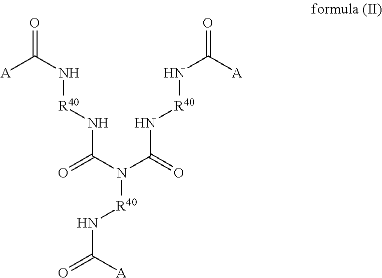

wherein:
each A is independently selected from

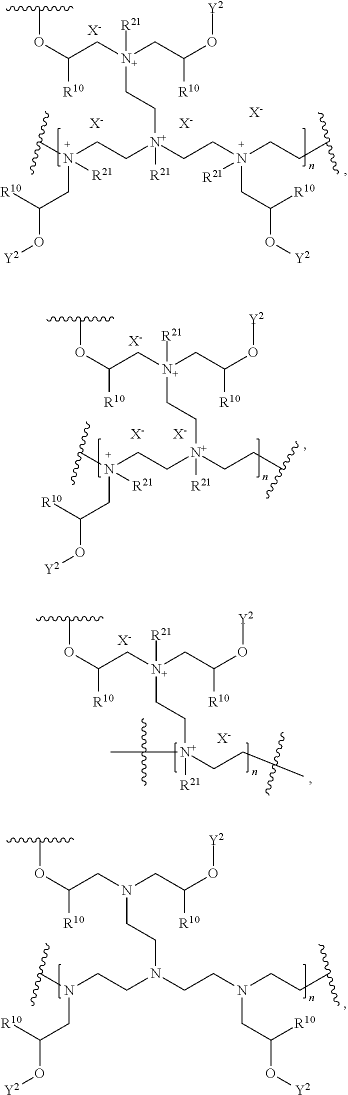

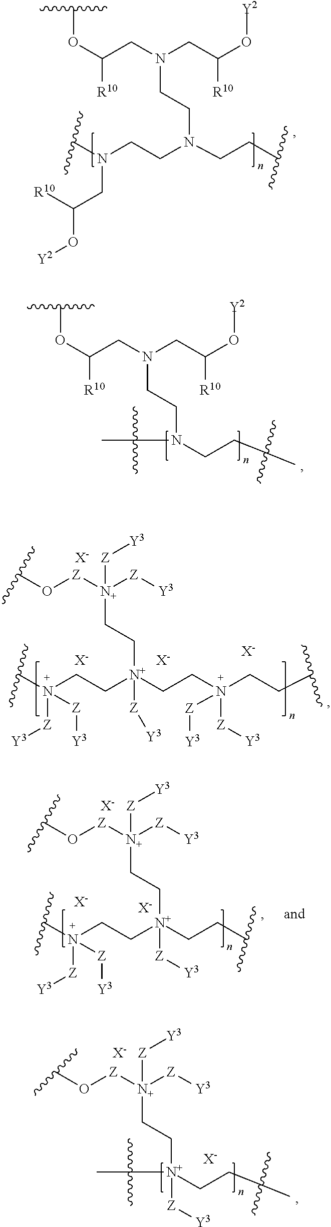

or a copolymer of any two or more thereof; and attachment of each A forms a carbamate linkage;
each Y³ is independently H or —O—Y², wherein every Y³ cannot be H
each Y² is independently H or —C(O)—NHR³⁰, wherein every Y² cannot be —C(O)—NHR³⁰;
each n is an integer independently selected from 1 to 3000, preferably an integer independently selected from 10 to 1000;
Z is —(C₂-C₆ alkylene)-;
each R¹⁰ is C₁-C₆ alkyl substituted with —N⁺(R²⁰)₃X⁻, and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3)

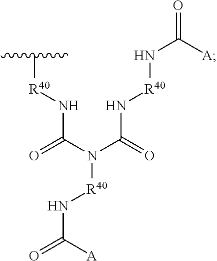

wherein each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In an aspect, provided is a composition comprising the antimicrobial compound as set forth above.

In an aspect, provided is a composition comprising the random polymerization product as set forth above.

In an aspect, provided is an antimicrobial coating, coating fluid, or spraying fluid comprising the composition set forth above.

In an aspect, provided is a device, equipment, apparatus, or accessory comprising the coating, the coating fluid or the spraying fluid set forth above.

In an aspect, in the device, the equipment, the apparatus, or the accessory, the coating fluid or spraying fluid is water soluble or water dispersible.

In an aspect, the device, equipment, apparatus, or accessory is selected from a group consisting of a filter, an air purifier, and a mask.

In an aspect, the device, equipment, apparatus, or accessory is selected from a group consisting of a keyboard, a keypad, a stylus, a mouse, a handheld device, a remote controller, a touch screen, a phone, a handheld device, and a display.

In an aspect, provided is a personal care aid comprising the coating, the coating fluid, or the spraying fluid set forth above.

In an aspect of the personal care aid, the coating fluid or the spraying fluid is water soluble or water dispersible.

In an aspect, provided is a method to sanitize a surface, the method comprising applying the composition described above.

In an aspect, provided is a method to reduce antimicrobial growth on a surface, the method comprising applying the composition described above to the surface.

In an aspect, provided is a method to prevent antimicrobial growth on a surface, the method comprising applying the composition described above to the surface.

In an aspect, provided is a method including forming a coating solution containing the composition.

In an aspect, provided is a method of using a composition described above. The use may include, for example, contacting a surface with the composition.

In an aspect, provided is a method comprising providing any of an antimicrobial coating, a coating fluid or a spraying fluid, each of the antimicrobial coating, the coating fluid or the spraying fluid comprising a composition as described above, and applying the antimicrobial coating, coating fluid or spraying fluid to a surface.

In an aspect, provided is a method including directing the coating solution to a surface, and providing a coating on the surface through the application of the coating solution to the surface.

In an aspect, provided is a polymer or interpenetrating polymer network prepared by:
(a) reacting a first multifunctional crosslinker with a first quaternary ammonium salt to form a first adduct;
(b) optionally reacting a polyethyleneimine intermediate with a second multifunctional crosslinker to form a second adduct;
(c) optionally reacting the first multifunctional crosslinker or a fourth multifunctional crosslinker with a second quaternary ammonium salt to form a third adduct;
(d) combining (i) the first adduct, (ii) the polyethyleneimine intermediate or the second adduct, and (iii) when present, the third adduct, with optionally a polyol and optionally a third multifunctional crosslinker to form an oil phase;
(e) dissolving a water-soluble polymer in water to form an aqueous phase;
(f) combining the oil phase and the aqueous phase to form an oil-in-water emulsion; and
(g) applying the emulsion onto a surface and allowing the emulsion to dry and cure on the surface to form the polymer or interpenetrating polymer network on the surface.

In an aspect, a blocking agent is added to the oil phase after step (d) but before step (f).

In an aspect, step (d) further comprises combining (i) the first adduct, (ii) the polyethyleneimine intermediate or the second adduct, and (iii) when present, the third adduct, with optionally the polyol and optionally the third multifunctional crosslinker in an organic solvent or diluent to form the oil phase.

In an aspect, step (d) further comprises adding a chain extender to the oil phase; or step (e) further comprises adding a chain extender to the aqueous phase; or a combination thereof.

In an aspect, step (e) further comprises adding a surfactant to the aqueous phase.

In an aspect, step (e) further comprises adding a defoamer or antifoamer to the aqueous phase.

In an aspect, step (e) further comprises adding a surfactant and either a defoamer or antifoamer to the aqueous phase.

In an aspect, step (f) further comprises performing a direct emulsification process whereby the emulsion is formed by vigorous shear and mixing.

In an aspect, step (f) further comprises performing a direct emulsification process whereby the emulsion is formed by sonication.

In an aspect, step (f) further comprises performing a phase inversion emulsification process whereby a water-in-oil emulsion is first prepared, followed by phase inversion to form the oil-in-water emulsion.

In an aspect, the phase inversion is conducted by changing the phase ratio, temperature, surfactant, solvent, or any combination of two or more thereof.

In another aspect, the present technology provides a personal care aid comprising any of the above-described coating, coating fluid or spraying fluid. In some embodiments, the coating fluid or spraying fluid is water soluble or water dispersible.

Other implementations are also described and recited herein.

### DETAILED DESCRIPTION

In the following description, for purposes of explanation, numerous specific details are set forth in order to provide a thorough understanding of the present technology. It may be evident, however, that the present technology may be practiced without these specific details. It is to be appreciated that certain aspects, modes, embodiments, variations and features of the technology are described below in various levels of detail in order to provide a substantial understanding of the present technology.

### Definitions

For convenience, the meaning of some terms and phrases used in the specification, examples, and appended claims, are provided below. Unless stated otherwise, or implicit from context, the following terms and phrases include the meanings provided below. The definitions are provided to aid in describing particular embodiments, and are not intended to limit the claimed subject-matter, because the scope of the present technology is limited only by the claims. Unless otherwise defined, all technical and scientific terms used herein have the same meaning as commonly understood by one of ordinary skill in the art to which this present technology belongs. If there is an apparent discrepancy between the usage of a term in the art and its definition provided herein, the definition provided within the specification shall prevail.

As used in this specification and the appended claims, the singular forms “a,” “an” and “the” include plural referents unless the content clearly dictates otherwise. For example, reference to “a cell” includes a combination of two or more cells, and the like.

As used herein, the term “approximately” or “about” in reference to a value or parameter are generally taken to include numbers that fall within a range of 5%, 10%, 15%, or 20% in either direction (greater than or less than) of the number unless otherwise stated or otherwise evident from the context (except where such number would be less than 0% or exceed 100% of a possible value). As used herein, reference to “approximately” or “about” a value or parameter includes (and describes) embodiments that are directed to that value or parameter. For example, description referring to “about X” includes description of “X”.

As used herein, the term “or” means “and/or.” The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “comprising” means that other elements can also be present in addition to the defined elements presented. The use of “comprising” indicates inclusion rather than limitation.

The term “consisting of” refers to compositions, methods, and respective components thereof as described herein, which are exclusive of any element not recited in that description of the embodiment.

As used herein the term “consisting essentially of” refers to those elements required for a given embodiment. The term permits the presence of additional elements that do not materially affect the basic and novel or functional characteristic(s) of that embodiment of the present technology.

As used herein, “aryl” refers to a carbocyclic (all carbon) ring that is fully aromatized. An “aryl” group can be made up of two or more fused rings (rings that share two adjacent carbon atoms). When an aryl group is a fused ring system, then the ring that is connected to the rest of the molecule is fully aromatized. The other ring(s) in the fused ring system may or may not be fully aromatized. Examples of aryl groups include, without limitation, the radicals of benzene, naphthalene and azulene.

As used herein, “alkyl” refers to a straight or branched chain fully saturated (no double or triple bonds) hydrocarbon group. An alkyl group of the presently disclosed compounds may comprise from 1 to 15 carbon atoms. An alkyl group herein may have 1 to 4 carbon atoms, 1 to 5 carbon atoms, 1 to 6 carbon atoms, 1 to 7 carbon atoms, 1 to 8 carbon atoms, 1 to 9 carbon atoms, 1 to 10 carbon atoms, 1 to 11 carbon atoms, 1 to 12 carbon atoms, 1 to 13 carbon atoms, 1 to 14 carbon atoms, or 1 to 15 carbon atoms. As used herein, a C₁-C₆ alkyl represents an alkyl group having 1 to 6 carbon atoms, a C₁-C₄ alkyl represents an alkyl group having 1 to 4 carbon atoms and a C₁-C₃ alkyl represents an alkyl group having 1 to 3 carbon atoms, etc. Examples of alkyl groups include, without limitation, methyl, ethyl, n-propyl, isopropyl, n-butyl, i-butyl, sec-butyl, t-butyl, amyl, t-amyl, hexyl, heptyl, octyl, nonyl, decyl, undecyl and dodecyl.

As used herein, “alkoxy” refers to an alkyl group, as defined above, appended to the parent molecular moiety through an oxy group, —O—. As used herein, a C₁-C₆ alkoxy represents an alkoxy group containing 1 to 6 carbon atoms and a C₁-C₃ alkoxy represents an alkoxy group containing 1 to 3 carbon atoms. Representative examples of alkoxy include, but are not limited to, methoxy, ethoxy, propoxy, 2-propoxy, butoxy, tert-butoxy, pentyloxy, hexyloxy etc.

As used herein, “cycloalkyl” refers to a monocyclic, bicyclic or polycyclic hydrocarbon ring system having, in some embodiments, 3 to 14 carbon atoms (e.g., C₃-C₁₄ cycloalkyl), or 3 to 10 carbon atoms (e.g., C₃-C₁₀ cycloalkyl), or 3 to 8 carbon atoms (e.g., C₃-C₈ cycloalkyl), or 3 to 6 carbon atoms (e.g., C₃-C₆ cycloalkyl) or 5 to 6 carbon atoms (e.g., C₅-C₆ cycloalkyl). Cycloalkyl groups can be saturated or characterized by one or more points of unsaturation (i.e., carbon-carbon double and/or triple bonds), provided that the points of unsaturation do not result in an aromatic system. Examples of monocyclic cycloalkyl groups include, but are not limited to, cyclopropyl, cyclobutyl, cyclopentyl, cyclohexyl, cyclohexeneyl, cyclohexynyl, cycloheptyl, cyclohepteneyl, cycloheptadieneyl, cyclooctyl, cycloocteneyl, cyclooctadieneyl and the like. The rings of bicyclic and polycyclic cycloalkyl groups can be fused, bridged, or spirocyclic.

As used herein, unless otherwise stated, “heteroalkyl” refers to an alkyl group, as defined herein, in which one or more of the constituent carbon atoms have been replaced by nitrogen, oxygen, sulfur, or silicon. A representative example of a heteroalkyl group is an alkoxy. A heteroalkylene is a divalent heteroalkyl group.

As used herein, unless otherwise stated, term “heteroaryl” refers to monocyclic or fused bicyclic aromatic groups (or rings) having, in some embodiments, from 5 to 14 (i.e., 5- to 14-membered heteroaryl), or from 5 to 10 (i.e., 5- to 10-membered heteroaryl), or from 5 to 6 (i.e., 5- to 6-membered heteroaryl) members (i.e., ring vertices), and containing from one to five, one to four, one to three, one to two or one heteroatom selected from nitrogen (N), oxygen (O), and sulfur (S). A heteroaryl group can be attached to the remainder of the molecule through a carbon atom or a heteroatom of the heteroaryl group, when chemically permissible. Non-limiting examples of heteroaryl groups include pyridyl, pyridazinyl, pyrazinyl, pyrimindinyl, triazinyl, purinyl, thienopyridinyl, thienopyrimidinyl, pyrazolopyrimidinyl, pyrazolopyridinyl, imidazopyridines, isothiazolyl, pyrazolyl, indazolyl, pteridinyl, imidazolyl, triazolyl, tetrazolyl, oxazolyl, isoxazolyl, thiadiazolyl, pyrrolyl, thiazolyl, furyl, thienyl and the like.

The term “heterocycloalkyl” refers to a non-aromatic monocyclic, bicyclic or polycyclic cycloalkyl ring having, in some embodiments, 3 to 14 members (e.g., 3- to 14-membered heterocycle), or 3 to 10 members (e.g., 3- to 10-membered heterocycle), or 3 to 8 members (e.g., 3- to 8-membered heterocycle), or 3 to 6 members (e.g., 3- to 6-membered heterocycle), or 5 to 6 members (e.g., 5- to 6-membered heterocycle), and having from one to five, one to four, one to three, one to two or one heteroatom selected from nitrogen (N), oxygen (O), sulfur (S) and silicon (Si). Heterocycloalkyl groups are saturated or characterized by one or more points of unsaturation (e.g., one or more carbon-carbon double bonds, carbon-carbon triple bonds, carbon-nitrogen double bonds, and/or nitrogen-nitrogen double bonds), provided that the points of unsaturation do not result in an aromatic system. The rings of bicyclic and polycyclic heterocycloalkyl groups can be fused, bridged, or spirocyclic. Non-limiting examples of heterocycloalkyl groups include aziridine, oxirane, thiirane, pyrrolidine, imidazolidine, pyrazolidine, dioxolane, phthalimide, piperidine, 1,4-dioxane, morpholine, thiomorpholine, thiomorpholine-S-oxide, thiomorpholine-S, S-oxide, piperazine, 3,4,5,6-tetrahydropyridazine, tetrahydropyran, pyran, decahydroisoquinoline, 3-pyrroline, thiopyran, tetrahydrofuran, tetrahydrothiophene, quinuclidine, and the like. A heterocycloalkyl group can be attached to the remainder of the molecule through a ring carbon atom, or a ring heteroatom, when chemically permissible.

As used herein, unless otherwise stated, “independently selected” indicates that each one of a designated group is selected independently from a subsequent list of species.

The term “statistically significant” or “significantly” refers to statistical significance and generally means a two standard deviation (2SD) or greater difference.

The terms “decrease”, “reduced”, “reduction”, or “inhibit” are all used herein to mean a decrease by a statistically significant amount. In some embodiments, “reduce,” “reduction” or “decrease” or “inhibit” typically means a decrease by at least 10% as compared to a reference level (e.g., the absence of a given treatment or agent) and can include, for example, a decrease by at least about 10%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, at least about 99%, or more. As used herein, “reduction” or “inhibition” does not encompass a complete inhibition or reduction as compared to a reference level. “Complete inhibition” is a 100% inhibition as compared to a reference level. A decrease can be preferably down to a level accepted as within the range of normal for an individual without a given disorder.

The terms “increased”, “increase”, “enhance”, or “activate” are all used herein to mean an increase by a statically significant amount. In some embodiments, the terms “increased”, “increase”, “enhance”, or “activate” can mean an increase of at least 10% as compared to a reference level, for example an increase of at least about 20%, or at least about 30%, or at least about 40%, or at least about 50%, or at least about 60%, or at least about 70%, or at least about 80%, or at least about 90% or up to and including a 100% increase or any increase between 10-100% as compared to a reference level, or at least about a 2-fold, or at least about a 3-fold, or at least about a 4-fold, or at least about a 5-fold or at least about a 10-fold increase, or any increase between 2-fold and 10-fold or greater as compared to a reference level. In the context of a marker or symptom, an “increase” is a statistically significant increase in such level.

As used herein, the term “polyisocyanates” generally represents the family of polyisocyanates containing more than one isocyanate reactive group such as, but not limited to, DESMODUR® N3300 and N100 (made by Covestro Deutschland AG of Leverkusen, Germany) which are aliphatic polyisocyanates based on HDI (hexamethylene diisocyanate) trimer, DESMODUR® Z4470SN (made by Covestro Deutschland AG of Leverkusen, Germany) which is a multifunctional polyisocyanate based on IPDI (isophorone diisocyanate), WANNATE® T series polyisocyanates which are toluene diisocyanate (TDI)-based aromatic polyisocyanates, and LUPRANATE® M series polyisocyanates which are 4,4- diphenylmethane diisocyanate (MDI)-based aromatic polyisocyanates.

As used herein, the term “antimicrobial” is used generally to indicate at least some level of microbe kill by a composition or a coating on a portion of a surface. For example, antimicrobial may be used to indicate a biostatic efficacy, sanitizing level (3-log, or 99.9%) reduction in at least one organism, or a disinfection level (5-log, or 99.999%) reduction in at least one organism, or sterilization (no detectable organisms). Microbes, or microorganisms, may include any species of bacteria, virus, fungus including mold and yeast, microalgae, or spore. Thus, antimicrobial herein encompasses antiviral, antibacterial, antifungal, and anti-algae (e.g., anti-microalgae).

As used herein, the terms “residual antimicrobial,” “residual self-sanitizing,” and “self-decontaminating surface” are used interchangeably to indicate a surface that maintains antimicrobial efficacy over a certain period of time under certain conditions once the surface is coated with an antimicrobial coating composition and that composition dried on the surface as a thin film. A coated surface may maintain residual antimicrobial efficacy indefinitely, or the coating may eventually “wear out” and lose its residual antimicrobial efficacy. An antimicrobial coating composition may function as a contact sanitizer, bacteriostatic material, disinfectant, or sterilant, (e.g., as a liquid antimicrobial applied to a contaminated surface) and may also have the ability to leave behind a residual antimicrobial coating on the surface once dried or cured thereon that can keep inactivating new microorganisms that contact the coated surface. In various embodiments, coating compositions may not be antimicrobial until dried or cured on a surface but are still referred to as antimicrobial coating compositions because of their ability to produce a residual antimicrobial coating on a surface. Antimicrobial coating compositions for use in various embodiments may provide a residual antimicrobial efficacy to a surface, meaning that a microorganism later inoculated on, or that otherwise comes in contact with, the coated surface may experience cell death, destruction, or inactivation. The residual antimicrobial effect made possible by the coatings herein is not limited by a particular mechanism of action, and no such theories are proffered. For example, an antimicrobial effect measured on a surface may be the result of intracellular mutations, inhibition of certain cellular processes, rupture of a cell wall, or a nondescript inactivation of the organism, such as in the case of viruses. Other antimicrobial effects may include inhibiting the reproduction of an organism or inhibiting the organism's ability to accumulate into biofilms.

As used herein, the term “antimicrobial coating composition” refers to a chemical composition comprising at least one chemical species, which is used to produce a residual antimicrobial coating on a surface after the composition is applied and then either dried, allowed to dry, or cured in some manner. The term is also used for liquid compositions that may find use as a germicidal spray (disinfectant or sanitizer), since the composition could then go on to dry into an antimicrobial coating. The term is also extended to include a composition that may be applied sequentially (e.g., over or under) or contemporaneously with the application of an antimicrobial coating composition, such as to assist in bonding the residual antimicrobial coating to the surface, improve durability of the overall coating, and/or to provide a catalytic effect or some sort of potentiation or synergy with the residual antimicrobial coating comprising an antimicrobial active. For simplicity herein, each one of multiple compositions used sequentially or contemporaneously to produce an overall residual antimicrobial coating on a portion of a surface is referred to as an “antimicrobial coating composition,” even if one or more of the compositions used for coating has no identifiable antimicrobial activity or where the active agent is uncertain. An antimicrobial coating composition may comprise a neat, 100% active chemical species or may be a solution or suspension of a single chemical species in a solvent. In other aspects, a composition may comprise a complex mixture of chemical substances, some of which may chemically react (hydrolyze, self-condense, etc.) within the composition to produce identifiable or unidentifiable reaction products. For example, a monomeric chemical species in an antimicrobial coating composition may partially or fully polymerize or copolymerize, such as to produce polymers including homopolymer and copolymers with a distribution of molecular weight, comonomer ratio, or molecular architecture while in solution, prior to a coating process using that composition. In other embodiments, chemical constituents within an antimicrobial coating composition may chemically react, graft, or form an interpenetration network on the surface or interphase that the composition is applied to, such as while the composition is drying and concentrating on the surface or while the coating composition is cured by various methods. In various embodiments, a solution comprising a polymer distribution may polymerize or cure further, such as to longer chain lengths or forming a polymer network, while the solution dries on a surface. Antimicrobial coating compositions for use in various embodiments may further comprise any number and combination of inert excipients, such as for example, solvents, buffers, acids, alkali, surfactants, emulsifiers, stabilizers, UV absorbers, thickeners, free-radical initiators, fillers, pigments or colorants, catalysts, etc.

As used herein, the term “homopolymer” takes on its ordinary meaning in organic chemistry of a molecule having repeated and identical monomer units. For simplicity's sake, the term homopolymer herein includes each of the smaller oligomers, i.e., dimer, trimer, tetramer, dendrimers, dendrons, etc., unless specified otherwise. For example, a homopolymer distribution herein may include the dimer and above, or the trimer and above, as indicated. In some instances, a homopolymer chain length distribution may be well defined and characterized, and in other instances, the distribution may not be characterizable at all and may remain unknown. The term copolymer herein includes random copolymer, block copolymer, graft copolymer, interpolymer complex, interpenetration network, etc. . . . and their blends.

As used herein, and unless otherwise indicated, the term “wt. %” takes on the ordinary meaning of percent (%) by weight of an ingredient in a chemical composition, based on the total weight of the composition “as made.” For example, an aqueous composition comprising 1 wt. % amine “based on the total weight of the composition” equates to a composition containing 99.0 grams water and 1.0 gram amine. Wt. % in a composition indicates the wt. % of active material, unless indicated otherwise. “As made” means that a written composition shows what was added to a mixing vessel, and not what might end up in the mixture after certain ingredients react, such as if an ingredient hydrolyzes or polymerizes.

Unless otherwise defined herein, scientific and technical terms used in connection with the present application shall have the meanings that are commonly understood by those of ordinary skill in the art to which this disclosure belongs. It should be understood that this present technology is not limited to the particular methodology, protocols, and reagents, etc., described herein and as such can vary. The terminology used herein is for the purpose of describing particular embodiments only and is not intended to limit the scope of the present technology, which is defined solely by the claims. Definitions of common terms in immunology and molecular biology can be found in The Merck Manual of Diagnosis and Therapy;³ The Encyclopedia of Molecular Cell Biology and Molecular Medicine;⁴ Molecular Biology and Biotechnology: a Comprehensive Desk Reference;⁵ Immunology;⁶ Janeway's Immunobiology;⁷ Lewin's Genes XI;⁸ Molecular Cloning: A Laboratory Manual;⁹ Basic Methods in Molecular Biology;¹⁰ Laboratory Methods in Enzymology;¹¹ Current Protocols in Molecular Biology (CPMB);¹² Current Protocols in Protein Science (CPPS);¹³ and Current Protocols in Immunology (CPI).¹⁴

Other terms are defined herein within the description of the various aspects of the present technology.

### Antimicrobial Coatings

Surfaces of objects which are in direct or indirect contact with humans and animals are exposed to a high microbial load and have a demonstrable influence on the transmission of diseases and infections. The antimicrobial coatings of the present technology can be particularly useful because they can be applied to just about any surface and drastically reduce the microbial load. Surfaces that can be treated with antimicrobial coatings include, but are not limited to, interior and exterior building components such as handrails, fixtures, fixture knobs, pulling handles, and grips; parts such as faucet handles for kitchens, wash rooms, bathrooms, toilets, personal articles, telephones, computers, door handles, counters, furniture, walls, ticketing machines, high-touch areas (e.g., lounges of buildings, public means of payment, and public means of transport), and other tough-to-clean/access areas such as mechanicals and HVAC systems. Further, these coatings have applicability to medical devices and accessories, implants, and instruments, laboratory equipment, factories, water filtration equipment, hospitals, school/childcare facilities, airports, restaurants, gyms, etc.

Bacteria of particular concern include, but are not limited to, Staphylococcus aureus (Staph), Escherichia coli (E. coli), Methicillin-Resistant Staphylococcus aureus (MRSA) and Vancomycin-Resistant Enterococcus faecalis and Enterobacter aerogenes (VRE). Staph is a group of over 30 strains that cause many different types of infections, including skin infections, food and blood poisoning. Most strains of E. coli are not harmful but are part of the healthy bacterial flora in the human gut. However, some strains can cause various diseases, including pneumonia, urinary tract infections, diarrhea and meningitis. Some strains of E. coli can also cause nausea, vomiting and fever. MRSA is a type of bacterium that causes infections in different parts of the body. It is relatively more difficult to treat than most other strains of Staph because it is resistant to antibiotics. It can cause serious skin, bloodstream, lungs or urinary tract infections. VRE are a type of bacteria called Enterococci that have developed resistance to many antibiotics, especially Vancomycin as the name suggests. These bacteria can cause serious infections, especially in people who are already ill, weak, and/or immunocompromised. VRE may cause bloodstream infection (sepsis), urinary infection, pneumonia, heart infections (endocarditis), or meningitis.

Viruses of particular concern include, but are not limited to, influenza A and B viruses, respiratory syncytial virus, adenovirus, rhinovirus and coronaviruses (229E, HKU1, NL63, OC43, and, more recently, SARS-CoV-2) as these viruses have been demonstrated to have long survival periods on numerous surfaces. For example, in a recent study of airports,¹⁵ detection of pathogen viral nucleic acids demonstrated viral surface contamination at multiple sites associated with high touch rates and suggested a potential risk in standard passenger pathways at airport sites. These viruses can cause serious infections, especially in people who are already ill, weak, and/or immunocompromised.

In the chemical coatings industry, a 99.9% percent reduction in bacteria or virus translates to a three order of magnitude reduction in microbial risk (i.e., 3 log). However, there is a number of physical and chemical requirements that an antimicrobial coating should meet to be a fully effective and broadly applicable antiviral/antibacterial/antifungal agent and surface coating. These properties include:
1. Highly antimicrobial against a broad spectrum of viruses, bacteria, and fungi.
2. Very fast-acting; killing greater than 99.9% of viruses in a contact time of ten minutes or less and of bacteria after overnight.
3. Long lasting; maintaining a bacteria or virus killing efficiency of at least 98% after 100 days of storage under ambient conditions or after 72 hours of storage at 40° C./85% RH humidity.
4. Non-toxic and nonallergenic based on recognized standard test procedures.
5. No materials leached out over time or when exposed to typical liquids used for cleaning.
6. Visibly colorless and transparent as a surface coating.
7. Easy to apply as a water-based formulation to a wide range of surfaces and materials by painting, spraying, dipping or other commonly used application methods.
8. Durable surface coating that is resistant to delaminating from the surface or becoming visibly deteriorated by contact with water, alcohol and common solvents.
9. Easy and cost effective to produce from readily available materials.
10. Made by a synthesis that is versatile enabling a wide range of chemical variations to fine tune its properties (i.e., solubility, etc.) for a range of different applications.
   To the present inventors' knowledge there are no antimicrobial coatings available yet that meet most or all of these requirements. Many of the existing antimicrobial coatings tend to deteriorate with time and lose effectiveness as contamination is repeated.

Conventional coating products claiming to deliver antibacterial properties include PAINTGUARD/PAINTSHIELD® from the Sherwin Williams Company (Cleveland, Ohio); ALESTA® AM and ALESTA® Ralguard from Axalta (Philadelphia, PA) and SILVERSAN™ from PPG Industrial Coatings (Pittsburgh, PA). However, these products generally claim to be 99.9% effective, but take over 5 hours after application to reach their maximum efficiency. Further, existing solutions tend to degrade over time, so that their active performance goes below 90% after recontamination (i.e., repeated exposure to pathogens in combination with routine environmental exposure and/or scrubbing/cleaning over prolonged periods of time). At just 90% protection, bacteria and germs have the ability to grow and respire, eventually multiplying to the point where existing pathogens on the substrate layer will persist, thereby decreasing the efficacy of these coatings.

Antimicrobial polymers have been reported with embedded agents including metals like silver,¹⁶ but these suffer from the fact that the embedded antimicrobial agents can leach out over time causing the polymer coating to lose its antimicrobial activity. Moreover, such formulations are not entirely satisfactory, as they only lead to a 3 log reduction that fails to completely inhibit regrowth of bacteria. This lack of effectiveness can probably be attributed to the fact that silver is used insufficient amounts and/or is unevenly dispersed throughout the composition, resulting in an inconsistent and, ultimately, ineffective distribution of anti-microbial particles within the composition/coating.

Park et al. (2006)¹⁷ reported antimicrobial active polymers made by reacting polyethyleneimine with a hydrophobic long chain hydrocarbon alkylating agent and then quaternization by methylation. Although these polymers have antibacterial and antiviral activity as surface coatings, the coatings are not colorless, and they are not durable and resistant to contact with water and other common solvents to which the surface may regularly come in contact.

Many have speculated that the antiviral activity of quaternary ammonium polymers is due to the interaction between the hydrophobic quaternary ammonium groups and the negatively charged membrane of the virus causing a disruption of the membrane which inactivates microorganisms such as viruses. In fact, the active ingredients in many of the commercially-available antiviral surface sprays are low molecular weight quaternary ammonium surfactant-like materials, which are assumed to act by this mechanism but that do not form long lasting durable surface coatings.

Researchers have reported acrylic or methacrylic co-polymers with quaternary ammonium functional groups that have antimicrobial activity^{18,19} but these do not produce durable water and solvent resistant coatings, and some have exhibited a level of toxicity.

Several researchers have reported antimicrobial polyurethane polymers bearing quaternary ammonium functional groups^{2,21,22} but these have a number of shortcomings. Some are water soluble and thereby not suitable for durable surface coatings. Others do not report testing the durability of coatings or the toxicity of the materials. Some are rather tedious to synthesize requiring somewhat expensive materials and as many as four synthetic steps including amine blocking and deblocking reactions.

Gao et al. (2007)²³ have reported the synthesis and antibacterial activity of polymers synthesized by alkylating polyethyleneimine with propyl epoxide and then quaternizing with benzyl chloride. These polymers are reported to be highly antibacterial with contact times as short as 4 minutes, but they are water soluble and thereby not suitable for producing a durable surface coating. Furthermore, testing against viruses and toxicity was not reported for these polymers.

While antimicrobial quaternary ammonium compounds and polymers are previously known, simple coatings of these materials either are not optically clear or not highly antimicrobial or not durable and simple steps to cross-link the coatings to achieve durability are insufficient to simultaneously achieve these properties.

### Polymers or Interpenetrating Polymer Networks of the Present Technology

The present technology provides water-based quaternary ammonium polymer structures and compositions and formulations thereof that meet virtually all of the requirements listed above.

In one aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; (ii) a polyethyleneimine intermediate or a second adduct of the polyethyleneimine intermediate and a second multifunctional crosslinker; and (iii) a water-soluble polymer.

In another aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; and (ii) a polyethyleneimine intermediate or a second adduct of the polyethyleneimine intermediate and a second multifunctional crosslinker.

In another aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; (ii) optionally a polyol; (iii) a polyethyleneimine intermediate or a second adduct of the polyethyleneimine intermediate and a second multifunctional crosslinker; (iv) optionally a third multifunctional crosslinker; and (v) a water-soluble polymer.

The water-soluble polymer comprises, consists essentially of, or consists of hydroxyethyl cellulose, hydroxypropyl cellulose, methylcellulose, hydrophobically modified cellulose, polyvinyl alcohol poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyethyleneimine, polyacrylamide, or their modified polymers or copolymers on the side-chain or main-chain (e.g., modification(s) that provide reactive functional groups, hydrophobicity, and/or surface activity), or a combination or blend of two or more thereof, or a copolymer of two or more thereof, or a copolymer of one or more thereof with polyvinylpyrrolidone, poly(glycidyl acrylate) or with poly(glycidyl methacrylate).

The water-soluble polymer may be present in the dried polymer or interpenetrating polymer network in an amount of from about 0.5 wt. % to about 15 wt. %. This includes about 0.5, 0.75, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15 wt. %, or any value therebetween. In some embodiments, the water-soluble polymer is present in the dried polymer or interpenetrating polymer network in an amount of from about 0.5 wt. % to about 15 wt. %, about 3 wt. % to about 12 wt. %, or about 5 wt. % to about 10 wt. %.

In another aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; (ii) optionally a polyol; (iii) a polyethyleneimine intermediate or a second adduct of the polyethyleneimine intermediate and a second multifunctional crosslinker; and (iv) optionally a third multifunctional crosslinker.

The first quaternary ammonium salt may have a chemical structure of:

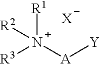

wherein:
R¹ is selected from a group consisting of —(C₈-C₃₀ alkyl), —(C₈-C₃₀ heteroalkyl), —(C₈-C₃₀ heteroalkyl)-(C₆-C₁₀ aryl), —(C₆-C₁₀ aryl), —(C₆-C₁₀ aryl)-(C₈-C₃₀ alkyl), —(C₆-C₁₀ aryl)-(C₈-C₃₀ heteroalkyl), —(CR^{m}Rⁿ)ₓ₁₀—W¹⁰—(CR^{p}R^{q})_{y10}—H, and —(CR^{m}Rⁿ)ₓ₁₁—W¹—(CR^{p}R^{q})_{y1} H—; wherein—(C₈-C₃₀ heteroalkyl), —(C₈-C₃₀ heteroalkyl)-(C₆-C₁₀ aryl), and —(C₆-C₁₀ aryl)-(C₈-C₃₀ heteroalkyl) have 1 to 4 heteroatoms independently selected from O, S, and Si;
R² is selected from a group consisting of —(C₁-C₄ alkyl), —(C₁-C₄ heteroalkyl), —(C₁-C₄ heteroalkyl)-(C₆-C₁₀ aryl), —(C₆-C₁₀ aryl), —(C₆-C₁₀ aryl)-(C₁-C₄ alkyl), —(C₆-C₁₀ aryl)-(C₁-C₄ heteroalkyl); —(CR^{m}Rⁿ)ₓ₂₀—W²⁰—(CR^{p}R^{q})_{y20}—H, and —(CR^{m}Rⁿ)ₓ₂₁—W²¹—(CR^{p}R^{q})_{y21}—H; wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 2 heteroatoms independently selected from O, S, and Si;
R³ is selected from a group consisting of —(C₁-C₃₀ alkyl), —(C₁-C₃₀ heteroalkyl), —(C₁-C₃₀ heteroalkyl)-(C₆-C₁₀ aryl), —(C₆-C₁₀ aryl), —(C₆-C₁₀ aryl)-(C₁-C₃₀ alkyl), —(C₆-C₁₀ aryl)-(C₁-C₃₀ heteroalkyl), —(CR^{m}Rⁿ)ₓ₃₀—W³⁰—(CR^{p}R^{q})_{y30}—H, and —(CR^{m}Rⁿ)ₓ₃₁—W³¹—(CR^{p}R^{q})_{y31}—H; wherein —(C₁-C₃₀ heteroalkyl), —(C₁-C₃₀ heteroalkyl)-(C₆-C₁₀ aryl), and —(C₆-C₁₀ aryl)-(C₁-C₃₀ heteroalkyl) have 1 to 4 heteroatoms independently selected from O, S, and Si;
A is a linking group selected from a group consisting of —(C₃-C₂₀ alkylene)-, —(C₃-C₂₀ heteroalkylene)-, —(C₆-C₁₁ arylene)-(C₃-C₂₀ alkylene), —(CR^{m}Rⁿ)ₓ₄₀—W⁴⁰—(CR^{p}R^{q})_{y40}—, and —(CR^{m}Rⁿ)ₓ₄₁—W⁴¹—(CR^{p}R^{q})_{y41}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m}, Rⁿ, R^{p}, and R^{q} is independently selected from H and C₁-C₄ alkyl;
W¹⁰, W²⁰, W³⁰ and W⁴⁰ are independently selected from —C(O)—; —C(O)O—; —OC(O)—; —C(O)NH—; and —NHC(O)—;
W¹¹, W²¹, W³¹ and W⁴¹ are independently selected from 5- to 6-membered cycloalkyl, C₆-C₁ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x10 is an integer from 1 to 30 and y10 is an integer from 0 to 29, wherein 8≤(x10+y10)≤30;
x11 is an integer from 1 to 30 and y11 is an integer from 0 to 29, wherein 8≤(x11+y11)≤30;
x20 is an integer from 1 to 4 and y20 is an integer from 0 to 3, wherein x20+y20≤4;
x21 is an integer from 1 to 4 and y21 is an integer from 0 to 3, wherein x21+y21≤4;
x30 is an integer from 1 to 30 and y30 is an integer from 0 to 29, wherein x30+y30≤30;
x31 is an integer from 1 to 30 and y31 is an integer from 0 to 29, wherein x31+y31≤30;
x40 is an integer from 1 to 19 and y40 is an integer from 1 to 19, wherein 3≤(x40+y40)≤20;
x41 is an integer from 1 to 20, and y41 is an integer from 0 to 19, wherein 3≤(x41+y41)≤20; Y is selected from a group consisting of —OH, —NHR⁴, —SH, —CO₂H, —C(O)NHR⁴, —C(S)NHR⁴,

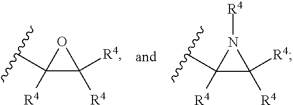

each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

In some embodiments, R¹ is selected from a group consisting of —(C₁₂-C₃₀ alkyl), —(C₁₂-C₃₀ heteroalkyl), —(C₁₂-C₃₀ alkyl)-(C₆-C₁₀ aryl), —(C₁₂-C₃₀ heteroalkyl)-(C₆-C₁₀ aryl), —(C₆-C₁ aryl)-(C₁₂-C₃₀ alkyl), and —(C₆-C₁₀ aryl)-(C₁₂-C₃₀ heteroalkyl); wherein —(C₁₂-C₃₀ heteroalkyl), —(C₁₂-C₃₀ heteroalkyl)-(C₆-C₁₀ aryl), and —(C₆-C₁₀ aryl)-(C₁₂-C₃₀ heteroalkyl) have 1 to 4 heteroatoms independently selected from O, S, and Si. In some embodiments, R¹ is —(C₁₂-C₃₀ alkyl). In some embodiments, R¹ is —(C₈-C₃₀ heteroalkyl) with 1 to 4 heteroatoms independently selected from O, S, and Si. In some embodiments, R¹ is —(C₆-C₁₀ aryl)-(C₁₂-C₃₀ alkyl). In some embodiments, R¹ is —(C₁₂-C₃₀ alkyl)-(C₆-C₁₀ aryl). In some embodiments, R¹ is —(C₆-C₁₀ aryl)-(C₁₂-C₃₀ heteroalkyl) with 1 to 4 heteroatoms independently selected from O, S, and Si. In some embodiments, R¹ is —(C₁₂-C₃₀ heteroalkyl)-(C₆-C₁₀ aryl) with 1 to 4 heteroatoms independently selected from O, S, and Si. In some embodiments, R¹ is —(CR^{m}Rⁿ)ₓ₁₀—W¹⁰-(CR^{p}R^{q})_{y10}—H. In some embodiments, R¹ is —(CR^{m}Rⁿ)ₓ₁₁—W¹¹—(CR^{p}R^{q})_{y1}—H.

In some embodiments, R² is —(C₁-C₄ alkyl). In some embodiments, R² is —(C₁-C₄ heteroalkyl) with 1 to 4 heteroatoms independently selected from O, S, and Si. In some embodiments, R² is —(C₆-C₁₀ aryl)-(C₁-C₄ alkyl). In some embodiments, R² is —(C₁-C₄ alkyl)-(C₆-C₁₀ aryl). In some embodiments, R² is —(C₆-C₁₀ aryl). In some embodiments, R² is —(C₆-C₁₀ aryl)-(C₁-C₄ heteroalkyl) with 1 to 4 heteroatoms independently selected from O, S, and Si. In some embodiments, R² is —(C₁-C₄ heteroalkyl)-(C₆-C₁₀ aryl) with 1 to 4 heteroatoms independently selected from O, S, and Si. In some embodiments, R² is —(CR^{m}Rⁿ)ₓ₂₀—W²⁰—(CR^{p}R^{q})_{y20}—H. In some embodiments, R² is —(CR^{m}Rⁿ)ₓ₂₁—W²¹—(CR^{p}R^{q})_{y21}—H.

In some embodiments, R³ is selected from a group consisting of —(C₁-C₄ alkyl), —(C₁-C₄ heteroalkyl), —(C₁-C₄ alkyl)-(C₆-C₁₀ aryl), —(C₁-C₄ heteroalkyl)-(C₆-C₁₀ aryl), —(C₆-C₁₀ aryl)-(C₁-C₄ alkyl), and —(C₆-C₁₀ aryl)-(C₁-C₄ heteroalkyl); wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 4 heteroatoms independently selected from O, S, and Si. In some embodiments, R³ is —(C₁-C₄ alkyl). In some embodiments, R³ is —(C₁-C₄ heteroalkyl) with 1 to 4 heteroatoms independently selected from O, S, and Si. In some embodiments, R³ is —(C₆-C₁₀ aryl)-(C₁-C₄alkyl). In some embodiments, R³ is —(C₁-C₄ alkyl)-(C₆-C₁₀ aryl). In some embodiments, R³ is —(C₆-C₁₀ aryl)-(C₁-C₄ heteroalkyl) with 1 to 4 heteroatoms independently selected from O, S, and Si. In some embodiments, R³ is —(C₁-C₄ heteroalkyl)-(C₆-C₁₀ aryl) with 1 to 4 heteroatoms independently selected from O, S, and Si. In some embodiments, R³ is —(CR^{m}Rⁿ)ₓ₃₀—W³⁰—(CR^{p}R^{q})_{y30}—H. In some embodiments, R³ is —(CR^{m}Rⁿ)ₓ₃₁—W³¹—(CR^{p}R^{q})_{y31}—H.

In some embodiments, R² and R³ are methyl. In some embodiments, R¹ is C₁₂-C₃₀ alkyl, and R² and R³ are methyl.

In some embodiments, A is —(C₃-C₂₀ alkylene)- optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl). In some embodiments, A is —(C₃-C₂₀ heteroalkylene)- with 1 to 4 heteroatoms independently selected from O, S, and Si, and optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ ary). In some embodiments, A is —(C₆-C₁₀ arylene)-(C₃-C₂₀ alkylene)-. In some embodiments, A is —(C₃-C₂₀ alkylene)-(C₆-C₁₀ arylene)-.

In some embodiments, A is —(CR^{m}Rⁿ)ₓ₄₀—W⁴⁰—(CR^{p}R^{q})_{y40}—. In some embodiments, A is —(CR^{m}Rⁿ)ₓ₄₁—W⁴¹—(CR^{p}R^{q})_{y41}—.

In some embodiments, A is —(CH₂)ₘ or —(CH₂CHR⁵—O—)ₙCH₂CHR⁵—, wherein m is an integer from 2 to 20; n is 0, 1, 2, 3, 4, or 5; and each R⁵ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si. In some embodiments, R⁵ is H or methyl.

In some embodiments, Y is —OH. In some embodiments, Y is —NHR⁴. In some embodiments, Y is —SH. In some embodiments, Y is —CO₂H. In some embodiments, Y is —C(O)NHR⁴, wherein R⁴ is selected from a group consisting of H, —(C₆-C₁₀ aryl)-(C₁-C₃ alkyl), —(C₆-C₁a aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si. In some embodiments, Y is —C(S)NHR⁴, wherein R⁴ is selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si. In some embodiments, Y is

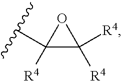

wherein each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

In some embodiments, Y is

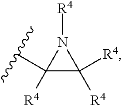

wherein each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

X⁻ may be independently selected from the group consisting of acetate, halide (e.g., chloride, bromide, or iodide), sulfate, sulfonate, phosphate, phosphonate, carbonate, silicate, hexafluorophosphate, hexafluoroantimonate, triflate, and borate, and their organo-substituted derivatives. As used herein, and unless stated otherwise, “organo-substituted derivatives” refers to anions wherein a sulfur atom, a phosphorous atom, a boron atom, a silicon atom or carbonyl group is substituted with either an alkyl or an aryl group. Non-limiting examples include methylsulfate, methanesulfonate, p-toluene sulfonate, trifluoromethylsulfonate, and trifluoroacetate.

In some embodiments, the first quaternary ammonium salt is

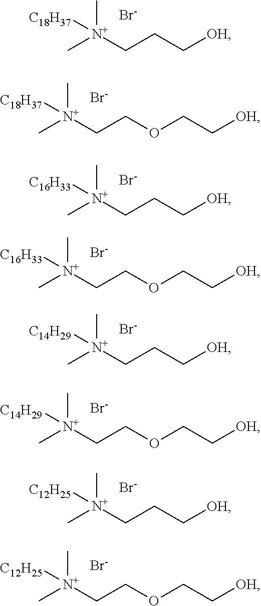

or a combination of two or more thereof.

The first quaternary ammonium salt may be present in the dried polymer or interpenetrating polymer network in an amount of about 1 wt. % to about 50 wt. %. This includes about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt. %, or any value therebetween. In some embodiments, the first quaternary ammonium salt is present in the dried polymer or interpenetrating polymer network in an amount of about 5 wt. % to about 25 wt. %. More precisely, the amount of quaternary ammonium salt may be represented by millinormal/g (mN/g) instead of wt. % based on the total weight of the dried polymer or interpenetrating polymer network. The first quaternary ammonium salt may be present in the dried polymer or interpenetrating polymer network in an amount of from about 0.1 mN/g to about 1.0 mN/g. This includes 0.1, 0.2, 0.3, 0.4, 0.5, 0.6, 0.7, 0.8, 0.9, or 1.0 mN/g, or any value therebetween. In some embodiments, the first quaternary ammonium salt is present in the dried polymer or interpenetrating polymer network in an amount of from about 0.4 mN/g to about 0.9 mN/g. In some embodiments, the first quaternary ammonium salt is present in the dried polymer or interpenetrating polymer network in an amount of from about 0.5 mN/g to about 0.8 mN/g.

The first multifunctional crosslinker may be a first polyisocyanate. In some embodiments, the first polyisocyanate has an average isocyanate functionality of 2 to 5. This includes an average isocyanate functionality of 2, 3, 4, or 5. In some embodiments, the first polyisocyanate has an average isocyanate functionality of 3 to 4.

The second multifunctional crosslinker may be a second polyisocyanate. In some embodiments, the second polyisocyanate has an average isocyanate functionality of 2 to 5. This includes an average isocyanate functionality of 2, 3, 4, or 5. In some embodiments, the second polyisocyanate has an average isocyanate functionality of 3 to 4.

The third multifunctional crosslinker may be a third polyisocyanate. In some embodiments, the third polyisocyanate has an average isocyanate functionality of 2 to 5. This includes an average isocyanate functionality of 2, 3, 4, or 5. In some embodiments, the third polyisocyanate has an average isocyanate functionality of 3 to 4.

In some embodiments, the first multifunctional crosslinker is a first polyisocyanate; the second multifunctional crosslinker, when present, is a second polyisocyanate; the third multifunctional crosslinker, when present, is a third polyisocyanate; wherein the first polyisocyanate, the second polyisocyanate, and the third polyisocyanate are different. In some embodiments, the first multifunctional crosslinker is a first polyisocyanate; the second multifunctional crosslinker, when present, is a second polyisocyanate; the third multifunctional crosslinker, when present, is a third polyisocyanate; wherein the first polyisocyanate, the second polyisocyanate, and the third polyisocyanate are the same.

Each of the first, second, and third polyisocyanates may be prepared from a diisocyanate independently selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In some embodiments, each of the first, second, and third polyisocyanates is independently selected from the group consisting of DESMODUR® N-3300, DESMODUR® N-100, DESMODUR® Z4470SN, WANNATE® T series polyisocyanates, and LUPRANATE® M series polyisocyanates. DESMODUR® N-3300 and DESMODUR® N-100 are aliphatic polyisocyanates based on HDI (hexamethylene diisocyanate) trimer. DESMODUR® Z4470SN is a multifunctional polyisocyanate based on IPDI (isophorone diisocyanate). WANNATE® T series polyisocyanates are toluene diisocyanate (TDI)-based aromatic polyisocyanates. LUPRANATE® M series polyisocyanates are 4,4- diphenylmethane diisocyanate (MDI)-based aromatic polyisocyanates.

The first multifunctional crosslinker may be present in the dried polymer or interpenetrating polymer network in an amount of about 2 wt. % to about 25 wt. %. This includes 2, 3, 4, 5, 6, 7, 8, 9, 10, 11, 12, 13, 14, 15, 16, 17, 18, 19, 20, 21, 22, 23, 24, or 25 wt. %, or any value therebetween. In some embodiments, the first multifunctional crosslinker is present in the dried polymer or interpenetrating polymer network in an amount of about 7 wt. % to about 15 wt. %, or about 5 wt. % to about 20 wt. %.

The second multifunctional crosslinker may be present in the dried polymer or interpenetrating polymer network in an amount of about 0.1 wt. % to about 10 wt. %, This includes 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10 wt. %, or any value therebetween. In some embodiments, the second multifunctional crosslinker is present in the dried polymer or interpenetrating polymer network in an amount of about 1 wt. % to about 10 wt. %, about 2 wt. % to about 8 wt. %, or about 3 wt. % to about 6 wt. %.

The third multifunctional crosslinker may be present in the dried polymer or interpenetrating polymer network in an amount of about 0.1 wt. % to about 20 wt. %. This includes 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 wt. %, or any value therebetween. In some embodiments, the third multifunctional crosslinker is present in the dried polymer or interpenetrating polymer network in an amount of about 1 wt. % to about 20 wt. %, or about 2 wt. % to about 15 wt. %.

In some embodiments, the first adduct has an average isocyanate functionality of 2 to 3. In some embodiments, the first adduct has an average isocyanate functionality of about 2.05 to about 2.3.

The first adduct may be present in the dried polymer or interpenetrating polymer network in an amount of about 5 wt. % to about 70 wt. %. This includes about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt. %, or any value therebetween. In some embodiments, the first adduct is present the dried polymer or interpenetrating polymer network in an amount of about 10 wt. % to about 50 wt. %, about 15 wt. % to about 65 wt. %, about 15 wt. % to about 60 wt. %, about 15 wt. % to about 50 wt. %, about 20 wt. % to about 70 wt. %, about 20 wt. % to about 60 wt. %, or about 20 wt. % to about 50 wt. %.

The polyol may be present in the dried polymer or interpenetrating polymer network in an amount of about 1 wt. % to about 40 wt. %. This includes 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt. %, or any value therebetween. In some embodiments, the polyol is present in the dried polymer or interpenetrating polymer network in an amount of about 5 wt. % to about 25 wt. %.

The polyol may be selected from a group consisting of polyether polyols, polyester polyols, polyacrylic polyols, polymethacrylic polyols, polycaprolactone polyols, polybutadiene polyols, poly(acrylonitrile-co-butadiene) polyols, polysiloxane polyols, a copolymer of any two or more thereof, and a combination of any two or more thereof.

In some embodiments, the polyol comprises, consists essentially of, or consists of polytetramethylene glycol (PTMG), polyethylene glycol (PEG), polypropylene glycol (PPG), or a combination of two or more thereof, or a copolymer of one or more thereof with polyester, polycaprolactone, polybutadiene, poly(acrylonitrile-butadiene), polysiloxane, or polyacrylate. In some embodiments, the polyol is selected from a group consisting of poly(tetramethylene glycol), polyethylene glycol, polypropylene glycol, poly(ethylene glycol-b-propylene glycol-b-ethylene glycol), and poly(propylene glycol-b-polyethylene glycol-b-propylene glycol).

In some embodiments, the polyol comprises, consists essentially of, or consists of a polyether polyol, a polyester polyol, or a combination thereof.

The polyol may have an average molecular weight of about 300 to about 3000 daltons. This includes about 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or 2000 daltons, or any value therebetween. In some embodiments, the polyol has an average molecular weight of about 400 to about 2000, or about 600 to about 1500 daltons.

In some embodiments, the polyol is pre-reacted with the first polyisocyanate to form an isocyanate end-capped prepolymer. In some embodiments, the polyol is pre-reacted with the third polyisocyanate to form an isocyanate end-capped prepolymer.

In some embodiments, the polyethyleneimine intermediate comprises optionally substituted hydroxyalkylene functionality that reacts with the first adduct and, if present, the second multifunctional crosslinker. In some embodiments, the polyethyleneimine intermediate comprises optionally substituted hydroxyalkylene functionality that reacts with the first adduct and, if present, the second multifunctional crosslinker, and if present, the third multifunctional crosslinker.

In some embodiments, the hydroxyalkylene functionality is optionally substituted with C₁-C₆ alkyl optionally substituted with a substituent selected from —N⁺(R²⁰)₃X⁻, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); and each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives. In some embodiments, the hydroxyalkylene functionality is substituted with C₁-C₆ alkyl substituted with—N+(R²⁰)₃X⁻, each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); and each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives. In some embodiments, the hydroxyalkylene functionality is substituted with —(CH₂)—N+(Me)₃Cl⁻. In some embodiments, the hydroxyalkylene functionality is hydroxyethylene, hydroxypropylene, hydroxybutylene, or an oligomer thereof.

In some embodiments, the polyethyleneimine intermediate comprises a reaction product of reagents comprising a polyethyleneimine, a mono-epoxide, and an alkylating agent, wherein the mono-epoxide is optionally substituted with C₁-C₆ alkyl optionally substituted with a substituent selected from —(C₆-C₁₀ aryl), and —(C₁-C₆ alkoxy) optionally substituted with hydroxy, C₁-C₆ alkoxy, C₆-C₁₀ aryl optionally substituted with C₁-C₆ alkyl, and carboxy.

In some embodiments, the mono-epoxide is a C₁-C₆ alkyl epoxide. In some embodiments, the C₁-C₆ alkyl epoxide is selected from the group consisting of propyl epoxide, butyl epoxide, and hexyl epoxide. In some embodiments, the C₁-C₆ alkyl epoxide is propyl epoxide. In some embodiments, the C₁-C₆alkyl epoxide is butyl epoxide. In some embodiments, the C₁-C₆ alkyl epoxide is hexyl epoxide.

In some embodiments, the polyethyleneimine intermediate comprises a reaction product of reagents comprising a polyethyleneimine, a mono-epoxide, and optionally an alkylating agent; the mono-epoxide is substituted with —(C₁-C₆ alkyl)-N⁺(R²⁰)₃X⁻; each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); and each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In some embodiments, the polyethyleneimine intermediate comprises a reaction product of reagents comprising a polyethyleneimine and a mono-epoxide; the mono-epoxide is substituted with —(C₁-C₆ alkyl)-N⁺(R²⁰)₃X⁻; each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); and each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In some embodiments, the alkylating agent comprises one or more R²¹-LG, wherein each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH; and each LG is a leaving group. As used herein, and unless otherwise indicated, the leaving group may be a halide, a sulfonate, or the like. In some embodiments, the alkylating agent is benzyl halide or hexyl halide.

In some embodiments, the polyethyleneimine intermediate comprises a reaction product of reagents comprising a polyethyleneimine and a haloalkanol. In some embodiments, the haloalkanol is X³⁰—(C₂-C₆ alkylene)-OH, wherein X³⁰ is Cl, Br, or I.

In some embodiments, the reagents for the reaction product comprised in the polyethyleneimine intermediate further comprise a monoisocyanate. In some embodiments, the monoisocyanate comprises one or more R³⁰—NCO, wherein each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently C₁-C₆ alkyl; and each R^{b} and each R^{c} are independently selected from —(C₁-C₆ alkyl) and —Si(C₁-C₆ alkyl)₃. In some embodiments, the monoisocyanate comprises octylisocyanate, octadecylisocyanate, or a combination thereof.

The polyethyleneimine intermediate may be present in the dried polymer or interpenetrating polymer network in an amount of about 0.1 wt. % to about 50 wt. %. This includes 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt. %, or any value therebetween. In some embodiments, the polyethyleneimine intermediate is present in the dried polymer or interpenetrating polymer network in an amount of about 3 wt. % to about 30 wt. %.

In some embodiments, at least 20% of the nitrogen atoms of the polyethyleneimine intermediate are quaternized. In some embodiments, at least 30% of the nitrogen atoms of the polyethyleneimine intermediate are quaternized.

The polyethyleneimine may have a molecular weight of about 300 to about 270,000 daltons. This includes about 300; 400; 500; 600; 700; 800; 900; 1000; 2500; 5000; 10,000; 25,000; 50,000; 75,000; 100,000; 125,000; 150,000; 175,000; 200,000; 225,000; 250,000; or 270,000 daltons, or any value therebetween. In some embodiments, the polyethyleneimine has a molecular weight of about 10,000 to about 200,000 daltons, or about 25,000 to about 120,000 daltons.

In some embodiments, the polyethyleneimine is branched. In some embodiments, the polyethyleneimine is hyperbranched.

In some embodiments, the polyethyleneimine has a ratio of primary to secondary to tertiary amines of about 1:2:1 to about 1:1:1. In some embodiments, the polyethyleneimine has a ratio of primary to secondary to tertiary amines of about 1:1:0.7.

In some embodiments, the polyethyleneimine intermediate is selected from

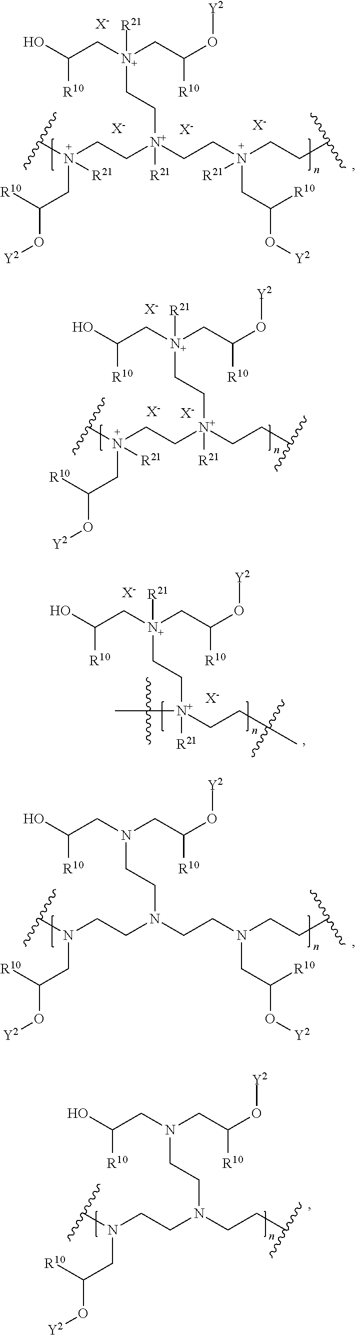

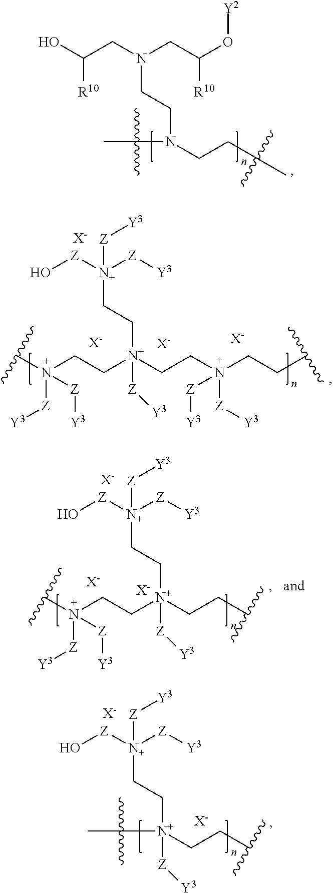

or a copolymer of any two or more thereof, wherein:
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000, preferably an integer independently selected from 10 to 1000;
Z is —(C₂-C₆ alkylene)-;
each R¹⁰ is independently selected from hydrogen; C₁-C₆ alkyl optionally substituted with a substituent selected from —N(R²⁰)₃, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently —(C₁-C₆ alkyl); and each R^{b} and each R^{c} are independently selected from —(C₁-C₆ alkyl) and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy, then the polyethyleneimine intermediate is selected from

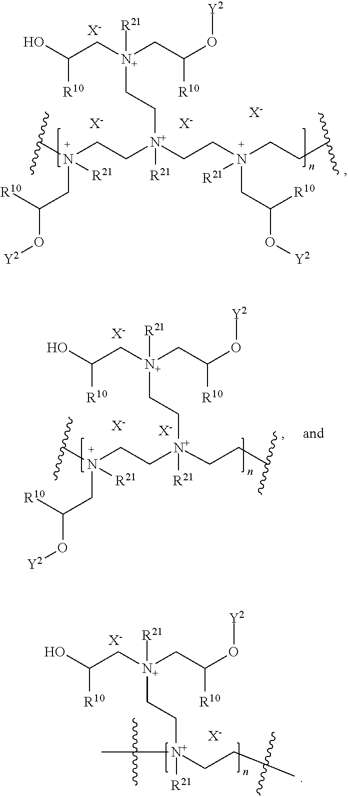

In some embodiments, the polyethyleneimine intermediate is selected from:

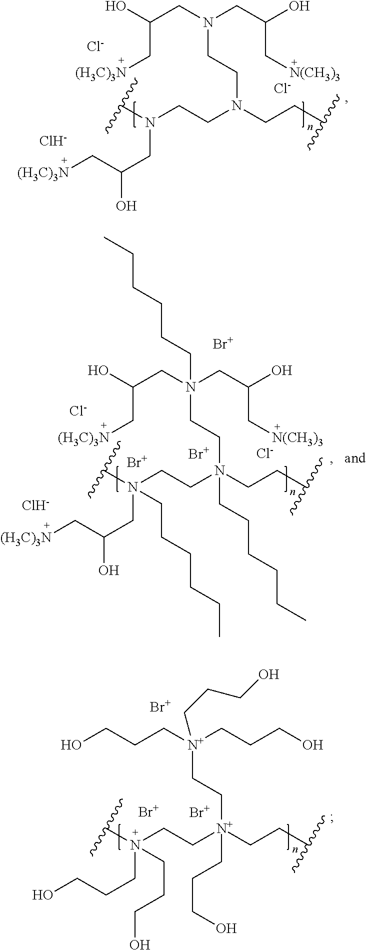

wherein each n is an integer independently selected from 1 to 3000, preferably an integer independently selected from 10 to 1000.

In some embodiments, the second adduct is of formula (I):

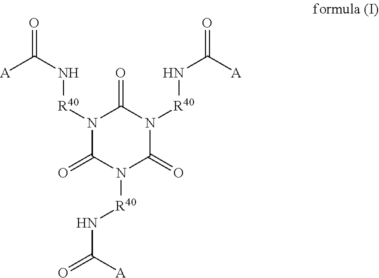

wherein:
each A is independently selected from

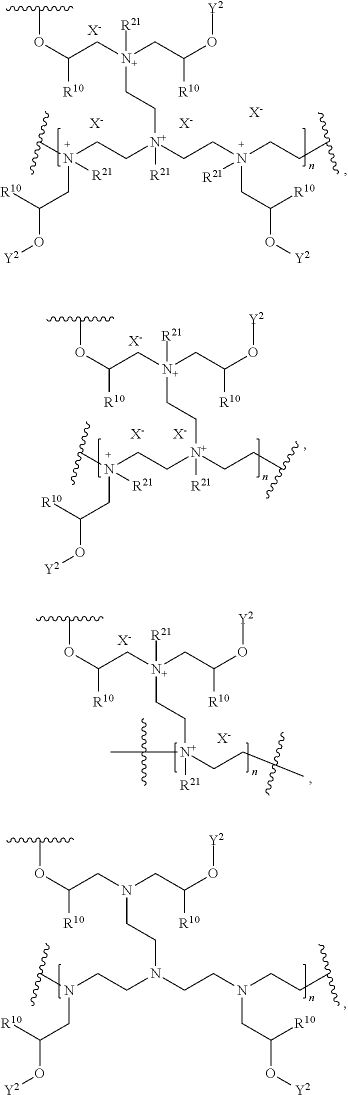

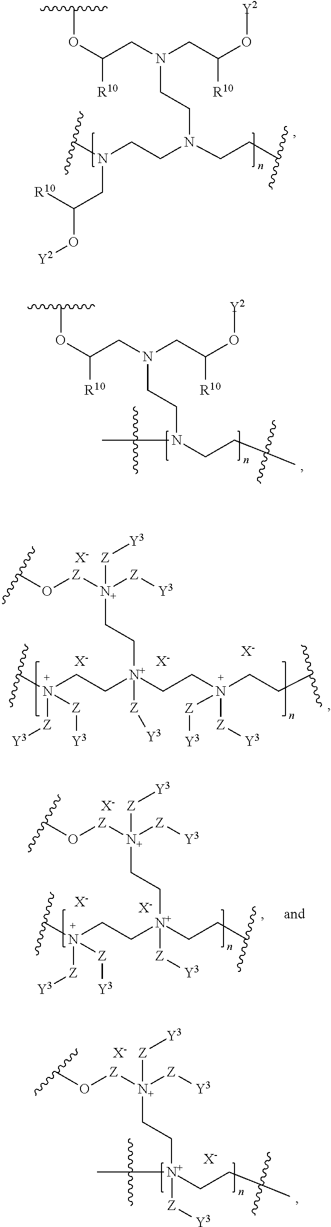

or a copolymer of any two or more thereof; and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰; each n is an integer independently selected from 1 to 3000, preferably an integer independently selected from 10 to 1000;
Z is —(C₂-C₆ alkylene)-;
each R¹⁰ is independently selected from hydrogen; C₁-C₆ alkyl optionally substituted with a substituent selected from —N(R²⁰)₃, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3)

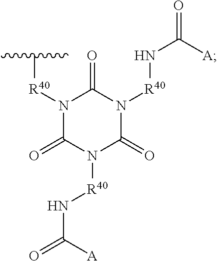

wherein each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy, then each A is independently selected from

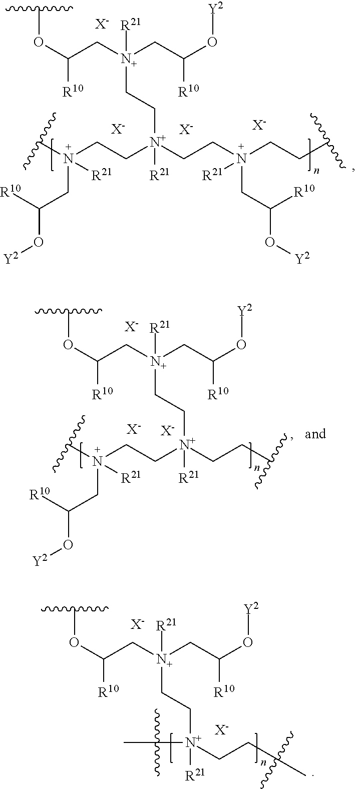

In some embodiments, the second adduct is of formula (II):

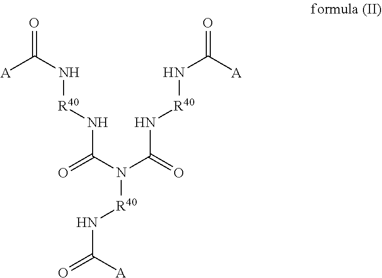

wherein:
each A is independently selected from

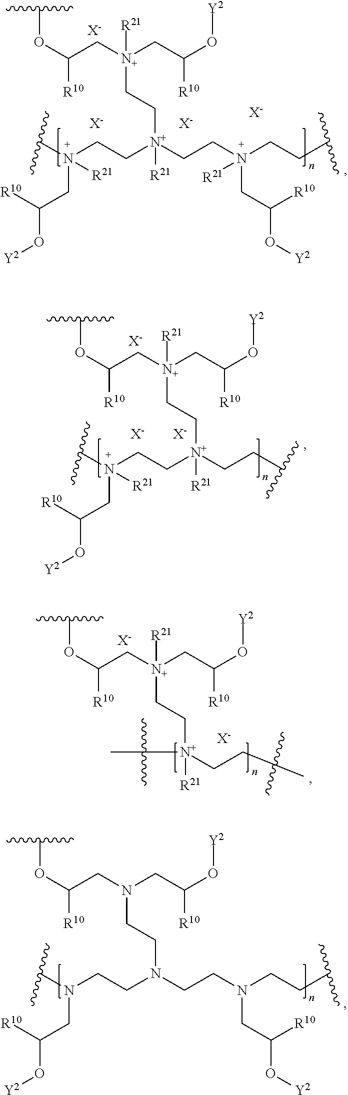

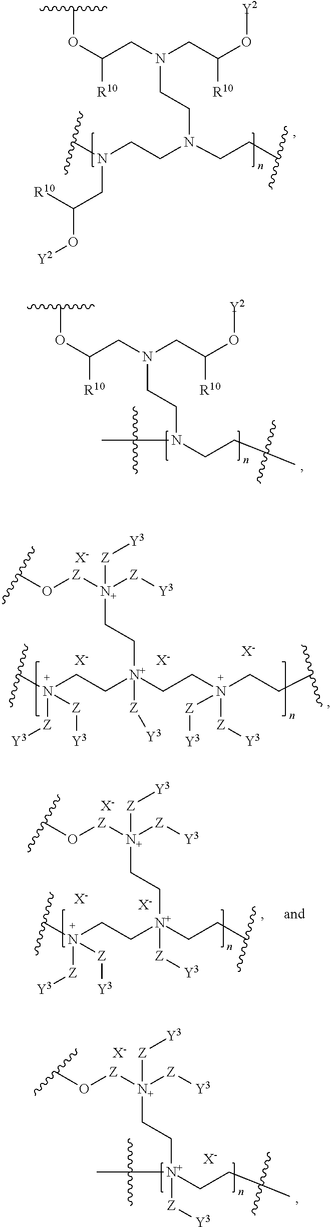

or a copolymer of any two or more thereof; and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰; each n is an integer independently selected from 1 to 3000, preferably an integer independently selected from 10 to 1000;
Z is —(C₂-C₆ alkylene)-;
each R¹⁰ is independently selected from hydrogen; C₁-C₆ alkyl optionally substituted with a substituent selected from —N(R²⁰)₃, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3

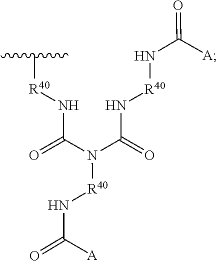

wherein each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), and carboxy, then each A is independently selected from

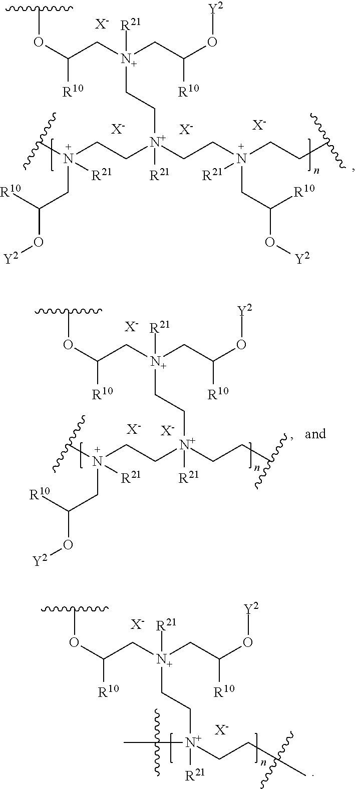

In some embodiments, the second adduct is present in the dried polymer or interpenetrating polymer network in an amount of about 1 wt. % to about 30 wt. %. This includes about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt. %, or any value therebetween. In some embodiments, the second adduct is present in the dried polymer or interpenetrating polymer network in an amount of from about 3 wt. % to about 15 wt. %.

The reagents for the random polymerization/crosslinking product may further comprise a third adduct of (i) the first multifunctional crosslinker or a fourth multifunctional crosslinker; and (ii) a second quaternary ammonium salt

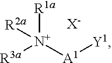

wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁ arylene)-(C₃-C₂₀ alkylene), —(CR^{m1}Rⁿ¹)ₓ₄₂—W⁴²—(CR^{p1}R^{q1})_{y42}-, and —(CR^{m1}Rⁿ¹)ₓ₄₃—W³—(CR^{p1}R^{q1})_{y43}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl; W⁴² is selected from —C(O)—; —C(O)O—; —OC(O)—; —C(O)NH—; and —NHC(O)—; W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a},

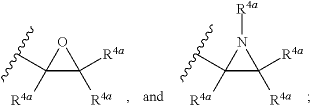

each R^{4a} is independently selected from a group consisting of H, (C—(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

The fourth multifunctional crosslinker may be present in the dried polymer or interpenetrating polymer network in an amount of about 0.1 wt. % to about 15 wt. %. This includes 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 11, 12, 13, 14, or 15 wt. %, or any value therebetween. In some embodiments, the fourth multifunctional crosslinker is present in the dried polymer or interpenetrating polymer network in an amount of about 2 wt. % to about 8 wt. %.

The fourth multifunctional crosslinker may be different from the first multifunctional crosslinker and, if present, from the second multifunctional crosslinker, and if present, from the third multifunctional crosslinker.

In some embodiments, the fourth multifunctional crosslinker is a fourth polyisocyanate. In some embodiments, the fourth polyisocyanate is prepared from diisocyanates selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI). In some embodiments, the fourth polyisocyanate is selected from the group consisting of DESMODUR® N-3300, DESMODUR® N-100, DESMODUR® Z4470SN, WANNATE® T series polyisocyanates, and LUPRANATE® M series polyisocyanates.

In some embodiments, the second quaternary ammonium salt is

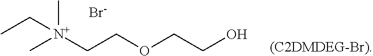

The second quaternary ammonium salt may be present in the dried polymer or interpenetrating polymer network in an amount of about 1 wt. % to about 15 wt. %. This includes about 1, 2, 3, 4, 5, 6, 7, 8, 9, 10, 11, 12, 13, 14, or 15 wt. %, or any value therebetween. In some embodiments, the second quaternary ammonium salt is present in the dried polymer or interpenetrating polymer network in an amount of about 3 wt. % to about 10 wt. %.

In some embodiments, the third adduct has an average isocyanate functionality of 2 to 3. In some embodiments, the third adduct has an average isocyanate functionality of 2.05 to about 2.3.

The third adduct may be present in the dried polymer or interpenetrating polymer network in an amount of about 2 wt. % to about 30 wt. %. This includes about 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt. %, or any value therebetween. In some embodiments, the second quaternary ammonium salt is present in the dried polymer or interpenetrating polymer network in an amount of about 3 wt. % to about 20 wt. %.

The reagents for the random polymerization/crosslinking product may further comprise a chain extender selected from a group consisting of HO—(CₙH₂ₙ)—OH and HO—(CₙH₂n-₂)—OH, or a combination thereof, wherein n is an integral between 2 and 8. In some embodiments, the chain extender is propanediol, 1,4-butanediol, neopentyl glycol, hexanediol, cyclohexane dimethanol, or a combination of two or more thereof. The chain extender may be present in the dried polymer or interpenetrating polymer network in an amount of about 0.5 wt. % to about 10 wt. %. This includes about 0.5, 1, 2, 3, 4, 5, 6, 7, 8, 9, or 10 wt. %, or any value therebetween. In some embodiments, the chain extender may be present in the dried polymer or interpenetrating polymer network in an amount of about 1 wt. % to about 5 wt. %.

In another aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; (ii) optionally a polyol; (iii) a polyethyleneimine intermediate or a second adduct of the polyethyleneimine intermediate and a second multifunctional crosslinker; (iv) optionally a third multifunctional crosslinker; (v) optionally a third adduct of (a) the first multifunctional crosslinker or a fourth multifunctional crosslinker, and (b) a second quaternary ammonium salt; (vi) optionally a chain extender; and (vii) a water-soluble polymer.

In another aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; (ii) optionally a polyol; (iii) a polyethyleneimine intermediate or a second adduct of the polyethyleneimine intermediate and a second multifunctional crosslinker; (iv) optionally a third multifunctional crosslinker; (v) optionally a third adduct of (a) the first multifunctional crosslinker or a fourth multifunctional crosslinker, and (b) a second quaternary ammonium salt; and (vi) optionally a chain extender.

In some embodiments, a first quaternary ammonium salt reacts with a first polyisocyanate to form a first adduct, wherein the first adduct retains unreacted isocyanate functionality from the first polyisocyanate. In some embodiments, about 10% to about 40%, preferably about 25% to about 33% of isocyanate functionality on the first polyisocyanate is converted to, for example, urethane or urea by reaction with the first quaternary ammonium salt. The unreacted isocyanate functionality subsequently reacts with one or more of the polyol (if present), the chain extender (if present), the polyethyleneimine intermediate or the second adduct, water, and the water-soluble polymer (if reactive). Similarly, in some embodiments, the second quaternary ammonium salt reacts with the first polyisocyanate or a fourth polyisocyanate to form a third adduct, wherein the third adduct retains unreacted isocyanate functionality from the first or fourth polyisocyanate. In some embodiments, about 10% to about 40%, preferably about 25% to 33% of isocyanate functionality on the first or fourth polyisocyanate is converted to, for example, urethane or urea by reaction with the second quaternary ammonium salt. If present, the third multifunctional crosslinker and/or third adduct may also react with one or more of the polyol (if present), the chain extender (if present), the polyethyleneimine intermediate or the second adduct, water, and the water-soluble polymer (if reactive). The first adduct and the third adduct are pre-formed prior to interaction with the polyol (if present), the chain extender (if present), the polyethyleneimine intermediate or the second adduct, and the water-soluble polymer (if reactive).

In another aspect, a polymer or interpenetrating polymer network is prepared by
(a) reacting a first multifunctional crosslinker with a first quaternary ammonium salt to form a first adduct;
(b) optionally reacting a polyethyleneimine intermediate with a second multifunctional crosslinker to form a second adduct;
(c) optionally reacting the first multifunctional crosslinker or a fourth multifunctional crosslinker with a second quaternary ammonium salt to form a third adduct;
(d) combining (i) the first adduct, (ii) the polyethyleneimine intermediate or the second adduct, and (iii) when present, the third adduct, with optionally a polyol and optionally a third multifunctional crosslinker to form an oil phase;
(e) dissolving a water-soluble polymer in water to form an aqueous phase;
(f) combining the oil phase and the aqueous phase to form an oil-in-water emulsion; and
(g) applying the emulsion onto a surface and allowing the emulsion to dry and cure on the surface to form the polymer or interpenetrating polymer network on the surface.

In some embodiments, a blocking agent is added to the oil phase after step (d) but before step (f.

In some embodiments, step (d) further comprises combining (i) the first adduct, (ii) the polyethyleneimine intermediate or the second adduct, and (iii) when present, the third adduct with optionally the polyol and optionally the second multifunctional crosslinker in an organic solvent or diluent to form the oil phase.

In some embodiments, step (d) further comprises adding a chain extender to the oil phase. In some embodiments, step (e) further comprises adding a chain extender to the aqueous phase.

In some embodiments, step (e) further comprises adding a surfactant to the aqueous phase. In some embodiments, step (e) further comprises adding a defoamer or antifoamer to the aqueous phase. In some embodiments, step (e) further comprises adding a surfactant and either a defoamer or antifoamer to the aqueous phase.

In some embodiments, step (f) further comprises performing a direct emulsification process whereby the emulsion is formed by vigorous shear and mixing. In some embodiments, step (f) further comprises performing a direct emulsification process whereby the emulsion is formed by sonication.

In some embodiments, step (f) further comprises performing a phase inversion emulsification process whereby a water-in-oil emulsion is first prepared, followed by phase inversion to form the oil-in-water emulsion. The phase inversion may be conducted by, for example, changing the phase ratio, temperature, surfactant, solvent, or any combination of two or more thereof.

In some embodiments, a multiphase water-in-oil-in-water emulsion is formed prior to conversion to the oil-in-water emulsion in step (f).

In some embodiments, combining the oil phase and the aqueous phase in step (f) forms a combination of the oil-in-water emulsion and a multiphase water-in-oil-in-water emulsion.

In another aspect, reagents for the preparation of a polymer or interpenetrating polymer network described herein are comprised in an antimicrobial composition.

Accordingly, in another aspect, provided herein is an antimicrobial composition comprising an oil-in-water emulsion, wherein the oil-in-water emulsion comprises
(i) an oil phase comprising
   a first adduct of a first multifunctional crosslinker and a first quaternary ammonium salt, wherein the first quaternary ammonium salt has a reactive linking group to react with the first multifunctional crosslinker;
   optionally a polyol;
   a polyethyleneimine intermediate, or a second adduct of the polyethyleneimine intermediate and a second multifunctional crosslinker; and
   optionally a third multifunctional crosslinker; and
(ii) an aqueous phase comprising a water-soluble polymer.
   This composition may be applied to a surface and allowed to dry and cure, thereby forming a polymer or interpenetrating polymer network of the present technology.

The reactive linking group of the first quaternary ammonium salt may be selected from a group consisting of —OH, —NHR⁴, —SH, —CO₂H, —C(O)NHR⁴, —C(S)NHR⁴,

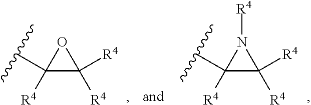

wherein each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

The first quaternary ammonium salt, as described herein and incorporated into the first adduct, may be present in the oil phase in an amount of about 1% to about 50% by weight based on the dry weight of the oil phase. As used herein, and unless otherwise indicated, “dry weight of the oil phase” refers to weight of the oil phase in the absence of any organic solvent and any water. This includes about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50%, or any value therebetween. In some embodiments, the first quaternary ammonium salt, incorporated into the first adduct, is present in the oil phase in an amount of about 1% to about 25%, or about 5% to about 25% by weight based on the dry weight of the oil phase.

The first multifunctional crosslinker (e.g., the first polyisocyanate), as described herein and incorporated into the first adduct, may be present in the oil phase in an amount of about 2% to about 25% by weight based on the dry weight of the oil phase. This includes about 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25%, or any value therebetween. In some embodiments, the first multifunctional crosslinker (e.g., the first polyisocyanate), incorporated into the first adduct, is present in the oil phase in an amount of about 5% to about 20% by weight based on the dry weight of the oil phase.

The first adduct as described herein may be present in the oil phase in an amount of about 5% to about 70% by weight based on the dry weight of the oil phase. This includes about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70%, or any value therebetween. In some embodiments, the first adduct is present in the oil phase in an amount of about 10% to about 50%, about 15% to about 65%, about 15% to about 60%, about 15% to about 50%, about 20% to about 70%, about 20% to about 60%, or about 20% to about 50%, by weight based on the dry weight of the oil phase.

The polyethyleneimine intermediate as described herein may be present in the oil phase in an amount of about 0.1% to about 50% by weight based on the dry weight of the oil phase. This includes 0.1%, 0.25%, 0.5%, 0.75%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50%, or any value therebetween. In some embodiments, the polyethyleneimine intermediate is present in the oil phase in an amount of about 3% to about 30% by weight based on the dry weight of the oil phase.

The second multifunctional crosslinker (e.g., the second polyisocyanate), as described herein and incorporated into the second adduct, may be present in the oil phase in an amount of about 0.1% to about 10% by weight based on the dry weight of the oil phase. This includes about 0.1%, 0.25%, 0.5%, 0.75%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10%, or any value therebetween. In some embodiments, the second multifunctional crosslinker (e.g., the second polyisocyanate) is present in the oil phase in an amount of about 2% to about 8%, or about 3% to about 6%, by weight based on the dry weight of the oil phase.

The second adduct as described herein may be present in the oil phase in an amount of about 1% to about 30% by weight based on the dry weight of the oil phase. This includes about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30%, or any value therebetween. In some embodiments, the second adduct is present in the oil phase in an amount of about 3% to about 15% by weight based on the dry weight of the oil phase.

In some embodiments, the oil phase further comprises a third multifunctional crosslinker as described herein. The third multifunctional crosslinker (e.g., the third polyisocyanate) may be present in the oil phase in an amount of about 5% to about 25% by weight based on the dry weight of the oil phase. This includes about 5%, 6%, 7%, 8%, 9%, 10%, 11%, 12%, 13%, 14%, 15%, 16%, 17%, 18%, 19%, 20%, 21%, 22%, 23%, 24%, or 25%, or any value therebetween. In some embodiments, the third multifunctional crosslinker (e.g., the third polyisocyanate) is present in the oil phase in an amount of about 5% to about 20% by weight based on the dry weight of the oil phase.

In some embodiments, the oil phase further comprises a third adduct as described herein. The third adduct may be present in the oil phase in an amount of about 2% to about 30% by weight based on the dry weight of the oil phase. This includes about 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30%, or any value therebetween. In some embodiments, the third adduct is present in the oil phase in an amount of about 3% to about 20% by weight based on the dry weight of the oil phase.

In some embodiments, the second quaternary ammonium salt, as described herein and incorporated into the third adduct, is present in the oil phase in an amount of about 1% to about 15% by weight based on the dry weight of the oil phase. This includes about 1%, 2%, 3%, 4%, 5%, 6%, 7%, 8%, 9%, 10%, 11%, 12%, 13%, 14%, or 15%, or any value therebetween. In some embodiments, the second quaternary ammonium salt, as described herein and incorporated into the third adduct, is present in the oil phase in an amount of about 3% to about 10% by weight based on the dry weight of the oil phase.

The fourth multifunctional crosslinker (e.g., the fourth polyisocyanate), as described herein and incorporated into the third adduct, may be present in the oil phase in an amount of about 0.1% to about 15% by weight based on the dry weight of the oil phase. This includes about 0.1%, 0.25%, 0.5%, 0.75%, 1%, 1.5%, 2%, 2.5%, 3%, 3.5%, 4%, 4.5%, 5%, 4.5%, 6%, 6.5%, 7%, 7.5%, 8%, 8.5%, 9%, 9.5%, 10%, 11%, 12%, 13%, 14%, or 15%, or any value therebetween. In some embodiments, the fourth multifunctional crosslinker (e.g., the fourth polyisocyanate), as described herein and incorporated into the third adduct, is present in the oil phase in an amount of about 2% to about 8% by weight based on the dry weight of the oil phase.

In some embodiments, reactive isocyanate functionality on the first adduct and/or the third adduct is protected with a blocking agent. Reaction with the blocking agent converts the reactive isocyanate functionality to blocked isocyanates (i.e., the isocyanate group is reversibly protected from immediate reaction with a nucleophile). This decreases the rate of polyisocyanate reaction with water in a subsequent emulsification step and/or the cross-linking reaction with, for example, any polyol(s) in the oil phase and/or the water-soluble polymer (such as hydroxyethyl cellulose) in the aqueous phase. In some embodiments, there is significant improvement in the reproducibility of the rheology properties, particle size and distribution of the resultant emulsion. In some embodiments, the coatability and process window of the coating process are also significantly improved. In some embodiments, the defect rate of resultant surface coatings is reduced and the yield rate of coated products is also improved. In some embodiments, no blocking agent is used in order to provide a more rapidly curing coating.

In some embodiments, the blocking agent is selected from a group consisting of oximes, phenols, malonates, alcohols, lactams, dicarbonyl compounds, hydroxamates, bisulfite addition compounds, hydroxylamines, esters of p-hydroxybenzoic acid and salicylic acid. In some embodiments, the blocking agent is selected from a group consisting of acetone oxime, methyl ethyl ketone oxime, sodium bisulfite, diethyl malonate, and 3,5-dimethylpyrazole.

In some embodiments, the composition further comprises a de-blocking agent. The de-blocking agent includes, but is not limited to, organotin, organobismuth, and tert-amines. Non-limiting examples include triethanolamine; N,N,N′N′-tetrakis(2-hydroxyethyl) ethylene diamine; and K-KAT XK-651 (bismuth carboxylate catalyst).

In some embodiments, the oil phase further comprises a chain extender selected from a group consisting of HO—(CₙH₂ₙ)—OH and HO—(CₙH₂ₙ₋₂)—OH, or a combination thereof, wherein n is an integral between 2 and 8. In some embodiments, the chain extender is propanediol, 1,4-butanediol, neopentyl glycol, hexanediol, cyclohexane dimethanol, or a combination of two or more thereof. The chain extender may be present in the oil phase in an amount of up to about 10% by weight based on the dry weight of the oil phase. This includes about 0.5%, 1%, 2%, 3%, 4%, 5%, 6%, 7%, 8%, 9%, 10%, or any value therebetween. In some embodiments, the chain extender is present in the oil phase in an amount of about 0.5% to about 10%, or about 1% to about 5% by weight based on the dry weight of the oil phase.

In some embodiments, the oil phase further comprises an organic solvent or diluent. In some embodiments, the organic solvent or diluent in the oil phase is water miscible. In some embodiments, the organic solvent or diluent is acetone. In some embodiments, the organic solvent or diluent is present in the oil phase in an amount of about 5% to about 35% by weight based on the weight of the oil phase. This includes about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35%, or any value therebetween. In some embodiments, the organic solvent or diluent is present in the oil phase in an amount of about 10% to about 30% by weight based on the weight of the oil phase.

The polyol may be present in the oil phase in an amount of about 1% to about 40% by weight based on the dry weight of the oil phase. This includes about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40%, or any value therebetween. In some embodiments, the polyol is present in the oil phase in an amount of about 5% to about 25% by weight based on the dry weight of the oil phase.

Weight percentage of the water-soluble polymer in the aqueous phase is calculated by the amount present in the oil phase for interaction with the oil phase itself and/or oil phase constituents (e.g., the first adduct, the optional second multifunctional crosslinker). The water-soluble polymer as described herein may be present in the aqueous phase in amount of about 0.5% to about 15% by weight of the dry weight of the oil phase. This includes about 0.5%, 1%, 2%, 3%, 4%, 5%, 6%, 7%, 8%, 9%, 10%, 11%, 12%, 13%, 14%, or 15%, or any value therebetween. In some embodiments, the water-soluble polymer as described herein is present in the aqueous phase in amount of about 3% to about 12%, or about 5% to about 10% by weight of the dry weight of the oil phase.

The water-soluble polymer may be a reactive water-soluble polymer and crosslinks with one or more of the first adduct and the third multifunctional crosslinker (if present). In some embodiments, the water-soluble polymer is a reactive water-soluble polymer and crosslinks with the first adduct, the third multifunctional crosslinker (if present), the third adduct (if present), or any combination of two or more thereof.

In some embodiments, the water-soluble polymer is a non-reactive water-soluble polymer and does not covalently bond to any component (e.g., the first adduct, the third multifunctional crosslinker (if present), the third adduct (if present), or any combination of two or more thereof) in the oil or water phase.

In some embodiments, the aqueous phase further comprises a water-soluble low molecular weight chain extender or crosslinker. The inclusion of the water-soluble low molecular weight chain extender or crosslinker may increase the degree of crosslinking of the random polymerization product. Examples of a water-soluble low molecular weight chain extender or crosslinker include, but are not limited to, multifunctional amines such as ethylene diamine, diethylene triamine, and triethylene tetraamine.

In some embodiments, the aqueous phase further comprises a surfactant. In some embodiments, the surfactant is a non-ionic surfactant. In some embodiments, the non-ionic surfactant preferably has an average HLB (hydrophilic-lipophilic balance) value of about 12 to about 15. Non-ionic surfactants include, but are not limited to, TRITON™ X-114 ((1,1,3,3-tetramethylbutyl)phenyl-polyethylene glycol), SILWET™ L-7604 (siloxane polyalkyleneoxide copolymer), and a combination thereof.

Weight percentage of the surfactant in the aqueous phase is calculated by the amount present in the oil phase for interaction with or adsorption on the oil phase. The surfactant may be present in the aqueous phase in an amount of about 0.01% to about 2% by weight based on the dry weight of the oil phase. This includes about 0.05%, 0.075%, 0.1%, 0.25%, 0.5%, 0.75%, 1%, 1.25%, 1.5%, 1.75%, or 2%, or any value therebetween. In some embodiments, the surfactant is present in the aqueous phase in an amount of about 0.05% to about 2%, or about 0.1% to about 1% by weight based on the dry weight of the oil phase.

In some embodiments, the aqueous phase further comprises a defoamer or antifoamer. In some embodiments, the defoamer is FOAMSTAR® ST 2410 (star polymer-based defoamer).

The polyethyleneimine intermediates may be used as antimicrobial compounds. In some embodiments, quaternization is not on the polyethyleneimine backbone, but on pendant substitution. Accordingly, in another aspect, provided herein is an antimicrobial compound selected from:

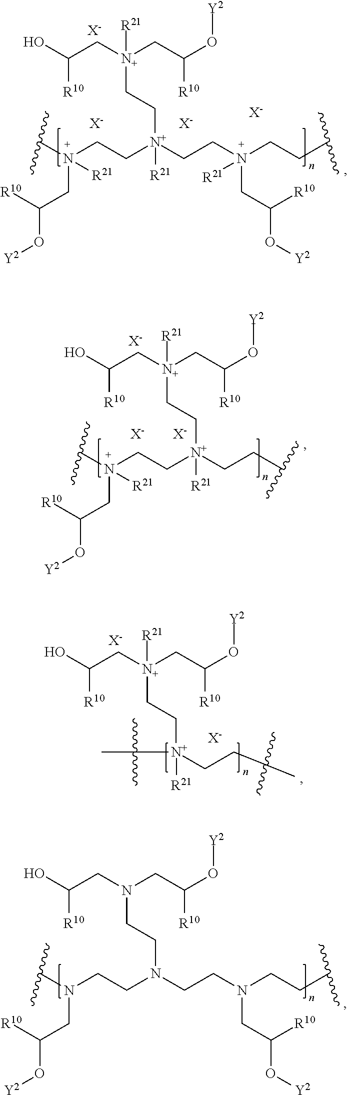

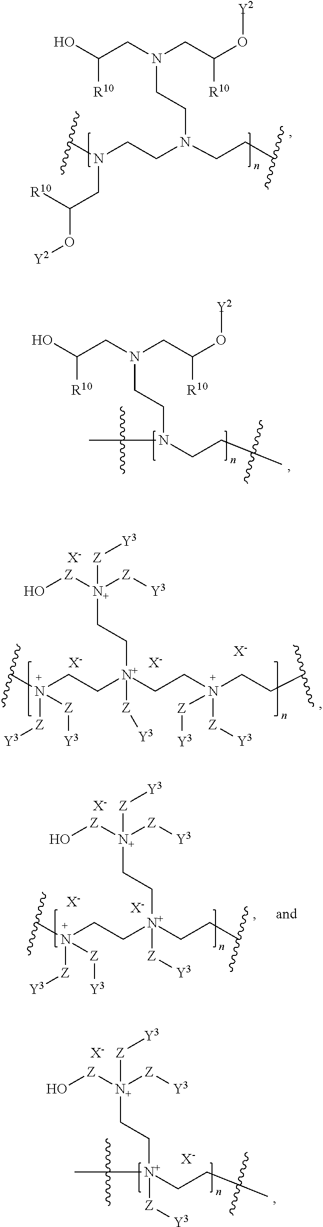

or a copolymer of any two or more thereof, wherein:
each Y³ is independently H or —O—Y², wherein every Y³ cannot be H;
each Y² is independently H or —C(O)—NHR³⁰, wherein every Y² cannot be —C(O)—NHR³⁰; each n is an integer independently selected from 1 to 3000, preferably an integer independently selected from 10 to 1000;
Z is —(C₂-C₆ alkylene)-;
each R¹⁰ is C₁-C₆ alkyl substituted with —N⁺(R²⁰)₃X⁻, and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently —(C₁-C₆ alkyl); and each R^{b} and each R^{c} are independently selected from —(C₁-C₆ alkyl) and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In some embodiments, each Y² is H. In some embodiments, the compound is

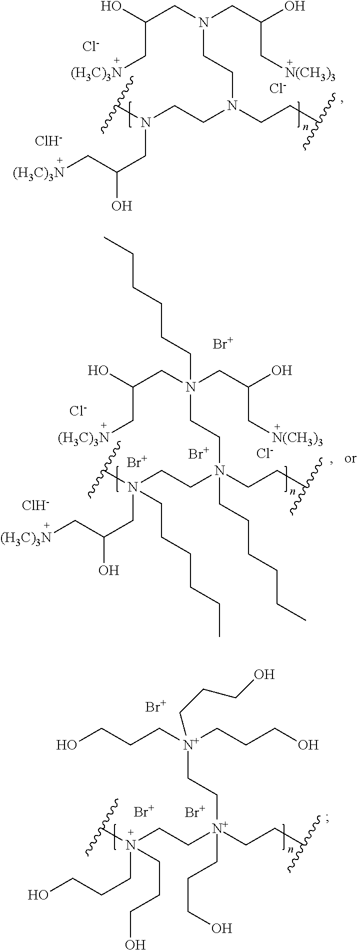

wherein each n is an integer independently selected from 1 to 3000, preferably an integer independently selected from 10 to 1000.

The second adduct, which is a random polymerization product of the polyethyleneimine intermediates disclosed herein with a (multifunctional) crosslinker, may be used as an antimicrobial compound. Accordingly, provided herein, in another aspect, is a random polymerization product of a polyethyleneimine intermediate and a crosslinker, wherein the polyethyleneimine intermediate is selected from:

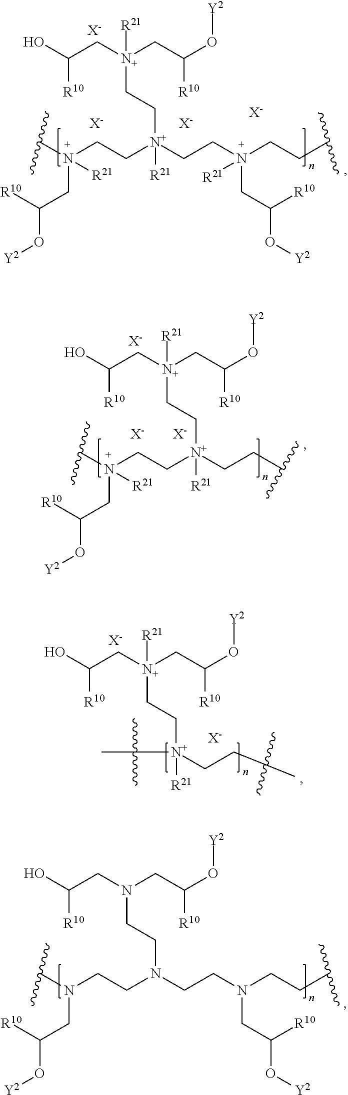

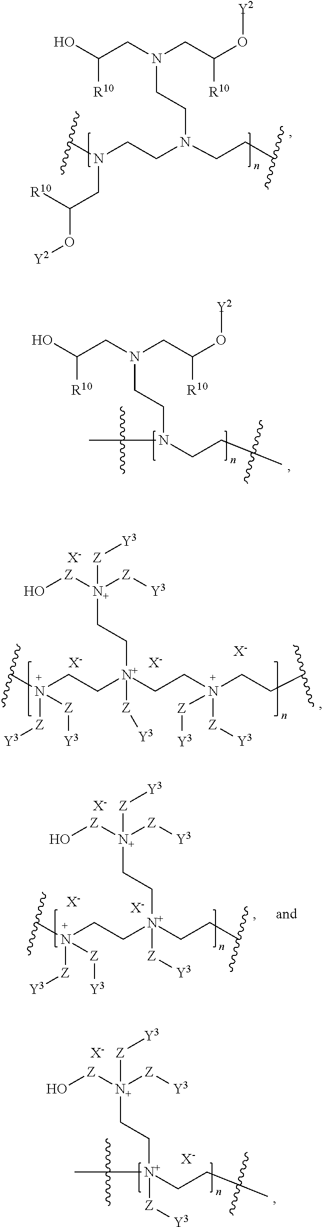

or a copolymer of any two or more thereof, wherein:
each Y³ is independently H or —O—Y², wherein every Y³ cannot be H;
each Y² is independently H or —C(O)—NHR³⁰, wherein every Y² cannot be —C(O)—NHR³⁰; each n is an integer independently selected from 1 to 3000, preferably an integer independently selected from 10 to 1000;
Z is —(C₂-C₆ alkylene)-;
each R¹⁰ is C₁-C₆ alkyl substituted with —N⁺(R²⁰)₃X⁻, and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently—(C₁-C₆ alkyl); and each R^{b} and each R^{c} are independently selected from —(C₁-C₆ alkyl) and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In some embodiments, the crosslinker is a polyisocyanate. In some embodiments, the polyisocyanate is prepared from a diisocyanate independently selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI). In some embodiments, the polyisocyanate is independently selected from a group consisting of DESMODUR® N-3300, DESMODUR® N-100, DESMODUR® Z4470SN, WANNATE® T series polyisocyanates, and LUPRANATE® M series polyisocyanates.

In some embodiments, the random polymerization product is of formula (I):

wherein:

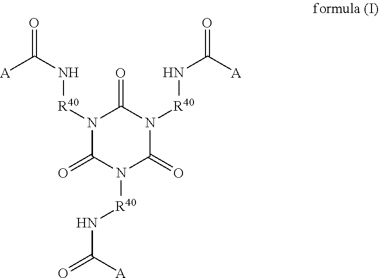

each A is independently selected from

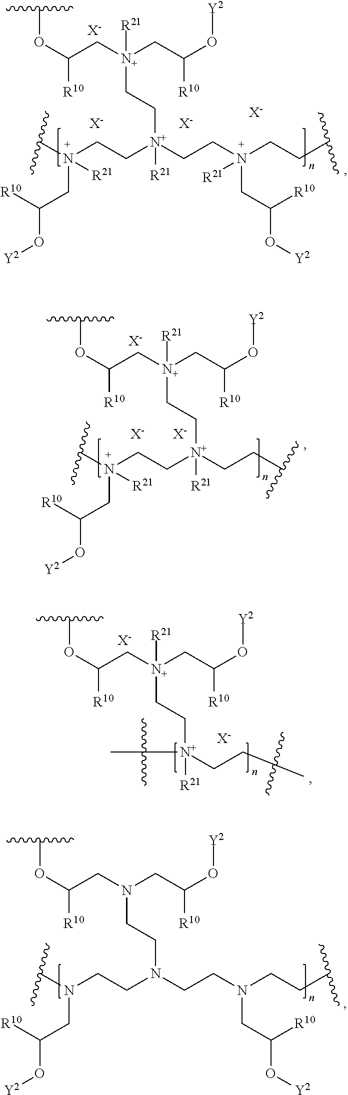

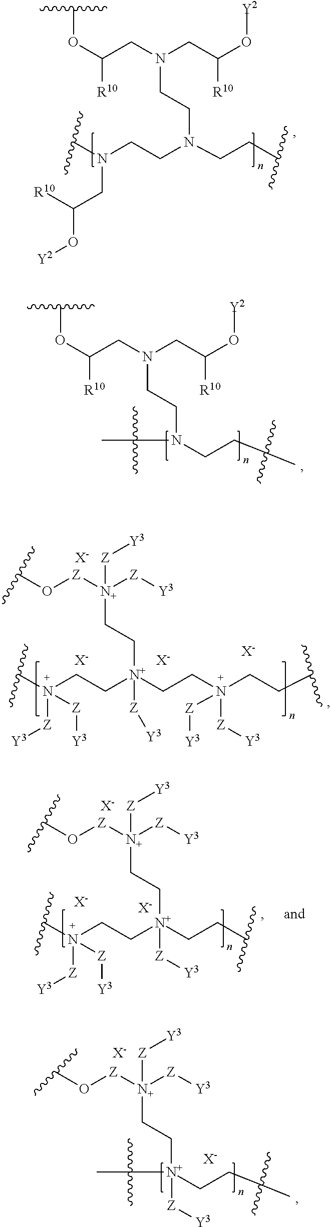

or a copolymer of any two or more thereof; and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰; each n is an integer independently selected from 1 to 3000, preferably an integer independently selected from 10 to 1000;
Z is —(C₂-C₆ alkylene)-;
each R¹⁰ is C₁-C₆ alkyl substituted with —N⁺(R²⁰)₃X⁻, and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3)

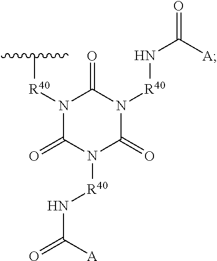

wherein
each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

In some embodiments, the random polymerization product is of formula (II):

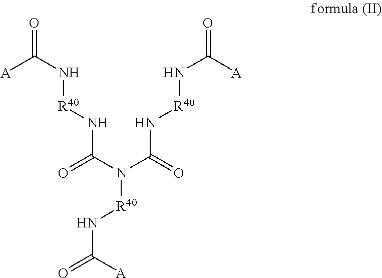

wherein:
each A is independently selected from

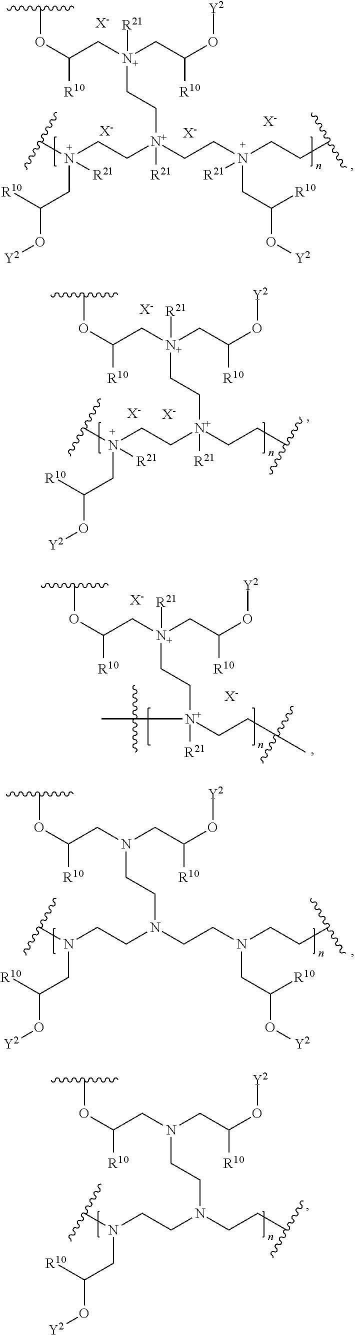

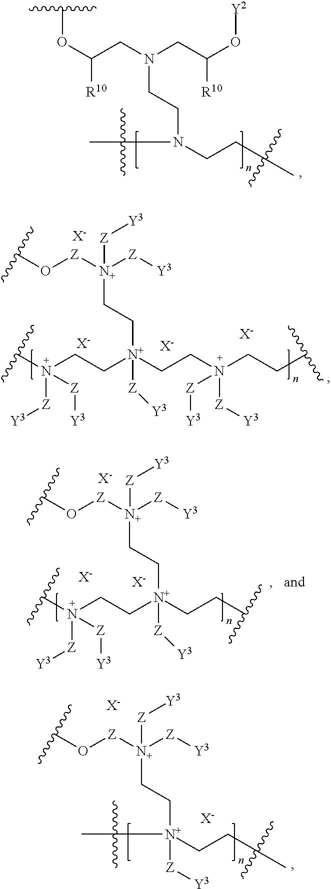

or a copolymer of any two or more thereof; and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000, preferably an integer independently selected from 10 to 1000;
Z is —(C₂-C₆ alkylene)-;
each R¹⁰ is C₁-C₆ alkyl substituted with —N⁺(R²⁰)₃X⁻, and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3)

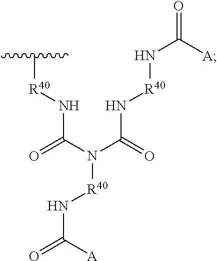

wherein
each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives.

It will be appreciated that the polymers described herein and the general method to prepare them offers a great deal of versatility to adjust and fine-tune physical and chemical properties and their antimicrobial properties for a wide range of different surfaces, substrates and applications. Examples of variables available for this fine-tuning include, but are not limited to, the structure and amount of the first quaternary ammonium salt, the optional polyol, the optional chain extender, the water-soluble polymer, the first multifunctional crosslinker (e.g., the first polyisocyanate), the polyethyleneimine intermediate or the second adduct (with its second multifunctional crosslinker, e.g., the second polyisocyanate), the optional third multifunctional crosslinker (e.g., the third polyisocyanate), the optional second quaternary ammonium salt, the optional fourth multifunctional crosslinker (e.g., the fourth polyisocyanate), and the degree of cross-linking. It will also be appreciated that multifunctional crosslinker(s) other than polyisocyanates may be used such as, but not limited to, multifunctional epoxides, imines, carbodiimides and aldehydes.

In another aspect, provided herein is an antimicrobial coating, coating fluid, or spraying fluid comprising, consisting essentially of, or consisting of an antimicrobial composition described herein. In some embodiments, the coating fluid or spraying fluid is water soluble or water dispersible.

In another aspect, provided herein is a device, equipment, apparatus, or accessory comprising the antimicrobial coating, coating fluid, or spraying fluid described herein. Non-limiting examples of the device, equipment, apparatus, or accessory include a filter, an air purifier, mask, or other personal protection device (PPD), respirator, etc. Other non-limiting examples include a keyboard, a keypad, a stylus, a mouse, a remote controller, a touch screen, a phone, and a display or any device integrating any of the foregoing components.

In another aspect, provided herein is a personal care aid comprising the coating, coating fluid, or spraying fluid described herein. Non-limiting examples of a personal care aid include facial tissue, hand soap, and a cleansing pad.

### Methods of Use

In another aspect, provided herein is a method to sanitize a surface, the method comprising, consisting essentially of, or consisting of applying a composition disclosed herein to the surface.

In another aspect, provided herein is a method to reduce (e.g., minimize) antimicrobial growth on a surface, the method comprising, consisting essentially of, or consisting of applying a composition disclosed herein to the surface. In some embodiments, the method includes forming a coating solution containing a composition according to any of the embodiments set forth herein. The method further includes directing, via an applicator (e.g., a sprayer), the coating solution to a surface, and providing a coating on the surface through the application of the coating solution to the surface.

In another aspect, provided herein is a method to prevent antimicrobial growth on a surface, the method comprising, consisting essentially of, or consisting of applying a composition disclosed herein to the surface.

In some embodiments of the methods described above, the applying step comprises, consists essentially of, or consists of spraying or brushing the surface with the composition. In some embodiments of the methods described above, the applying step comprises, consists essentially of, or consists of dipping the surface into a coating solution containing a composition according to any of the embodiments set forth herein. In some embodiments of the methods described above, the applying step comprises, consists essentially of, or consists of applying the composition to the surface by an electrostatic process.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. Moreover, due to biological functional equivalency considerations, some changes can be made in protein structure without affecting the biological or chemical action in kind or amount. These and other changes can be made to the disclosure in light of the detailed description. All such modifications are intended to be included within the scope of the appended claims.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The technology described herein is further illustrated by the following examples which in no way should be construed as being further limiting. Although methods and materials similar or equivalent to those described herein can be used in the practice or testing of this disclosure, suitable methods and materials are described below.

### Examples

The present technology now being generally described, it will be more readily understood by reference to the following examples. These are included merely for purposes of illustration of certain aspects and embodiments of the present technology and are not intended to limit the present technology.

Assessment of the Antiviral Activity of the Polymers and/or Coatings Thereof

Assessment of the antiviral activity of the polymer coatings of the present technology was conducted as follows. All samples and all accessories in the assessment were first disinfected by either high temperature autoclave treatment, alcohol cleaning or irradiation in a UV laminar flow chamber.

First, adenovirus (108 PFU/mL, plaque forming unit, MOI=100 multiplicity of infection) was diluted to 2×10⁷ PFU/ml in a phosphate buffer solution (PBS). Then, 0.1 mL of the diluted virus solution was deposited on the disinfected samples.

The antiviral activity was determined by two different methods: (i) the human cell (HuH7) method; and (ii) the quantitative reverse transcription polymerase chain reaction (RT-qPCR) method.

(i) Human cell (HuH7) Method

Huh7 is a type of human liver cell line that may be grown in the laboratory for research purposes. According to the web site huh7.com, it is “a well differentiated hepatocyte-derived carcinoma cell line, originally taken from a liver tumor in a 57-year-old Japanese male in 1982.”

For the assessment of antiviral activity, 0.1 mL of the virus (Adenovirus) in Dulbecco's Modified Eagle Medium (DMEM)+10% fetal bovine serum (FBS) medium was dropped onto the coating and also onto a control substrate and allowed to sit on the coating for 30 minutes. The virus/medium mixture was transferred to a Petri dish containing HuH7 cells (human liver cells) in the medium. The residual virus on the coating was rinsed twice with 0.1 mL of the medium and the liquid combined with the virus fluid in the Petri dish. The Petri dish was transferred to a CO₂ incubator and incubated at 37° C. with a relative humidity of about 95% and a C₀₂ concentration of about 5% for 48 hours to amplify the signal.

Once the incubation was completed, visible light and fluorescence micrographs were taken of the virus/cell samples to determine the population of virus and the live/dead cells. For positive control, 0.1 mL of virus in the medium was transferred directly into the petri dish containing HuH7 cells in the medium.

### (ii) RT-qPCR Method

RT-qPCR is used in a variety of applications including pathogen detection, gene expression analysis, RNAi validation, microarray validation, genetic testing, and disease research.

### Sample Preparation

The medium (DMEM, high sucrose, pyruvate; ThermoFisher, Catalog number: 11995040) was removed from the refrigerator and conditioned in a water bath at 37° C. for 30 min.

Preparation of Virus Fluid: The typical virus count of the stock is 5 Lambda (5×10⁸) per tube. To the virus tube, 1 mL of DMEM medium was added and the tube was mixed homogeneously with a vortex mixer for 5-10 sec to make a virus fluid of 5×10⁸/mL concentration. The virus fluid was further diluted to 5×10⁷/mL with DMEM medium for the antivirus tests.

RT-qPCR Procedure for Coatings: The coated film was immersed in 99% alcohol for 1 sec. Any excess alcohol was removed from the surface. The film was then air-dried in a new petri dish for 15-20 min. Then 100 μL of the diluted virus fluid (5×10⁶/mL) was dropped onto the dried film. The petri dish was covered, and the virus allowed to contact the film for desired contact time period. In some of the experiments, the contact time was reduced to as short as 30 sec. The virus fluid from the film was transferred to an Eppendorf tube. The film was then rinsed twice with 50 μL of 1×PBD and the rinsing fluid was combined into the Eppendorf tube. The total test fluid volume was 200 μL and ready for the DNA extraction.

RT-qPCR Procedure for Aqueous Solutions: 100 μL of the test sample was added to 100 μL of the diluted virus fluid (5×10⁷/mL) in an Eppendorf tube and the mixture (5×10⁶ virus count) was shaken on a shaker for 30 min. DNA was extracted using the Novogene DNA kit following the specified extraction procedure.

RT-qPCR Tests: Each sample was tested in quadruplicates. The ingredients listed in Table 1 were mixed thoroughly in an Eppendorf tube.

TABLE 1
Formulation of the premix for q-RT-PCR Test

| Items | Volume (μL) |
|---|---|
| DI Water | 15.4 |
| Forward-primer | 2.2 |
| Reverse-primer | 2.2 |
| Master mix buffer | 22.0 |
| (Kapa BioSystems | |
| PCR reagent) | |
| Sample DNA | 4.4 (Added as the last ingredient) |
| TOTAL VOLUME | 46.2 μL |

### EGFP Primer Sequence:

| | | | | |
|---|---|---|---|---|
| Forward- | FLenti- | 5′AACCACTACCTgAgCACCCA3′ | 2 | OPC |
| primer | GFP | (20) SEQ ID NO: 1 | | |
| Reverse- | RLenti- | 5′gTCCATgCCgAgAgTgATCC3′ | 2 | OPC |
| primer | GFP | (20) SEQ ID NO: 2 | | |

Ten μL of the premix was added to each cavity of a test plate, with three samples taken for each coating and each sample was done in quadruplicate. Accordingly, a total of 12 tests were done for each coating.

The plate was centrifuged to assure all the premix fluid flowed to the bottom of the cavities. The plate was then inserted into an Applied Biosystems QuantStudio 3 (ThermoFisher) to determine the Cycle Threshold (CT) number for the calculation of the antiviral efficiency. The antiviral efficiency was calculated quantitatively from the CT number.

### Testing

Qualitative Cell Viability Test for Coatings: The coating was placed in a petri dish and 100 μL of DMEM medium was dropped on the coating. The petri dish was then covered for 30 min. The medium on the film was then transferred to a cell plate containing 8×10⁴ cells in 500 μL of medium in each partition. The film was rinsed twice with 50 μL of DMEM medium and the rising fluid was combined with previous test fluid in the same location in the plate. A total of 200 μL of the test fluid was added to the 500 μL cell/medium. The cell plate was incubated at a 37° C./95% RH CO₂ incubator for 48-96 hours, after which the cell growth and morphology were observed under visible microscope. Dead cells floated or were suspended in the medium, while live cells remained fixed to the bottom of the plate. This test was for the assessment of the contact cytotoxicity of the polymer film. In cases where this test indicates some degree of cytotoxicity, the actual mechanism for the cell death is not given although cell death due to chemicals extracting from the coating are one possibility.

Qualitative Cell Viability Test for Polymer Solution or Dispersion: 100 μL of the polymer solution or dispersion and 100 μL of DMEM medium were added to an Eppendorf and mixed thoroughly with a shaker for 30 min. For polymer film, a fixed area of the film was cut and dispersed in the medium for the test. The test fluid was transferred to the cell plate and the cells were grown in a 37° C./95% RH CO₂ incubator for 48-96 hours. The cell growth and morphology were recorded under visible microscope.

Qualitative Antiviral Efficiency Test of Polymer film: 100 μL of the virus fluid (5×10⁷/mL) was dropped on the polymer film in a petri dish. The petri dish was covered for 30 min. The virus fluid was transferred to a cell plate containing 8×10⁴ cells in 500 μL of medium in each partition. The film was then rinsed twice with 50 μL of DMEM medium and the rising fluid was combined with previous test fluid in the same location in the plate. The total volume of the test fluid was 200 μL. The cell plate was then incubated at a 37° C./95% RH CO₂ incubator for 48-96 hours. Finally, the cell morphology and the fluorescence were recorded under UV microscope.

Qualitative Antiviral Efficiency Test of Polymer Solution or Dispersion: 100 μL of the virus fluid (5×10⁷/mL) and 100 μL of the polymer solution or dispersion were added to an Eppendorf and shaken thoroughly with a shaker for 30 min. The test mixture was added in a cell plate containing 8×10⁴ cells in 500 μL of medium in each partition. The cell plate was then incubated at a 37° C./95% RH CO₂ incubator for 48-96 hours. Finally, the cell morphology and the fluorescence were recorded under UV microscope.

### Examples 1-4. Water-Based Coatings Comprising a Water-Soluble Polyethyleneimine Intermediate

TABLE 2

| | | Examples (dry wt % in the dry film) | | | |
|---|---|---|---|---|---|
| | | 1 | 2 | 3 | 4 |
| Oil | First Adduct | 75 | 70 | 70 | 70 |
| Phase | (N100- | | | | |
| | C18DMDEG(Br-)) | | | | |
| | PTMG (MW1000) | 6 | 6 | 6 | 6 |
| | N100 | 14 | 14 | 14 | 14 |
| | | Polyethyleneimine Intermediate | | | |
| | | (QPEI) Used in the | | | |
| | | Aqueous Phase (wt. %) | | | |
| | | None | 37169 | HB37169 | HB37478 |
| Aqueous | QPEI | 0 | 5 | 5 | 5 |
| Phase | HEC (MW 380K) | 5 | 5 | 5 | 5 |
| | Contact Time | Antiviral Efficiency | | | |
| | 30 sec | 80.77% | 97.16% | 99.40% | 99.73% |
| | 1 min | 89.62% | 99.78% | 99.99% | 99.97% |
| | 5 min | 95.60% | 99.82% | 99.99% | 100% |
| | 10 min | 91.12% | 99.99% | 99.98% | 100% |
| | 30 min | 89.55% | 100% | 99.17% | 100% |

Preparation of the Aqueous Phase:

3.1 parts of HEC 380K ((2-hydroxyethyl cellulose, average Mw=380,000 from Aldrich) were dissolved thoroughly in 96.9 parts of DI water. The pH of the solution was adjusted to 4.5 by a 5% solution of H₃PO₄.

### Comparative Example 1: Preparation and Antiviral Activity Assessment

Preparation of the Oil-Phase:

5.0 g (10.7 mmol) of thoroughly dried C₁₈DMDEG was added to a solution of 7.67 g (16.03 mmol, 48 mmol reactive NCO) of DESMODUR® N100 in 5 g dry toluene at 90° C. under nitrogen and allowed to react for 15 hours. A clear viscous liquid (first adduct) was obtained after the toluene was removed under reduced pressure.

4.144 parts of the first adduct (N100-C₁₈DMDEG(Br—)), 0.356 parts of PTMG 1000 (Poly(tetramethylene glycol), Average Mn=1000 from Aldrich) and 1.5 parts of MEK (methyl ethyl ketone) were pre-reacted at 70° C. for 1 hour. The mixture was cooled to room temperature and dried under vacuum until the solid content reached about 90% by weight. To the solution, 0.828 parts of polyisocyanate N100 (DESMODUR N100 from Convestro) and 1.276 parts of dried acetone were added and mixed homogeneously.

Preparation of Oil-In-Water Emulsion and Coating

The aqueous phase solution as prepared above was added into the oil phase at room temperature and emulsified by ultrasonication (100 Watt) for 10 sec, 5 times with a 10 sec pulse between each ultrasonication. The total emulsification time was about 90-120 sec. The resultant oil-in-water emulsion was coated onto a 2 mil, corona-treated white PET (Melinex 339 from Teijin), and dried for 10 min at room temperature followed by 15 hours at 60° C. The resultant film showed acceptable film properties and resistances against alcohol and water disinfection processes. Its antiviral efficiency against Adenovirus was measured by q-RT-PCR as described above.

### Examples 2-4

The same procedure described in Example 1 was repeated for the preparation of emulsions and coatings of Examples 2, 3 and 4 except that the amount of the first adduct (N100-C18DMDEG(Br—)) was reduced by 5 wt. % and QPEI 37169, QPEI HB37169 (hyperbranched), or QPEI HB37478 were added in an amount of 5 wt. %.

Preparation of QPEI 37169

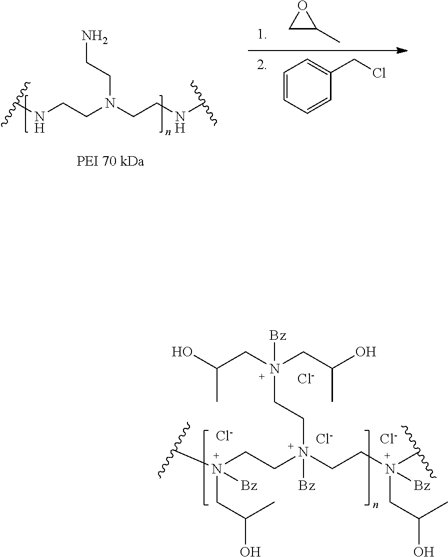

QPEI 37169 was prepared as shown in the reaction scheme above.

For the purposes of the chemistry described herein, the ratio of primary, secondary and tertiary amines in branched PEI is assumed to be 1:2:1 as has been reported in the literature.^{24,25}

The procedure used is essentially as described in Gao et al. (2007).²⁶ The structure for QPEI 37169 is intended to be an approximation indicating that most of the primary and secondary amines have been reacted with the epoxide with most of the tertiary amines quaternized by alkylation with the benzyl chloride.

To a 25 mL two-neck flask under nitrogen was added 3.33 g of 70 kDa PEI solution (30% in water/1 g PEI, assume mw=43.1 g/mol, 23.2 mmol) and was cooled to 0° C. To this mixture, 5.4 g (92.8 mmol) propylene oxide was added dropwise at 0-3° C. After the addition was completed, the reaction mixture was stirred at 0-3° C. for seven hours. Then the temperature of the reaction mixture was increased to 35° C. and the unreacted propylene oxide was distilled out (˜3.60 mL). Added to the resulting solution was 11.75 g (10.6 mL, 92.8 mmol) of benzylchloride and the reaction was heated to 50° C. for 30 hours. The reaction was extracted with diethyl ether (3×20 mL) to remove unreacted benzylchloride, residual propylene oxide, and oleophilic side products or impurities, if there are any. The water phase was separated and vaporized under vacuum and dried by lyophilization leaving QPEI 37169 as a transparent solid (2.85 g). The product was characterized by proton NMR and Infrared (IR) spectroscopy.

Preparation of QPEI HB37169

The same reaction as in the preparation of QPEI 37169 was used for the preparation QPEI HB37169 except that a hyperbranched polyethyleneimine of the same molecular weight was used.

Preparation of QPEI HB37478

The same reaction as in the preparation of QPEI 37169 was used for the preparation QPEI HB37478 except that the quaternization agent benzyl bromide was replaced by hexyl bromide, and a hyperbranched polyethyleneimine of the same molecular weight was used.

Replacement of 5 wt. % of the first adduct (N100-C₁₈DMDEG(Br—)) with the three polyethyleneimine intermediate (QPEI) significantly improved the antiviral efficiency even at a contact time as short as 30 seconds (see Table 2).

### Examples 5-9. QPEI 37169 as the Polyethyleneimine Intermediate in the Aqueous Phase

TABLE 3

| | Examples | | | | | |
|---|---|---|---|---|---|---|
| Composition (wt % in the dry film) | 2 | 5 | 6 | 7 | 8 | 9 |
| First Adduct (N100-C18DMDEG(Br—)) | 70 | 65 | 68 | 63 | 65 | 60 |
| PTMG (MW1000) | 6 | 6 | 8 | 8 | 11 | 11 |
| N100 | 14 | 14 | 14 | 14 | 14 | 14 |
| QPEI 37169 | 5 | 10 | 5 | 5 | 5 | 5 |
| HEC (MW 380K) | 5 | 5 | 5 | 10 | 5 | 10 |
| Antiviral efficiency (30 min) | 99.99% | 99.96% | 99.99% | 99.99% | 99.99% | 99.97% |

The same procedures as those in Examples 1-4 were used to prepare the compositions of Examples 5-9, except that the composition was changed as shown in Table 3. All the coatings showed acceptable film properties, water resistance and alcohol resistance.

All of the coatings showed >99.95% antiviral efficiency at 30 minutes of contact time.

Examples 10-20 describe additional examples of polyethyleneimine intermediates or second adducts that can be used in the present technology.

### Example 10. Synthesis of Polyethyleneimine Intermediate 40840

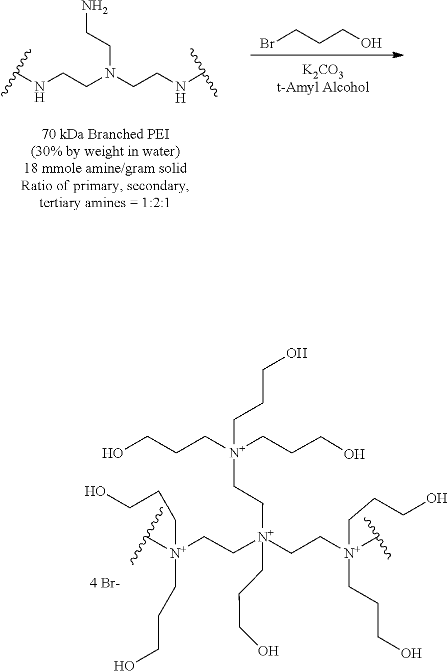 [SMILES: *NCCN(CCN)CCN* ; OCCCBr ; *[N+](CCCO)(CCCO)CC[N+](CCCO)(CC[N+](*)(CCCO)CCCO)CC[N+](CCCO)(CCCO)CCCO]

A 500 mL 3 neck round bottom flask was fitted with a thermometer, condenser and magnetic stirrer. The reaction flask was flushed with nitrogen gas and the reaction carried out under a nitrogen gas flow.

10 g of PEI (70 kDa branched, 30% by weight aqueous solution, amine content 18 mmole/gram solid polymer, ratio of primary, secondary, tertiary amines=1:2:1) and potassium carbonate (37.07 g, 0.232 mol) and 150 mL t-Amyl Alcohol were added to the round bottom flask. This mixture was stirred under nitrogen for 30 minutes and then 3-bromo-1-propanol (64.5 g, 0.464 mol, 1.3 equivalents for complete quaternization) was added dropwise at room temperature. The resulting mixture was heated and stirred at 95° C. for 96 hours.

After 96 hours, the mixture was allowed to cool to room temperature and filtered to remove insoluble solid. The filtered solid was washed with 150 mL methanol. The combined filtrates were treated with 250 mL diethyl ether and a white precipitate was formed. The organic phase was decanted and the white solid was dissolved in 200 mL methanol and precipitated with 200 mL diethyl ether. This dissolution/precipitation process was carried out two more times and the resulting white pasty solid was dried in a rotary evaporator and then further dried under high vacuum for 5 hours. Then yield of dry produce was 17.4 g. The product was characterized by ¹H NMR and the degree of quaternization analyzed using the Mohr argentometric titration method to measure the amount of bromide.

### Example 11. Synthesis of Polyethyleneimine Intermediate 40660

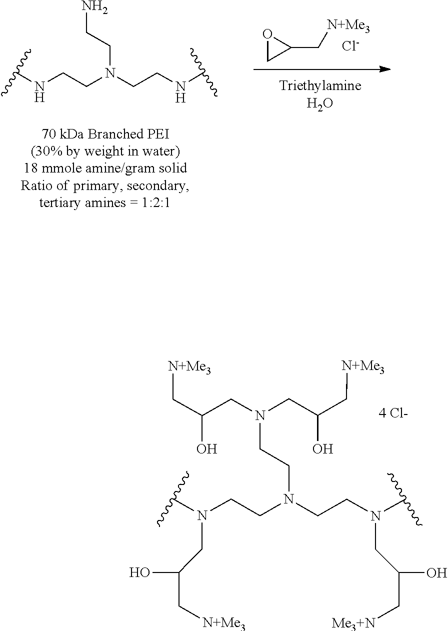

A 2-L 3 neck round bottom flask was fitted with a dropping funnel, condenser and magnetic stirrer. The reaction flask was flushed with nitrogen gas and the reaction carried out under a nitrogen gas flow.

10 g of PEI (70 kDa branched, 30% by weight aqueous solution, amine content 18 mmole/gram solid polymer, ratio of primary, secondary, tertiary amines=1:2:1) was added to the reaction flask and 835 mL water added to it. 114.3 g glycidyltrimethylammonium chloride (0.754 mol, ˜4 equivalents for theoretical full conversion) was dissolved in 130 mL water and added dropwise to the reaction mixture. 153 g (210 mL, 1.5 mol) Triethylamine was added dropwise to the reaction mixture at room temperature. The resulting two-phased reaction mixture was vigorously stirred at room temperature for 4 days after which time the reaction mixture was one clear phase. All solvents were removed in a rotary evaporator at 55° C. The pasty liquid residue was dissolved in 200 mL methanol and the polymer product precipitated with 400 mL diethyl ether. This methanol/diethyl ether dissolution and precipitation was repeated six times. The final precipitate was dried in a rotary evaporator and then under high vacuum yielding 46.5 g of the final product. The product was characterized by ¹H NMR and the degree of quaternization analyzed using the Mohr argentometric titration method to measure the amount of chloride.

### Example 12. Synthesis of Polyethyleneimine Intermediate 40818

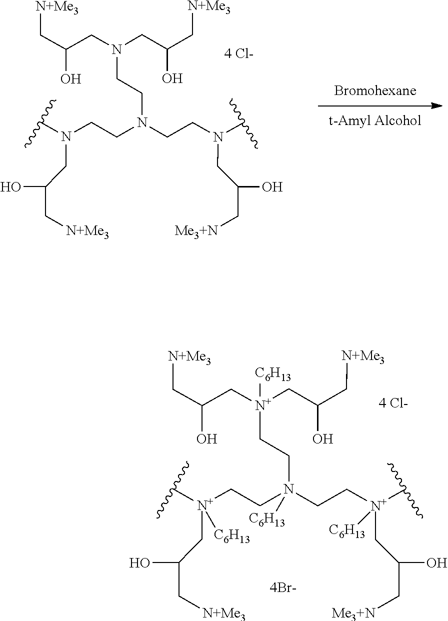

A 100-mL 1 neck round bottom flask was fitted with a condenser, a heating cup and magnetic stirrer. The reaction flask was flushed with nitrogen gas and the reaction carried out under a nitrogen gas flow.

2 g of the glycidyl functionalized PEI (3.3 mmol 13.3 mmol reactive N), bromohexane (7 g, 40 mmol, 3 equivalents) and 4.4 mL t-amyl alcohol were added to the flask and the reaction mixture was heated at 96° C. for 96 hours. The reaction mixture turned from colorless to light orange in color. The reaction was cooled to room temperature and the resulting solution was poured into Tertiary Butyl Methyl Ether (TBME) with vigorous stirring causing a precipitate to form. The liquid was decanted away from the precipitated solid and the solid dissolved in methanol and reprecipitated with TBME. This process was repeated 3 times yielding 4.06 g of the product after drying with a rotary evaporator and then high vacuum. The product was characterized by ¹H NMR and the degree of quaternization analyzed using the Mohr argentometric titration method to measure the amount of halide.

### Example 13. Adenovirus Activity Assessment for Examples 10 and 11

Aqueous solutions of polyethyleneimine intermediates 40840 and 40660 were assessed for antiviral activity as described above.

TABLE 4

| Polyethyleneimine | qPCR testing | |
|---|---|---|
| intermediate | Time | Antiviral efficiency |
| aqueous solution (1 wt. %) | of contact | mean (%) |
| 40840 | 30 min | 99.35% |
| 40660 | 30 min | 98.94% |

### Example 14. Synthesis of a Polyethyleneimine Intermediate Capped with Monoisocyanate (Approximately 85% of Free OH Groups)

The structure for the polymer product, as shown below, is intended to be an approximation indicating that most of the hydroxyl groups (˜85% molar equivalent) have been reacted with the blend of monoisocyanates to form urethanes with some hydroxyl groups remaining unreacted.

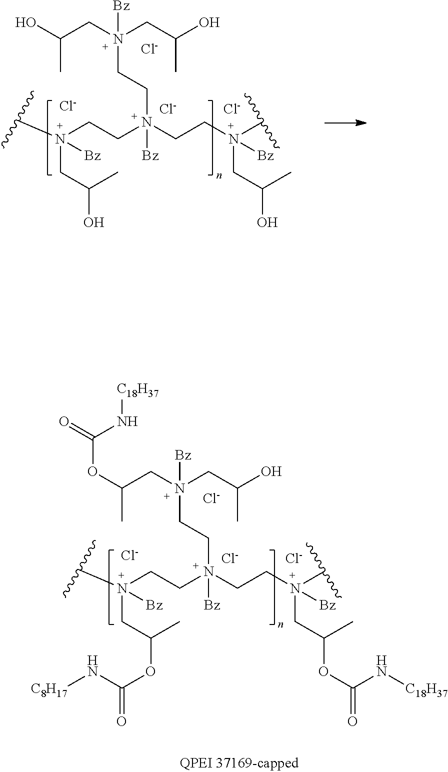

The concentration of reactive hydroxyl groups (mmol/gram of dry polymer) was determined by titrating a known amount (grams) of the dried Hydroxyl Alkyl Quaternary Polyethyleneimine (HA-Q-PEI) with a known excess amount (grams, mmoles) of Octadecylisocyanate. The percentage of monoisocyanate which was consumed in the reaction was determined by monitoring the reaction progress using infrared (IR) spectroscopy to monitor the drop in the isocyanate peak at 2263 cm-¹. From the percentage drop in this peak, the number of mmoles of isocyanate consumed was estimated. This value was equivalent to the number of mmoles of polymer hydroxyl groups which reacted with the isocyanate. In this way, a hydroxyl group concentration of the polymer (mmoles reactive hydroxyl groups/g dry polymer) was calculated and then used in subsequent reactions to determine the amount of monoisocyanate(s) required to functionalize specific percentages of the reactive hydroxyl groups in the polymer and by doing so, would fine-tune the hydrophilic/hydrophobic properties of the polymer.

Using the procedure described in Example 2, 2.0 g (2.27 mmol assuming a molecular weight of 881 g/mole for the polymer unit cell) of the Hydroxypropyl Quaternary Ammonium PEI, QPEI 37169, was prepared and then dried under vacuum at 60° C. for two hours followed by storing overnight in a desiccator at room temperature. To the dried polymer was added 13.8 g t-Butyl Alcohol and 9.2 g of Dimethyl Acetamide. The resulting mixture was stirred under nitrogen until the polymer completely dissolved. Both of these solvents were dried thoroughly with molecular sieve 4 Å before use. A mixture of 1.6 g (5.41 mmol) of octadecylisocyanate and 0.36 g (2.32 mmol) of octylisocyanate was added dropwise to the polymer solution. This mixture totaled 7.73 mmol of monoisocyanate which corresponds to approximately 85% of the available hydroxyl groups. The reaction mixture turned slightly cloudy. The resulting reaction mixture was stirred at room temperature under nitrogen for twelve hours. The resulting reaction mixture was filtered with a PTFE filter (1 μm pore size) affording the 20.83 grams of QPEI 37169-capped as a 12.19% solid solution. IR spectroscopy showed the expected new peak corresponding to the urethane carbonyls and no residual isocyanate peak.

In some embodiments, after the reaction with monoisocyanate(s) is complete, the reaction mixture was added to water to precipitate the capped product. This product was isolated and washed with water to remove any water soluble impurities and then dried for use in subsequent steps. This water precipitation step was useful for removing any water soluble impurities that may contribute to toxicity.

### Example 15. Process for Crosslinking and Coating Reaction of Octadecyl/Octyl Urethane Quaternary Ammonium PEI (Example of Second Adduct Formation)

The structure for the polymer Compound (A), as shown below, is intended to be an approximation indicating that some of the unreacted hydroxyl groups in QPEI 37169-capped have been reacted with the polyisocyanate to form urethane cross-links.

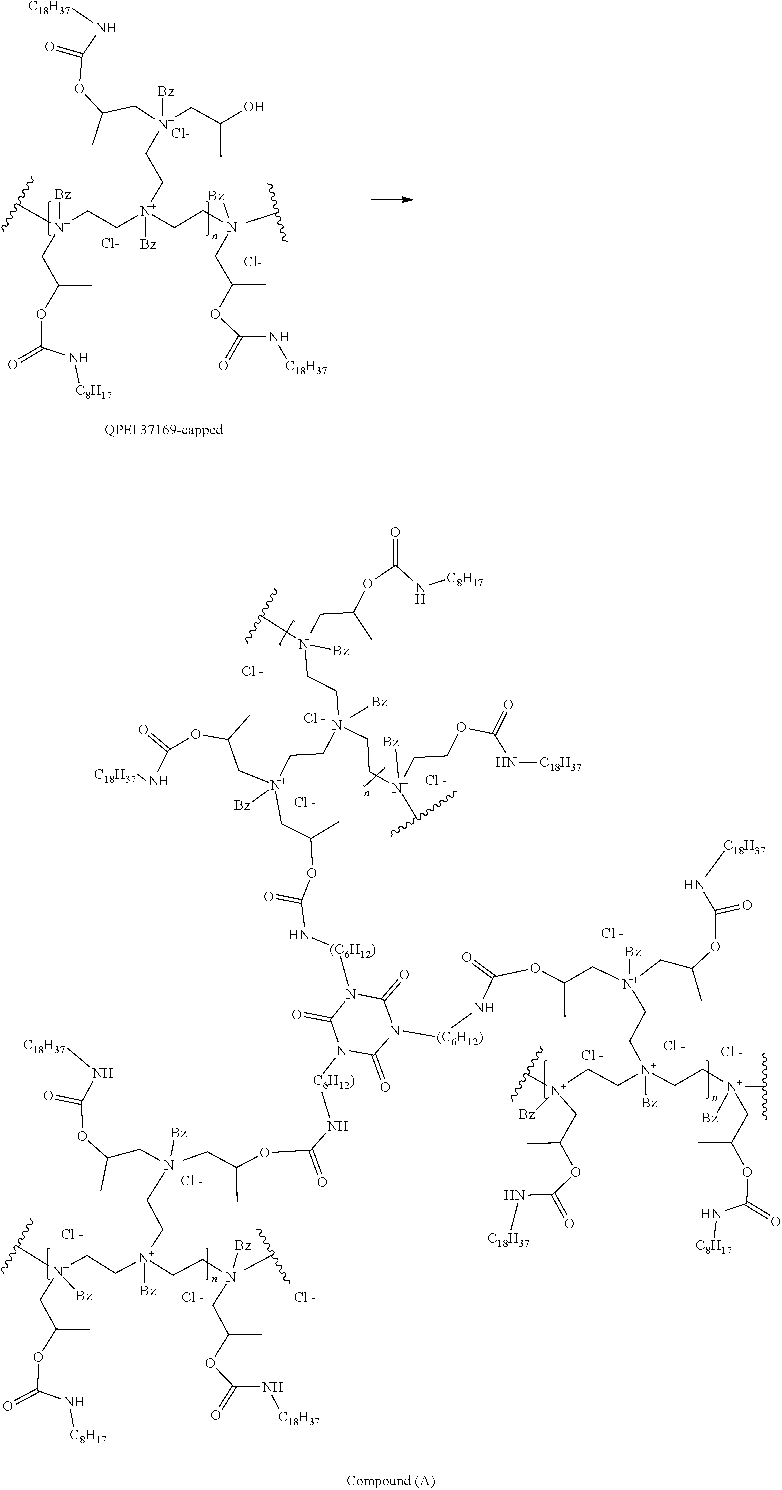

Using the procedure described in Example 15, 20 g of the Octadecyl/Octyl Urethane Quaternary Ammonium PEI was prepared, to which was added 1.25 g of Desmodur N3300 (50% solution in anhydrous acetone) and 0.18 g of a Dibutyltin Dilaurate 1% solution in dry toluene. The resulting mixture was mixed thoroughly and immediately coated, with a #36 Myer rod, onto a corona-pretreated white PET (2 mils, Milenex 339) supported with a stainless steel plate. The coated film was heated in an oven for 30 minutes at 60° C. without vacuum. This dried film was used for measurements of antimicrobial activity. IR spectroscopic analysis indicated no residual isocyanates.

It should be noted that the above crosslinking procedure has also been carried out without the Dibutyltin Dilaurate catalyst and afforded a reasonable coating albeit the resulting dried film was somewhat less durable than when the catalyst was used.

### Example 16. Aqueous Solution Antiviral Efficiencies Against Adenovirus of HA-Q-PEI Polymers with Varied PEI Molecular Weights, Nitrogen Quaternization Groups, and Anionic Counter Ions

Various HA-Q-PEI (Hydroxy Alkyl Quaternary PEI) of the following formula:

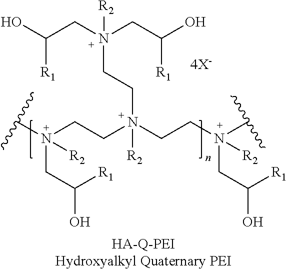

were prepared using analogous procedures as that which is described in Example 2 (preparation of QPEI 37169) and analyzed for their antiviral (AV) efficiency against adenovirus as described above. Select data are shown in Table 5 (R₁=methyl for each polymer). These results demonstrate high antiviral efficiencies over a range of PEI molecular weights and with varied nitrogen quaternization groups (R₂) and anionic counterions (X—).

TABLE 5

| sample | MW | R₂ | X- | % AV Efficiency |
|---|---|---|---|---|
| 2-1 | 600 | n-Hexyl | Bromide | 82 |
| 2-2 | 10,000 | n-Hexyl | Bromide | 97.29 |
| 2-3 | 100,000 | n-Hexyl | Bromide | 99.98 |
| 2-4 | 70,000 | n-Hexyl | Bromide | 99.93 |
| 2-5 | 70,000 | Benzyl | Chloride | 99.9 |
| 2-6 | 70,000 | Methyl | Iodide | 99.91 |
| 2-7 | 70,000 | n-Butyl | Bromide | 99.92 |
| 2-8 | 70,000 | —CH₂C(O)OCH₂CH₃ | Bromide | 99.94 |
| 2-9 | 70,000 | —CH₂C(O)Ph | Bromide | 99.42 |

### Example 17. Aqueous Solution Antiviral Efficiencies Against Adenovirus of HA-Q-PEI Polymers with Varied PEI Molecular Weights

Additional HA-Q-PEI polymers (R₁=methyl, R₂=hexyl, X=bromide) of the following formula:

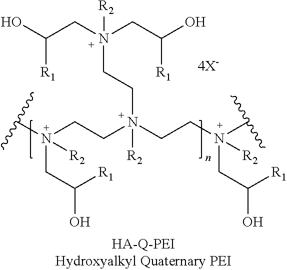

having various molecular weights were prepared using analogous procedures as that which is described in Example 2 (preparation of QPEI 37169) and were analyzed for their antiviral (AV) efficiency against adenovirus as described above. Select data are shown in Table 6.

TABLE 6

| sample | MW (kDa) | % AV efficiency |
|---|---|---|
| 3-1 | 0.6 | 82.05 |
| 3-2 | 0.6 | 95.18 |
| 3-3 | 10 | 97.29 |
| 3-4 | 10 | 98.41 |
| 3-5 | 25 | 99.98 |
| 3-6 | 70 | 99.93 |
| 3-7 | 100 | 99.98 |
| 3-8 | 270 | 99.99 |
| 3-9 | 270 | 99.97 |

These results demonstrate that for this series of HA-Q-PEI polymers, the solution antiviral efficiency against Adenovirus increases as PEI molecular weight increases, leveling off at a maximum of >99% in the range of 25,000 to 270,000.

While these HA-Q-PEI polymers exhibit high solution antiviral efficiencies, they are not directly suitable for making durable water-resistant surface coatings due to their high degree of water solubility. Coating durability to solvents like water and ethanol is highly desirable so that the antimicrobial efficiency will be maintained and the need for frequent re-sanitizing of the surface is greatly reduced even after the surface is cleaned by washing.

### Example 18. Adenovirus Antiviral Efficiency of a Second Adduct as Anti-Microbial Agent in Coating as a Function of the Weight Percent of N100 Crosslinker Used

Coatings of second adducts of the following formula:

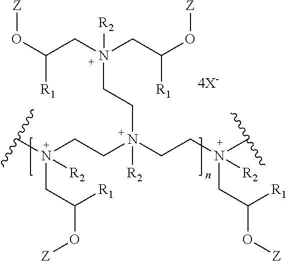

were prepared using analogous procedures as that which is described in Example 15, replacing the Octadecyl/Octyl Urethane Quaternary Ammonium PEI with a HA-Q-PEI (prepared from PEI: molecular weight=70,000 (branched), R₁=methyl, R₂=hexyl, X=bromide), and varying the amounts of crosslinker Z (DESMODUR® N100):

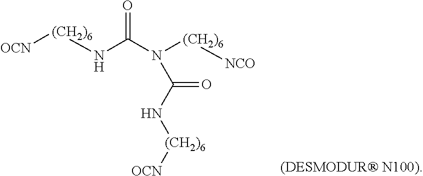

The antiviral efficiency against adenovirus (procedure as described above) for these second adducts was investigated. Select data are shown in Table 7.

TABLE 7

| sample | wt. % crosslinker* | % AV efficiency |
|---|---|---|
| 4-1 | 6.5 | 87.12 |
| 4-2 | 17.7 | 65.11 |
| 4-3 | 26.5 | 66.05 |
| 4-4 | 33.3 | 49.47 |
| 4-5 | 39.2 | 46.42 |
| 4-6 | 44.1 | 2.52 |

*wt. % with respect to second adduct

Cross-linking the HA-Q-PEI (polyethyleneimine intermediate) coating to form the polyurethane second adduct coating improved water and ethanol durability of the coating, but, as can be seen by this example, this is associated with a significant decrease in the antiviral efficiency with increased amounts of cross-linking.

### Example 19 Antiviral Efficiency Against Adenovirus of Polyethyeleneimine Intermediates with or without Monoisocyanate Substitution as Uncross-Linked Coatings

Polyethyeleneimine intermediates with monoisocyanate substitution (MUA-Q-PEI-A polymers, wherein R₃=C₁₈ alkyl or C₈ alkyl) of the following formula:

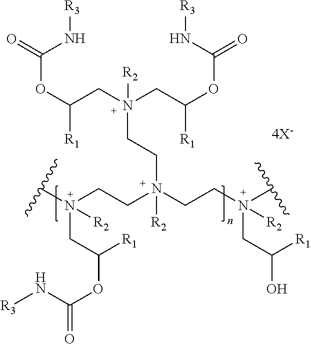

were prepared from HA-Q-PEI (prepared from PEI: molecular weight=70,000 (branched), R₁=methyl, R₂=benzyl) and a monoisocyanate mixture (7:3 ratio of octadecylisocyanate to octylisocyanate), wherein approximately 90% of HA-Q-PEI hydroxyl groups reacted with the monoisocyanate mixture (see similar protocol in Example 14). MUA-Q-PEI-A100 polymers were also similarly prepared, in which approximately 100% of the HA-Q-PEI hydroxyl groups reacted with the monoisocyanate mixture. Films of these MUA-Q-PEI-A and MUA-Q-PEI-A100 polymers were examined for their antiviral efficiency against adenovirus as described above. Select results are shown in Table 8.

TABLE 8

| | | contact | % AV |
|---|---|---|---|
| sample | polymer system | time (min) | efficiency |
| 5-1 | 1% water solution HA-Q-PEI | 30 | 97.41 |
| 5-2 | dry film MUA-Q-PEI-A | 30 | 99.99 |
| 5-3 | dry film MUA-Q-PEI-A | 1 | 99.84 |
| 5-4 | dry film MUA-Q-PEI-A | 0.5 | 99.49 |
| 5-5 | dry film MUA-Q-PEI-A100 | 30 | 99.99 |
| 5-6 | dry film MUA-Q-PEI-A100 | 1 | 99.98 |
| 5-7 | dry film MUA-Q-PEI-A100 | 0.5 | 99.91 |

These results indicate that the high solution antiviral efficiency of the HA-Q-PEI polymer was maintained and/or increased after reaction with the monoisocyanate mixture to form the coatings of the MUA-Q-PEI-A and the MUA-Q-PEI-A100 polymer. These results also demonstrate that the coatings exhibit >99% antiviral efficiency even at contact times as short as 30 seconds.

### Example 20 Second Adduct Coating Antiviral Efficiency Against Adenovirus and Coating Durability as a Function of Amount (Weight Percent) of N3300 Polyisocyanate Crosslinker Used

Second Adduct (PUA-Q-PEI-B polymers, wherein R₃=C₁₈ alkyl or C alkyl) of the following formula:

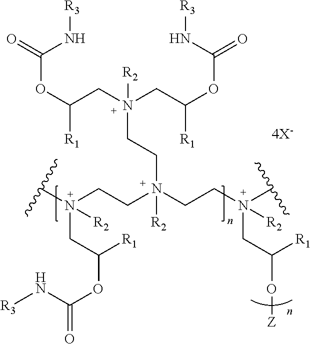

were prepared using analogous procedures as that which is described in Example 14. In particular, the HA-Q-PEI (prepared from PEI: molecular weight=25,000 (Hyper Branched), R₁=methyl, R₂=hexyl, X=bromide) was reacted with a monoisocyanate mixture (7:3 ratio of octadecylisocyanate to octylisocyanate), wherein approximately 90% of HA-Q-PEI hydroxyl groups reacted with the monoisocyanate mixture, before the remaining hydroxyl groups were reacted with varying amounts of crosslinker Z (DESMODUR® N3300):

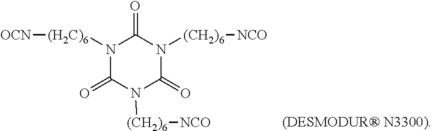

Coatings of these PUA-Q-PEI-B polymers were evaluated for their antiviral efficiency against adenovirus (procedure as described above), water durability, and ethanol durability. The general procedure for measuring water and ethanol durability was to immerse center cross-cut coating samples in water or ethanol for ten minutes followed by gentle wiping of the sample with a cotton swab. An intact coating passed the test. Select data are shown in Table 9.

TABLE 9

| | wt. % | % AV | water | ethanol |
|---|---|---|---|---|
| Sample | crosslinker* | efficiency | durability | durability |
| 6-1 | 0 | 99.97 | fail | fail |
| 6-2 | 1.62 | 99.95 | pass | pass |
| 6-3 | 4.75 | 99.99 | pass | pass |
| 6-4 | 7.61 | 99.92 | pass | pass |
| 6-5 | 10.37 | 39.87 | pass | pass |

*wt. % crosslinker with respect to PUA-Q-PEI-B polymer product

This data suggest that the crosslinker is necessary to achieve good durability and that there was an optimum range of crosslinker level for these samples within which antiviral efficiency was >99% and above which antiviral efficiency was significantly decreased.

### Example 21. Antibacterial and Antiviral Testing

Coating samples from Table 10 were prepared in a similar manner as described in Examples 1-4.

TABLE 10

| coating | N100-C18DMDEG | | PTMG | | |
|---|---|---|---|---|---|
| sample | Adduct [N100/C18] | QPEI | (MW1000) | N100 | HEC |
| 1 | 75% [64.8/35.2] | 0% | 6% | 14% | 5% |
| 2 | 70% [64.8/35.2] | 5% | 6% | 14% | 5% |
| 3 | 68.5% [65.1/34.9] | 14.80% | 2.60% | 7.80% | 6.20% |

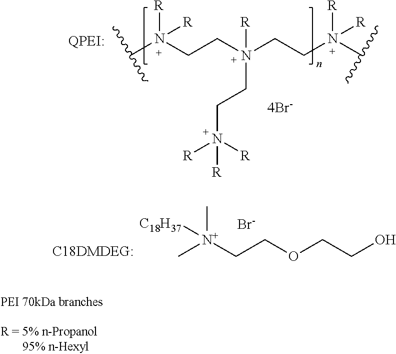

The QPEI for these coating was prepared as follows. To a 500 mL 4 neck round bottom flask equipped with a reflux condenser, dropping funnel, thermometer and KPG stirrer with side stirrer blade was added 20 g EPOMIN™ P-1050 (PEI 70 kDa with amine content 18 mmol/g of polymer, with a ratio of primary to secondary to tertiary amines=1:2:1), 150 ml t-amyl alcohol and 32.1 g (232 mmol) K₂CO₃. The mixture was stirred under nitrogen gas at 200 rpm at 25- to 30° C. for 30 min. To this reaction mixture was added 6.5 g (46 mmol) 3-bromo-1-propanol solved in 145.5 g (881 mmol) 1-bromohexane dropwise over 30 min at 25-30° C. After the addition was complete, the temperature was increased to 96° C. and the reaction was stirred at 96° C. to 98° C. for 98 hours, resulting in a light brown color solution. The reaction was cooled to 25-30° C. and filtered (Büchner funnel), and the filter was washed with 50 ml tert-amyl alcohol. The filtrate was concentrated to dryness under vacuum at less than 50° C. and to the residue was added 200 ml of diethyl ether at 25-30° C. This was stirred for 30-60 minutes during which time a brown slurry formed. Stirring was stopped, and the solid was allowed to settle over 30-60 minutes. The supernatant liquid was decanted off. Decanting of the supernatant liquid (ether suspension) was repeated several times (5-6 times) more until the amount of alkyl halides in the decanted liquid was less than 0.5% by GC analysis. The residual liquid was distilled off from the solid under vacuum in a rotary evaporator at less than 40° C. The sticky off-white material was dissolved in methyl ethyl ketone at 25-30° C., resulting in a slightly hazy solution, filtered through celite bed, after which a clear solution was observed. Distillation of the solvent under reduced pressure in a Rota evaporator at 45° C. led to a solid mass. The solid mass was dried for 6-8 hours below 45° C. The product was isolated as an off-white solid in a yield of 39.4 g. The theoretical mole % of PEI reaction with 1-bromopropanol and 1-bromohexane is 5% and 95%, respectively, assuming similar alkylation rates between the two alkyl halides.

Coating samples from Table 10 were tested against a range of viruses and bacteria as well as fungus and microalgae according to ISO standard 21702:2019. Select data are shown in Tables 11, 12, 13, and 14 below. Positive values reflect a percent decrease in the microorganism population. Negative log values indicate an increase in microorganism population.

TABLE 11

| | | | coating sample | | |
|---|---|---|---|---|---|
| | | | 1 | 2 | 3 |
| | | | antiviral | antiviral | antiviral |
| Virus | contact time | | efficiency | efficiency | efficiency |
| Influenza A | 24 | h | 99.8 | 99.99 | >99.99 |
| virus H3N2 | 1 | h | | | |
| | 30 | min | | | |
| | 10 | min | 98.8 | 99.98 | 99.48 |
| | 1 | min | 20.57 | 43.77 | 98 |
| Influenza A | 24 | h | 99.8 | 99.98 | 99.99 |
| virus H1N1 | 1 | h | | | |
| | 30 | min | | | |
| | 10 | min | 98.52 | 99.97 | 99.7 |
| | 1 | min | 41.12 | 30.81 | 98.34 |
| Human Corona | 24 | h | 99.94 | >99.99 | >99.99 |
| virus 229E | 1 | h | | | |
| | 30 | min | | | |
| | 10 | min | 99.09 | 99.99 | 99.84 |
| | 1 | min | 29.21 | 66.11 | 99.22 |
| Feline calicivirus | 24 | h | 99.65 | >99.99 | >99.99 |
| F-9 | 1 | h | | | |
| | 30 | min | | | |
| | 10 | min | 98.74 | 99.85 | 99.56 |
| | 1 | min | 46.3 | 8.8 | 98.3 |

TABLE 12

| | | | coating sample | | |
|---|---|---|---|---|---|
| | | | 1 | 2 | 3 |
| | | | anti- | anti- | anti- |
| | contact | | bacterial | bacterial | bacterial |
| Bacteria | time | | efficiency | efficiency | efficiency |
| Enterococcus faecalis | 24 | h | 99.71 | >99.99 | >99.99 |
| (VRE—Vancomycin- | 1 | h | −0.07 log | 98.88 | >99.99 |
| resistant enterococcus) | 30 | min | −0.49 log | 97.08 | 99.44 |
| | 10 | min | | | |
| | 1 | min | 66.25 | −0.02 log | 71.67 |
| Klebsiella pneumonia | 24 | h | 9.8 | 98.55 | >99.99 |
| (CRE—Carbapenen- | 1 | h | 1.41 | 98.7 | 99.99 |
| resistant | 30 | min | −0.11 log | 92.5 | 99.44 |
| enterobacteriaceae) | 10 | min | | | |
| | 1 | min | 22.96 | 14.81 | 18.52 |
| Staphylococcus aureus | 24 | h | 84.29 | >99.99 | >99.99 |
| (MRSA—Methicillin- | 1 | h | −0.62 log | >99.99 | >99.99 |
| resistant Staph. aur.) | 30 | min | −0.28 log | 99.63 | 99.83 |
| | 10 | min | | | |
| | 1 | min | −0.38 log | 29.17 | 86.67 |
| Clostridium difficile | 24 | h | 90.38 | 99.15 | 97.73 |
| | 1 | h | 27.03 | 97.54 | 8.11 |
| | 30 | min | 9.3 | 96.43 | 3.1 |
| | 10 | min | | | |
| | 1 | min | −0.11 log | −0.03 log | 1.61 |

TABLE 13

| | | | coating sample | | |
|---|---|---|---|---|---|
| | | | 1 | 2 | 3 |
| | | | antifungal | antifungal | antifungal |
| Fungus | contact time | | efficiency | efficiency | efficiency |
| Candida albicans | 24 | h | 93.6 | 99.88 | 91 |
| | 1 | h | 17.65 | 19.61 | 45.1 |
| | 30 | min | −79.37 | 16.55 | 57.24 |
| | 10 | min | | | |
| | 1 | min | 55.38 | 23.85 | 41.54 |

TABLE 14

| | | | coating sample | | |
|---|---|---|---|---|---|
| | | | 1 | 2 | 3 |
| | | | anti-algae | anti-algae | anti-algae |
| Microalgae | contact time | | efficiency | efficiency | efficiency |
| Chlorella vulgaris | 24 | h | >99.99 | >99.99 | >99.99 |
| | 1 | h | >99.99 | >99.99 | >99.99 |
| | 30 | min | 88.97 | >99.99 | >99.99 |
| | 10 | min | | | |
| | 1 | min | 61.84 | >99.99 | >99.99 |

Coating sample 3 from Table 10 was tested for antiviral and antibacterial efficiency after being subjected to a wet abrasion (PAS standard 2424:2014 pt. 9.2.4) or dry abrasion (PAS standard 2424:2014 pt. 9.2.2). Data is shown in Table 15.

TABLE 15
Antimicrobial Efficiency After Wet and
Dry Abrasion Tests (Coating Sample 3)

| | contact | | antiviral | |
|---|---|---|---|---|
| Virus | time | | efficiency | |
| Influenza A virus | 24 | h | >99.99 | after 100 cycles wet abrasion |
| H1N1 | 1 | min | 86.82 | after 100 cycles wet abrasion |
| | 24 | h | >99.99 | after 100 cycles dry abrasion |
| | 1 | min | 52.14 | after 100 cycles dry abrasion |
| | | | antibacterial | |
| Bacteria | | | efficiency | |
| Klebsiella | 24 | h | 99.96 | after 100 cycles wet abrasion |
| pneumonia | 1 | min | 1.16 | after 100 cycles wet abrasion |
| (CRE) | 24 | h | 99.29 | after 100 cycles dry abrasion |
| | 1 | min | 8.24 | after 100 cycles dry abrasion |

Non-limiting examples of QPEI which may be incorporated in the technology disclosed herein are described below.

### Example 22. Compound 22-1

Compound 22-1 is analogous to QPEI samples 3-8 and 3-9 of Example 17 and was prepared from a PEI with MW=270 kDa. Compound 22-1 (batch 105159) contains a ratio of more than 1:1 of nitrogen functionalization by hexyl halide to nitrogen functionalization by propylene oxide (i.e., there are more hexyl groups than 2-hydroxypropyl groups on the nitrogen atoms). Compound 22-1 (batch 99367) contains a ratio of about 1:1 of nitrogen functionalization by hexyl halide to nitrogen functionalization by propylene oxide (i.e., the number of hexyl groups is about equal to the number of 2-hydroxypropyl groups on the nitrogen atoms).

### Example 23. Compound 23-1

Compound 23-1 is analogous to compound 37478 but was prepared from a PEI with MW=25 kDa. Compound 23-1 contains a ratio of about 1:1 of nitrogen functionalization by hexyl halide to nitrogen functionalization by propylene oxide (i.e., the number of hexyl groups is about equal to the number of 2-hydroxypropyl groups on the nitrogen atoms).

### Example 24. Compound 24-1

Compound 24-1 (batch 109590) is analogous to HB37478 of Example 4, but a branched 70 kDa PEI was used rather than a hyperbranched 70 kDa PEI. Compound 24-1 (batch 109590) contains a ratio of about 1:1 of nitrogen functionalization by hexyl halide to nitrogen functionalization by propylene oxide (i.e., the number of hexyl groups is about equal to the number of 2-hydroxypropyl groups on the nitrogen atoms).

### Example 25. Compound 25-1

Compound 25-1 (batch 105402 and batch 109634) is analogous to QPEI sample 2-9 of Example 16 (prepared from a PEI with MW=70 kDa). Compound 25-1 (batch 105402 and batch 109634) contains a ratio of about 1:1 of nitrogen functionalization by phenacyl halide to nitrogen functionalization by propylene oxide (i.e., the number of phenacyl groups is about equal to the number of 2-hydroxypropyl groups on the nitrogen atoms).

### Example 26. Compound 26-1

Compound 26-1 (batch 109781) is analogous to QPEI 37169 of Example 2 (prepared from a PEI with MW=70 kDa). Compound 26-1 (batch 109781) contains a ratio of about 1:1 of nitrogen functionalization by benzyl halide to nitrogen functionalization by propylene oxide (i.e., the number of benzyl groups is about equal to the number of 2-hydroxypropyl groups on the nitrogen atoms).

### Example 27. Compound 27-1

Compound 27-1 (batch 110417) is analogous to compound 25-1 but is prepared from a PEI with MW=750 kDA.

### Example 28. Compound 28-1

Compound 28-1 (batch 109831) is analogous to polyethyleneimine intermediate 40660 of Example 11 (prepared from a PEI with MW=70 kDa).

### Example 29. Compound 29-1

Compound 29-1 (batch 110420) is analogous to polyethyleneimine intermediate 40818 of Example 12 (prepared from a PEI with MW=70 kDa).

### Example 30. Compound 30-1

Compound 30-1 corresponds to the intermediate compound in the synthesis of QPEI 37169 of Example 2, resulting from reaction of PEI (MW=70 kDa) with propylene oxide. Accordingly, there are no quaternary amines in compound 29-1.

### Example 31. Compound 31-1

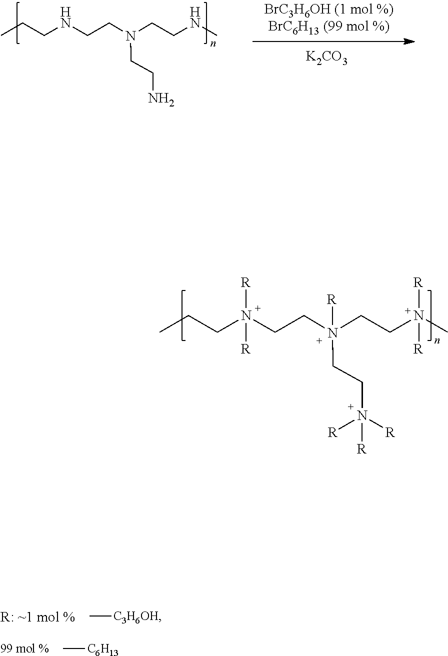

A 1-L 3-neck round bottom flask was fitted with a dropping funnel, condenser, water bath and mechanical stirrer. The flask was flushed with nitrogen gas, and the reaction carried out under a nitrogen gas flow.

20 g of a 50% aqueous solution of 70 kDa branched PEI (10 g PEI polymer, 0.180 mole amine content with a ratio of primary to secondary to tertiary amines of approximately 1:2:1) was added to the flask and stirred at ˜200 RPM. Note that 0.180 mole nitrogen content with this ratio of primary, secondary, and tertiary amines in theory can react with 0.36 mole of alkyl halide. This is defined as “1 equivalent of alkyl halide” for this example.

tert-Amyl alcohol (150 ml) was added to the flask at ambient temperature followed by K₂CO₃ (32.1 g, 0.232 mole). A mixture of bromopropanol (1.29 g, 0.0093 mole) and 1-bromohexane (151.86 g, 0.92 mole), (total alkyl halide=0.93 mole, 2.6 equivalents with mole % content of each alkyl halide=1% bromopropanol/99% 1-bromohexane), was added dropwise over 1-2 hours at ambient temperature.

The reaction temperature was increased to 96° C., and the reaction stirred at 96° C. for 98 hours. The reaction was allowed to cool to 25-30° C., filtered, and the filtered material washed with methanol (50 ml). The filtrate was evaporated to dryness under vacuum keeping the temperature below 50° C. To the residue was added diethyl ether (200 ml), and the mixture was stirred for 30-60 minutes at room temperature after which time a light brown slurry had formed. This mixture was allowed to settle, and the supernatant decanted off. This diethyl ether trituration and decanting was repeated 3-4 times until the residual alkyl halide content in the decant layer was less than 0.5% as determined by GC analysis.

After completing the trituration/decantation process, the mixture was evaporated to dryness under reduced pressure while keeping the temperature below 40° C., resulting in an off-white sticky solid. This solid was dissolved in methyl ethyl ketone (100 ml) at 25-30° C., filtered through Celite, and the filtrate evaporated to dryness under reduced pressure at 45° C. The resulting solid was oven-dried for 4-6 hours at below 45° C. providing the product (37.8 g) as an off-white solid. Water content was measured by Karl-Fischer analysis to be 0.24%. Bromine content was measured by AgNO₃ titration to be 23.6%. The theoretical mole % of PEI reaction with 1-bromopropanol and 1-bromohexane is 1% and 99%, respectively, assuming similar alkylation rates between the two alkyl halides.

### Example 32. Compound 32-1

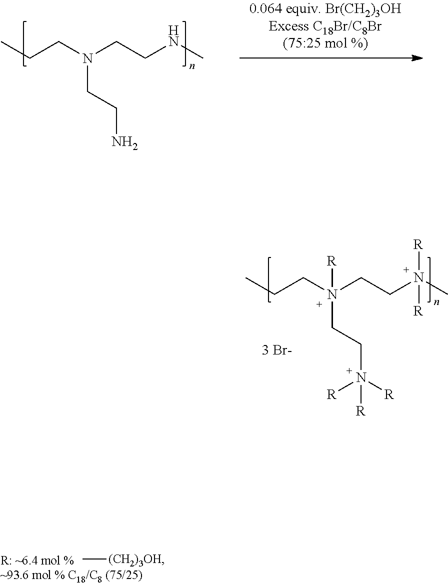

A 1-L 4-neck round bottom flask was fitted with a dropping funnel, condenser, water bath and mechanical stirrer. The flask was flushed with nitrogen gas, and the reaction carried out under a nitrogen gas flow.

10 g of 25 kDa hyperbranched PEI (0.180 mole amine content with a ratio of primary to secondary to tertiary amines of approximately 1:1:1) was added to the flask along with water (10 ml). Note that 0.180 mole nitrogen content with this ratio of primary, secondary, and tertiary amines in theory can react with 0.36 mole of alkyl halide. This is defined as “1 equivalent of alkyl halide” for this example.

tert-Amyl alcohol (50 ml) was added to the flask at ambient temperature, and this suspension was stirred at 160-180 RPM. After 15-30 minutes stirring, the mixture was cooled to 0-5° C., and bromopropanol (3.2 g, 0.023 mole, 0.064 equivalents) was added dropwise over 15-30 minutes at 0-5° C. The reaction mixture was stirred at 0-5° C. for 4-5 hours and then the temperature was allowed to increase to ambient temperature. The reaction was stirred at ambient temperature for 14-15 hours after which time the reaction mixture was a hazy solution.

The water content of the reaction was reduced by azeotropic distillation of solvent (˜10 mL). This volume of tert-Amyl alcohol was added to the reaction, and the distillation process repeated 3 times. tert-Amyl alcohol was added to make up the original reaction volume, and the resulting mixture was stirred for 60-90 minutes at 50-60° C. after which time a clear solution was obtained.

A mixture (0.928 mole, 2.6 equivalents of alkyl halide) of 1-bromooctadecane (232.1 g, 0.696 mole) and 1-bromooctane (44.8 g, 0.232 mole) was added at 50-60° C. The temperature was raised to 94-98° C., and the reaction stirred at this temperature for 48 hours, resulting in a clear brown solution. The solvent was removed under reduced pressure at below 60° C., the resulting residue cooled to 25-30° C., and 500 mL acetone was added. The resulting suspension was stirred at 25-30° C. for 30-60 minutes. Stirring was stopped, and the suspension allowed to settle for 1 hour. The supernatant liquid was decanted away from solid, and acetone (500 ml) was added to the solid residue. This suspension was stirred at 25-30° C. for 30-60 minutes after which time the stirring was stopped, and the suspension was allowed to settle over 30-60 minutes, and the supernatant liquid decanted away from the settled solid. This suspension stirring, settling and decanting process was repeated several more times until the 1-bromooctadecane and 1-bromooctane in the supernatant was less than 0.5% as measured by GC analysis.

The remaining solvent was removed under reduced pressure at below 35° C. The solid product was further dried for 8-10 hours at below 35° C., affording 40.6 g of the QPEI product as a light brown solid. Bromine content was determined to be ˜23% as measured by AgNO₃ titration. The theoretical mole % of reaction with 1-bromopropanol and the 75/25 mixture of 1-bromooctadecane and 1-bromooctane is 6.4% and 93.6%, respectively.

### Example 33. Compound 33-1

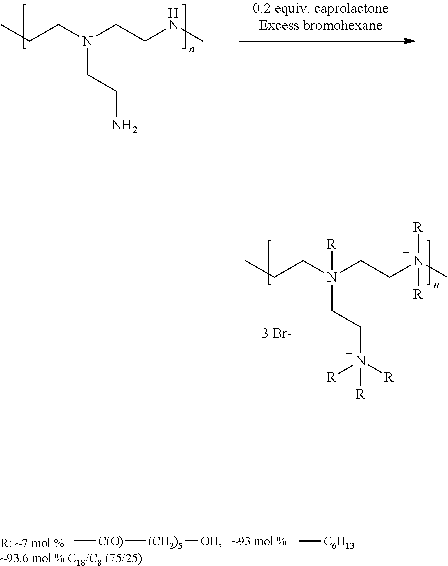

A 0.5-L 4-neck round bottom flask was fitted with a dropping funnel, condenser, water bath and mechanical stirrer. The flask was flushed with nitrogen gas and the reaction carried out under a nitrogen gas flow.

10 g of 25 kDa hyperbranched PEI (0.180 mole amine content with a ratio of primary to secondary to tertiary amines of approximately 1:1:1) was added to the flask and stirred at 160-180 RPM. Note that 0.180 mole nitrogen content with this ratio of primary, secondary, and tertiary amines in theory can react with 0.120 mole of caprolactone (“1 equivalent of caprolactone” for this example) and 0.360 mole of 1-bromohexane (“1 equivalent of 1-bromohexane” for this example).

Water (10 g) was added to the flask along with tert-amyl alcohol (50 ml), and the resulting solid suspension was cooled to 0-5° C.

Caprolactone (2.65 g, 0.0238 mole, 0.2 equivalent) was added dropwise over 15-30 minutes at 0-5° C. The resulting mixture was stirred at 0-5° C. for 4-5 hours. The temperature was increased to 25-30° C., and the reaction was stirred at this temperature for 14-15 hours resulting in a hazy solution.

tert-Amyl alcohol was distilled off to azeotropically remove water from the reaction mixture, and fresh tert-amyl alcohol was added to replace the solvent that was distilled off. The reaction temperature was increased to 50-60° C., and the reaction stirred for 60-90 minutes resulting in a clear solution. 1-Bromohexane (153.2 g, 0.928 mole, 2.6 equivalents) was added. The resulting reaction mixture was stirred for 15-30 minutes at 50-60° C. and then the temperature was increased to 94-98° C. The reaction was stirred at this temperature for 48 hours resulting in a solid suspension.

The reaction was cooled to 25-30° C. Diethyl ether (100 ml) was added dropwise, and the resulting suspension was stirred at 25-30° C. for 30-60 minutes. Stirring was stopped and the suspension was allowed to settle for 1 hour. The supernatant liquid was decanted away from the settled solid, and fresh diethyl ether (100 ml) was added. This suspension stirring, settling and decanting process was repeated several times until the 1-bromohexane content in the decanted liquid was less than 0.5% as measured by GC analysis.

The remaining solvent was removed under reduced pressure at less than 35° C. The crude solid product was further dried for 10-12 hours at below 35° C., affording the QPEI product (32 g) as a beige solid. The water content was measured to be 1200 PPM as measured by Karl Fischer analysis. The bromine content was determined to be ˜35% as measured by AgNO₃ titration.

The theoretical mole % of PEI reaction with caprolactone and 1-bromohexane is ˜7% and ˜93%, respectively, assuming that the caprolactone primarily reacts with the primary amines.

### Example 34. Additional QPEI Compounds

The following compounds were prepared using procedures analogous to those in the above-described examples.

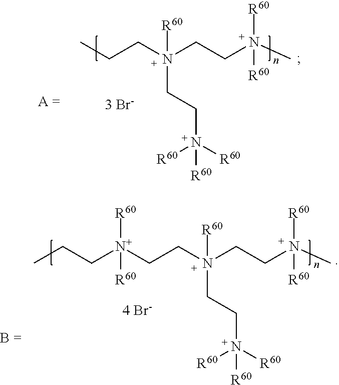

| | General | | |
|---|---|---|---|
| Compound | Structure | PEI MW* | R⁶⁰ (mole %) |
| 34-1 | B | 70 kDa | —(CH₂)₃OH (10%) |
| | | (branched) | —C₆H₁₃ (90%) |
| 34-2 | B | 70 kDa | —(CH₂)₃OH (5%) |
| | | (branched) | —C₆H₁₃ (95%) |
| 34-3 | B | 70 kDa | —CH₂CH(CH₃)OH (5%) |
| | | (branched) | —C₆H₁₃ (95%) |
| 34-4 | B | 70 kDa | —C(O)(CH₂)₅OH (7.5%) |
| | | (branched) | —C₆H₁₃ (92.5%) |
| 34-5 | A | 25 kDa | —CH₂CH(CH₃)OH (50%) |
| | | (hyper- | 50:50** —C₁₈H₃₇:—C₈H₁₇ (50%) |
| | | branched) | |
| 34-6 | B | 72 kDa | —(CH₂)₃OH (13%) |
| | | (branched) | 75:25** —C₁₈H₃₇:—C₈H₁₇ (87%) |
| 34-7 | B | 72 kDa | —C(O)(CH₂)₅OH (6.5%) |
| | | (branched) | 75:25** —C₁₈H₃₇:—C₈H₁₇ (93.5%) |
| 34-8 | A | 25 kDa | —C(O)(CH₂)₅OH (7%) |
| | | (hyper- | 75:25** —C₁₈H₃₇:—C₈H₁₇ (93%) |
| | | branched) | |
| 34-9 | A | 25 kDa | —CH₂CH(CH₃)OH (50%) |
| | | (hyper- | 25:75** —C₁₈H₃₇:—C₈H₁₇ (50%) |
| | | branched) | |

*indicates molecular weight of polyethyleneimine precursor
**indicates stoichiometric ratio

### Example 35. Antimicrobial Activity Studies

Minimum Inhibitory Concentration (MIC)

The standard broth microdilution method was used to investigate the antimicrobial efficacy of the tested compounds. Serial two-fold dilutions were prepared for each compound in concentrations ranging from 100 μM to 0.8 μM in sterile MH broth in flat 96-well plates. ONC of each bacterial strain was adjusted to give a standard bacterial concentration (5×10⁵ CFU/mL) and added to each dilution to determine the MIC in a total volume of 100 μL MH broth. All plates were statically incubated at 37° C. for 24 h. Sterile dH₂O was used as a vehicle only control, for each bacterial strain positive (bacteria only) and negative (MH media only) controls were included. To determine the MIC breakpoint plates were stained with 10 μL of 0.02% resazurin and incubated at 37° C. for 30 min. Following incubation, all plates were imaged, and absorbance was measured at 570 nm (Plate reader). The MIC is defined as the lowest concentration of compounds that inhibits growth. MH media was used as a negative control and bacteria only was used as a positive control on each plate for all compounds tested. Serial two-fold dilutions were performed by mixing 50 μL of the highest concentration (x2) from row A to H containing 50 μL sterile MH broth.

MIC Data Analysis

The data was exported to Microsoft Excel and background normalized by subtracting OD570 nm values from media only wells (−VE control). MIC values were determined by plotting the OD570 nm values (Y) against the log concentration of each compound (X). A modified Gompertz model was used to fit the data to obtain a more accurate MIC. The average OD570 nm for each test compound concentration was fitted to a sigmoidal curve using the modified Gompertz function (y=A+Ce−e(B(x−M))), and the minimum inhibitory concentration (MIC) was identified from the point of inflexion of the lower asymptote (GraphPad Prism 9.0). This was applied to the mean of three biological replicates each with four technical replicates (n=12) for each dilution in each compound.

Minimum Bactericidal Concentration (MBC) procedure

To determine MBC compound concentrations breakpoints were estimated from MIC curves. Overnight cultures were set up as described above for all bacterial strains. The following day overnight cultures were adjusted to give a cell density of 5×10⁵ cells per mL. Briefly, cultures were adjusted to the McFarland standard (0.08-0.12) and diluted (1:150). Adjusted cultures were inoculated into 96 well plates with 50 μL sterile Muller-Hinton broth (MHB) and 2 concentrations of each compound. MBC plates were statically incubated for 24 hours at 37° C. Sterile dH₂O was used as a vehicle control, positive (bacteria only) and negative controls (media only) were also included in the assay. MBC cultures were quantified by serial dilution in a 96 well plate and spot plating onto Muller-Hinton agar (MHA). MHA plates were incubated at 37° C. for 24 h and counted. Results are presented as CFU per mL.

Summary of Results:

TABLE 16
Summarized MIC values for compounds tested against listed bacteria. All values are μM.

| MIC* | Gram −VE | | | Gram +VE | | | |
|---|---|---|---|---|---|---|---|
| Compd_Batch | KL1 | PA27853 | EC25922 | EF51299 | EF19433 | SA29213 | MR1 |
| 25-1_105402 | 0.00 | Unstable | 82.82 | 20.04\hat{ } | 22.50\hat{ } | 4.55 | 4.21\hat{ } |
| 25-1_109634 | 0.00 | 58.40\hat{ } | 4.50E+06 | 61.47\hat{ } | 91.59\hat{ } | 8.39 | 17.35\hat{ } |
| 22-1_105159* | 3.36E+08 | 3.93E+25 | 1.26E+04 | 0.00 | 5.48E+09 | 1.12E+15 | 7.25E+11 |
| 22-1_99367* | 2.87E+12 | 18.57\hat{ } | 0.00 | 2.93 | 68443.00 | 2.94 | 2.98 |
| 39637_105543 | +infinity | 53.54 | 42.96 | 62.65\hat{ } | 3.20\hat{ } | 3.16 | 10.58\hat{ } |
| 39637_109466 | 2.06 | 62.14\hat{ } | 59.94 | 16.81\hat{ } | 2.59\hat{ } | 3.05 | 10.78\hat{ } |
| 24-1_109590 | 2.54E+11 | 119.70\hat{ } | 7.55 | 29.17\hat{ } | 7.68\hat{ } | 3.05 | 4.22\hat{ } |
| 23-1_109770 | 0.00 | +infinity | 2.92 | 3.62\hat{ } | 2.18\hat{ } | 2.08 | 1.43\hat{ } |
| 26-1_109781 | 6455.00 | 6.36 | 4.21 | 0.00\hat{ } | 20.16\hat{ } | 3.33 | 0.00\hat{ } |
| 40840_110435 | 1.76 | 0.00 | 0.03 | +infinity | 0.00 | 1.99 | +infinity |
| 27-1_110417 | +infinity | +infinity | 0.00 | 3.26E+13 | 3.99E+04 | 0.00 | 0.00 |
| 40598_109448* | 48.98 | 0.06 | 0.83 | 4.82E+10 | Unstable | 1.93 | 0.00 |
| 30-1_109666 | 2.16 | 19847.00 | 5.74 | 4.24 | 0.01 | 0.00 | 1.78\hat{ } |
| 28-1_109831 | 0.36 | 42.19\hat{ } | 4.26E+09 | 0.00 | 74346.00\hat{ } | 6.01 | 1.05\hat{ } |
| 40597_109444*\hat{ } | 0.01 | 2.84 | 0.00 | 27.19\hat{ } | 1.63\hat{ } | 0.00 | 0.94 |

*MIC values were estimated by using a modified Gompertz model to fit the data to obtain a more accurate MIC.
Values marked with \hat{ } indicate reliable estimation of MIC, whereas all other values indicate unreliable estimation using the model, interpret with caution.

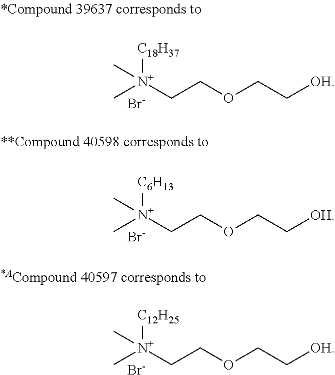

TABLE 17
Summarized MBC values for compounds tested
against listed bacteria. All values are μM.

| MBC | Gram −VE | | | Gram +VE | | | |
|---|---|---|---|---|---|---|---|
| Compd_Batch | KL1 | PA27853 | EC25922 | EF51299 | EF19433 | SA29213 | MR1 |
| 25-1_105402 | 50 | 75 | 50 | 25 | 6.25 | 3.12 | 6.25 |
| 25-1_109634 | — | — | 50 | 25 | — | — | 12.5 |
| 22-1_105159 | 0.78 | 0.78 | 1.5 | 0.4 | 6.25 | 0.4 | 0.4 |
| 22-1_99367 | 50 | 12 | 0.78 | 0.4 | 6.25 | 0.4 | 0.4 |
| 39637_105543 | — | — | 25 | — | 1.57 | 1.57 | 6.25 |
| 39637_109466 | 50 | — | 25 | 1.57 | 1.57 | 1.57 | 6.25 |
| 24-1_109590 | 25 | — | 3.1 | 50 | 6.25 | 3.12 | 3.12 |
| 23-1_109770 | 6.25 | — | 1.57 | 6.25 | 1.57 | 3.25 | — |
| 26-1_109781 | — | — | — | — | — | >6.25 | — |
| 40840_110435 | — | — | — | — | — | — | — |
| 27-1_110417 | 6.25 | — | — | 6.25 | 6.25 | 6.25 | 6.25 |
| 40598_109448 | — | — | — | — | — | — | |
| 30-1_109666 | — | — | — | — | — | — | >50 |
| 28-1_109831 | 25 | — | — | >50 | — | >6.25 | 6.25 |
| 40597_109444 | — | — | — | — | — | — | — |

Compounds 39637, 40598, and 40597 are defined as in Table 15.
—: no activity observed

Compounds 25-1 (batches 105402 and 109634), 39637 (batches 105543 and 109466), 24-1 (batch 109590), 23-1 (batch 109770), and 26-1 (batch 109781) showed strong antimicrobial activity towards the gram+ve species Enterococcus faecalis and Staphylococcus aureus.

In the Gram-negative species (Klebsiella pneumonia and Pseudomonas aeruginosa) three compounds were able to display an inhibitory effect within the investigated range of concentrations: compounds 22-1 (batch 105159), 22-1 (batch 99367), and 24-1 (batch 109590).

Compounds 39637 (batches 105543 and 109466), 24-1 (batch 109590), and 23-1 (batch 109770) inhibited Staphylococcus Aureus at concentrations from 1.57 μM to 6.25 μM.

Of all the compounds tested, the most effective MIC and MBCs were lower in Gram positive bacteria; however, there does appear to be broad spectrum activity with Gram negative bacteria at much higher concentrations.

Compound 22-1 (batches 105159 and 99367) exhibited the most effective MBC inhibition profile across all bacterial strains. MBC values clearly show inhibition of all strains at relatively low concentrations.

Of all compounds tested above, the following exhibited the lowest antimicrobial activity: compounds 40840 (batch 110435), 40598 (batch 109448), 30-1 (batch 109666), 28-1 (batch 109831), and 40597 (batch 109444). Compound 27-1 (batch 110417) showed low antimicrobial efficacy via MIC but inhibited five out of the seven strains at 6.25 μM in MBC.

Additional compounds were tested to obtain MIC values against the same bacteria shown in Tables 16 and 17 (see Table 18). ****: ≤12.5 μM MIC of QPEI for all tested bacteria; ***: >12.5 μM MIC of QPEI and ≤50 μM MIC of QPEI against >50% of the tested bacteria; **: >12.5 μM MIC of QPEI and ≤50 μM MIC of QPEI against <50% of the tested bacteria; *: >100 μM MIC of QPEI for all tested bacteria.

TABLE 18

| Compound | Antibacterial Efficiency |
|---|---|
| 31-1 | **** |
| 32-1 | ** |
| 33-1 | **** |
| 34-1 | **** |
| 34-2 | **** |
| 34-3 | **** |
| 34-4 | **** |
| 34-5 | *** |
| 34-6 | *** |
| 34-7 | *** |
| 34-8 | * |
| 34-9 | ** |

### REFERENCES

¹ Ellingson, K. D., et al. (2020). “Urban Hospital Study—Antimicrobial Surface Coating.” Clinical Infectious Diseases, 71(8): 1807-1813.
² Jarach, N., et al., (2020). “Polymers in the Medical Antiviral Front-Line”. Polymers, 12(8): 1727.
³ THE MERCK MANUAL OF DIAGNOSIS AND THERAPY, (2011). 19^{th} Edition, published by Merck Sharp & Dohme Corp., (ISBN 978-O-911910-19-3).
⁴ THE ENCYCLOPEDIA OF MOLECULAR CELL BIOLOGY AND MOLECULAR MEDICINE, Robert S. Porter et al. (eds.), published by Blackwell Science Ltd., 1999-2012 (ISBN 9783527600908).
⁵ MOLECULAR BIOLOGY AND BIOTECHNOLOGY: A COMPREHENSIVE DESK REFERENCE, (1995). Robert A. Meyers (ed.), published by VCH Publishers, Inc. (ISBN 1-56081-569-8).
⁶ IMMUNOLOGY, (2006). Werner Luttmann, published by Elsevier.
⁷ JANEWAY'S IMMUNOBIOLOGY, (2014). Kenneth Murphy, Allan Mowat, Casey Weaver (eds.), Taylor & Francis Limited, (ISBN 0815345305, 9780815345305).
⁸ LEWIN'S GENES XI, (2014). published by Jones & Bartlett Publishers (ISBN-1449659055).
⁹ Michael Richard Green and Joseph Sambrook, (2012). MOLECULAR CLONING: A LABORATORY MANUAL, 4th ed., Cold Spring Harbor Laboratory Press, Cold Spring Harbor, N.Y., USA (ISBN 1936113414).
¹⁰ Davis et al., (2012). BASIC METHODS IN MOLECULAR BIOLOGY, Elsevier Science Publishing, Inc., New York, USA (ISBN 044460149X).
¹¹ LABORATORY METHODS IN ENZYMOLOGY: DNA, (2013). Jon Lorsch (ed.) Elsevier (ISBN 0124199542).
¹² CURRENT PROTOCOLS IN MOLECULAR BIOLOGY (CPMB), (2014). Frederick M. Ausubel (ed.), John Wiley and Sons (ISBN 047150338X, 9780471503385).
¹³ CURRENT PROTOCOLS IN PROTEIN SCIENCE (CPPS), (2005). John E. Coligan (ed.), John Wiley and Sons, Inc.
¹⁴ CURRENT PROTOCOLS IN IMMUNOLOGY (CPI) (2003). Coligan, J. E., et al., (eds.) John Wiley and Sons, Inc. (ISBN 0471142735, 9780471142737).
¹⁵ Ikonen, N., et al., (2018). “Deposition of respiratory virus pathogens on frequently touched surfaces at airports.” BMC Infectious Diseases, 18(437): 1-8.
¹⁶ Géczi, Z., et al., (2018). “Antimicrobial Silver-Polyethyleneimine Polylactic Acid Polymer Composite Film for Coating Methacrylate-Based Denture Surfaces.” J. of Nanomaterials, 2018(6): 1-9.
¹⁷ Park, D., et al., (2006). “One-Step, Painting-Like Coating Procedures To Make Surfaces Highly and Permanently Bactericidal.” Biotechnology Prog. 22(2): 584-589.
¹⁸ Xue, Y. and Xiao, H. (2015). “Antibacterial/Antiviral Property and Mechanism of Dual- Functional Quaternized Pyridinium-Type Copolymer.” Polymers, 7(11): 2290-2303.
¹⁹ U.S. Pat. No. 5,783,502, “Virus Inactivating Coatings.” (Issued Jul. 21, 1998).
²⁰ Nurdin, N., et al., (1993). “Biocidal Polymers Active By Contact. II. Biological Evaluation of Polyurethane Coatings with Pendent Quaternary Ammonium Salts.” J. of Applied Polymer Science, 50: 663-670.
²¹ Chung, S., et al., (2016). “Antimicrobial Nanostructural Polyurethane Scaffolds.” Ch. 17 in ADVANCES IN POLYURETHANE BIOMATERIALS, Cooper S. L. and Guan, J. (eds.), Elsevier Ltd.
²² Park, D., et al., (2013). “Antiviral and Antibacterial Polyurethanes of Various Modalities.” Appl. Biochem. Biotechnol., 169: 1134-1146.
²³ Gao, B., et al., (2007). “Studies on the Preparation and Antibacterial Properties of Quaternized Polyethyleneimine.” J. Biomaterials Science, Polymer Edition, 18(5): 531-544.
²⁴ Klibanov, A., et al., (2006). “One-Step Painting-Like Coating Procedures to make Surfaces Highly and Permanently Bactericidal.” Biotechnol. Prog., 22(2): 584-589.
²⁵ Gao, B., et al., (2007). “Studies on the Preparation and Antibacterial Properties of Quaternized Polyethyleneimine.” J. Biomaterials Science, Polymer Edition, 18(5): 531-544.
²⁶ Id.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology described herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The foregoing written specification is considered to be sufficient to enable one skilled in the art to practice the present aspects and embodiments. The present aspects and embodiments are not to be limited in scope by examples provided, since the examples are intended as a single illustration of one aspect and other functionally equivalent embodiments are within the scope of the disclosure. Various modifications in addition to those shown and described herein will become apparent to those skilled in the art from the foregoing description and fall within the scope of the appended claims. The advantages and objects described herein are not necessarily encompassed by each embodiment. Those skilled in the art will recognize, or be able to ascertain using no more than routine experimentation, many equivalents to the specific embodiments described herein. Such equivalents are intended to be encompassed by the following claims.

1. An antimicrobial composition comprising an oil-in-water emulsion, the oil-in-water emulsion comprising:
(i) an oil phase comprising
a first adduct of a first multifunctional crosslinker and a first quaternary ammonium salt, wherein the first quaternary ammonium salt has a reactive linking group to react with the first multifunctional crosslinker;
optionally a polyol;
a polyethyleneimine intermediate, or a second adduct of the polyethyleneimine intermediate and a second multifunctional crosslinker; and
optionally a third multifunctional crosslinker; and
(ii) an aqueous phase comprising a water-soluble polymer,
wherein the polyethyleneimine intermediate comprises optionally substituted hydroxyalkylene functionality that reacts with the first adduct and, if present, the second multifunctional crosslinker; and
nitrogen atoms present in the polyethyleneimine intermediate are at least partially quaternized.

2. The antimicrobial composition of claim 1, wherein the water-soluble polymer is crosslinked with (a) the first multifunctional crosslinker as incorporated in the first adduct; (b) when present, the second multifunctional crosslinker as incorporated in the second adduct; (c) when present, the third multifunctional crosslinker; or (d) any combination of two or more thereof.

3. The antimicrobial composition of claim 1, wherein the first quaternary ammonium salt has a chemical structure of 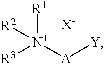
wherein
R¹ is selected from a group consisting of —(C₈-C₃₀ alkyl), —(C₈-C₃₀ heteroalkyl), —(C₈-C₃₀ heteroalkyl)-(C₆-C₁₀ aryl), —(C₆-C₁₀ aryl), —(C₆-C₁₀ aryl)-(C₈-C₃₀ alkyl), —(C₆-C₁₀ aryl)-(C₈-C₃₀ heteroalkyl), —(CR^{m}Rⁿ)ₓ₁₀—W¹⁰—(CR^{p}R^{q})_{y10}—H, and —(CR^{p}R^{q})ₓ₁₁—W¹¹—(CR^{p}R^{q})_{y11}H—; wherein —(C₈-C₃₀ heteroalkyl), —(C₈-C₃₀ heteroalkyl)-(C₆-C₁₀ aryl), and —(C₆-C₁₀ aryl)-(C₈-C₃₀ heteroalkyl) have 1 to 4 heteroatoms independently selected from O, S, and Si;
R² is selected from a group consisting of —(C₁-C₄ alkyl), —(C₁-C₄ heteroalkyl), —(C₁-C₄ heteroalkyl)-(C₆-C₁₀ aryl), —(C₆-C₁₀ aryl), —(C₆-C₁₀ aryl)-(C₁-C₄ alkyl), —(C₆-C₁₀ aryl)-(C₁-C₄ heteroalkyl), —(CR^{m}Rⁿ)ₓ₂₀—W²⁰—(CR^{p}R^{q})_{y20}—H, and —(CR^{m}Rⁿ)ₓ₂₁—W²¹—(CR^{p}R^{q})_{y21}—H; wherein —(C₁-C₄ heteroalkyl), —(C₁-C₄heteroalkyl)-(C₆-C₁₀ aryl), and —(C₆-C₁₀ aryl)-(C₁-C₄heteroalkyl) have 1 to 2 heteroatoms independently selected from O, S, and Si;
R³ is selected from a group consisting of —(C₁-C₃₀ alkyl), —(C₁-C₃₀ heteroalkyl), —(C₁-C₃₀ heteroalkyl)-(C₆-C₁₀ aryl), —(C₆-C₁₀ aryl), —(C₆-C₁₀ aryl)-(C₁-C₃₀ alkyl), —(C₆-C₁₀ aryl)-(C₁-C₃₀ heteroalkyl); —(CR^{m}Rⁿ)ₓ₃₀—W³⁰—(CR^{p}R^{q})_{y30}—H, and —(CR^{m}Rⁿ)ₓ₃₁—W³¹—(CR^{p}R^{q})_{y31}—H; wherein —(C₁-C₃₀ heteroalkyl), —(C₁-C₃₀ heteroalkyl)-(C₆-C₁₀ aryl), and —(C₆-C₁₀ aryl)-(C₁-C₃₀ heteroalkyl) have 1 to 4 heteroatoms independently selected from O, S, and Si;
A is a linking group selected from a group consisting of —(C₃-C₂₀ alkylene)-, —(C₃-C₂₀heteroalkylene)-, —(C₆-C₁₀ arylene)-(C₃-C₂₀ alkylene)-, —(CR^{m}Rⁿ)ₓ₄₀—W⁴⁰-(CR^{p}R^{q})_{y40}—, and —(CR^{m}Rⁿ)₄₁—W⁴¹—(CR^{p}R^{q})_{y41}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m}, Rⁿ, R^{p}, and R^{q} is independently selected from H and C₁-C₄ alkyl;
W¹⁰, W²⁰, W³⁰, and W⁴⁰ are independently selected from —C(O)—; —C(O)O—; —OC(O)—; —C(O)NH—; and —NHC(O)—;
W¹¹, W²¹, W³¹, and W⁴¹ are independently selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x10 is an integer from 1 to 30 and y10 is an integer from 0 to 29, wherein 8≤(x10+y10)≤30;
x11 is an integer from 1 to 30 and y11 is an integer from 0 to 29, wherein 8≤(x11+y11)≤30;
x20 is an integer from 1 to 4 and y20 is an integer from 0 to 3, wherein x20+y20≤4;
x21 is an integer from 1 to 4 and y21 is an integer from 0 to 3, wherein x21+y21≤4;
x30 is an integer from 1 to 30 and y30 is an integer from 0 to 29, wherein x30+y30≤30;
x31 is an integer from 1 to 30 and y31 is an integer from 0 to 29, wherein x31+y31≤30;
x40 is an integer from 1 to 19 and y40 is an integer from 1 to 19, wherein 3≤(x40+y40)≤20;
x41 is an integer from 1 to 20, and y41 is an integer from 0 to 19, wherein 3≤(x41+y41)≤20;
Y is selected from a group consisting of —OH, —NHR⁴, —SH, —CO₂H, —C(O)NHR⁴, —C(S)NHR⁴, 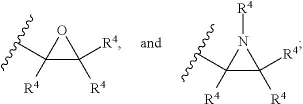
each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

4.-17. (canceled)

18. The antimicrobial composition of claim 1, wherein:
(a) the first multifunctional crosslinker is a first polyisocyanate; the second multifunctional crosslinker, when present, is a second polyisocyanate; the third multifunctional crosslinker, when present, is a third polyisocyanate; and the first polyisocyanate, the second polyisocyanate, and the third polyisocyanate are different; or
(b) the first multifunctional crosslinker is a first polyisocyanate; the second multifunctional crosslinker, when present, is a second polyisocyanate; the third multifunctional crosslinker, when present, is a third polyisocyanate; and the first polyisocyanate, the second polyisocyanate, and the third polyisocyanate are the same.

19.-21. (canceled)

22. The antimicrobial composition of claim 18, wherein each of the first, second, and third polyisocyanates is prepared from a diisocyanate independently selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

23.-38. (canceled)

39. The antimicrobial composition of claim 1, wherein the polyol, when present, is selected from a group consisting of polyether polyols, polyester polyols, polyacrylic polyols, polymethacrylic polyols, polycaprolactone polyols, polybutadiene polyols, poly(acrylonitrile-co-butadiene) polyols, polysiloxane polyols, a copolymer of any two or more thereof, and a combination of any two or more thereof.

40.-45. (canceled)

46. The antimicrobial composition of claim 1, wherein the water-soluble polymer is selected from a group consisting of hydroxyethyl cellulose (HEC), hydroxypropyl cellulose, polyvinyl alcohol, poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyacrylamide, polyethyleneimine intermediate, a copolymer of two or more thereof, a copolymer of one or more thereof with polyvinylpyrrolidone poly(glycidyl acrylate) or with poly(glycidyl methacrylate), and a combination or blend of two or more thereof.

47.-60. (canceled)

61. The antimicrobial composition of claim 1, wherein the oil phase further comprises a third adduct of the first multifunctional crosslinker and a second quaternary ammonium salt 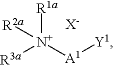
wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m1}Rⁿ¹)ₓ₄₂—W⁴²—(CR^{p1}R^{q1})_{y42}—, and —(CR^{m}Rⁿ¹)ₓ₄₃—W⁴³—(CR^{p1}R^{q1})_{y43}-, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{g1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NR^{4a}, —C(S)NHR^{4a} 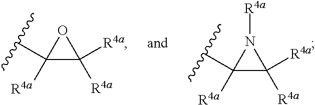
each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

62. The antimicrobial composition of claim 1, wherein the oil phase further comprises a third adduct of a fourth multifunctional crosslinker and a second quaternary ammonium salt 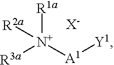
wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m1}Rⁿ¹)ₓ₄₂—W⁴²—(CR^{p1}R^{q1})_{y42}—, and —(CR^{m1}Rⁿ¹)ₓ₄₃—W⁴³—(CR^{p1}R^{q1})_{y43}-, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NR^{4a}, —C(S)NHR^{4a}, 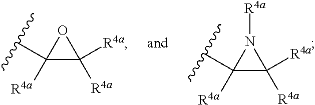
each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, triflate, borate, or an organo-substituted derivative of any of the foregoing.

63.-86. (canceled)

87. The antimicrobial composition of claim 1, wherein the polyethyleneimine intermediate comprises;
(i) a reaction product of reagents comprising a polyethyleneimine, a mono-epoxide, and an alkylating agent, wherein the mono-epoxide is optionally substituted with C₁-C₆ alkyl optionally substituted with a substituent selected from —(C₆-C₁₀ aryl), and —(C₁-C₆ alkoxy) optionally substituted with hydroxy, C₁-C₆ alkoxy, C₆-C₁₀ aryl optionally substituted with C₁-C₆ alkyl, or carboxy;
(ii) a reaction product of reagents comprising a polyethyleneimine, a mono-epoxide, and optionally an alkylating agent: the mono-epoxide is substituted with —(C₁-C₆ alkyl)-N⁺(R²⁰)₃X⁻; each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl); and each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivative; or
(iii) a reaction product of reagents comprising a polyethyleneimine and a haloalkanol.

88.-104. (canceled)

105. The antimicrobial composition of claim 1, wherein the polyethyleneimine intermediate is selected from 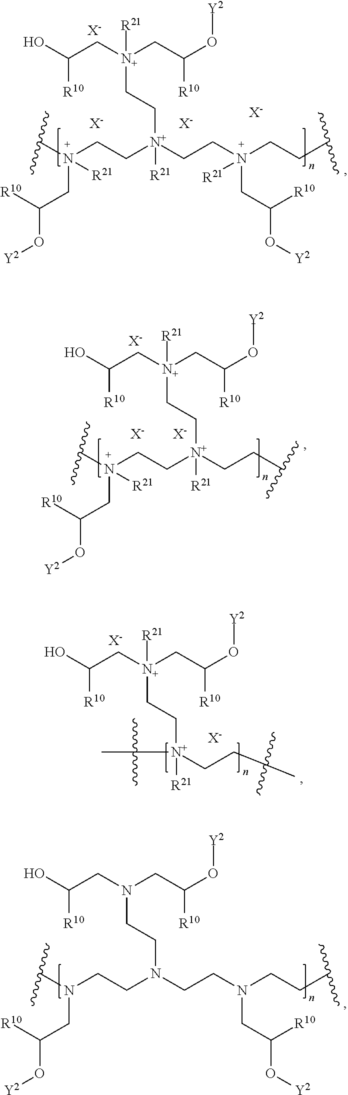 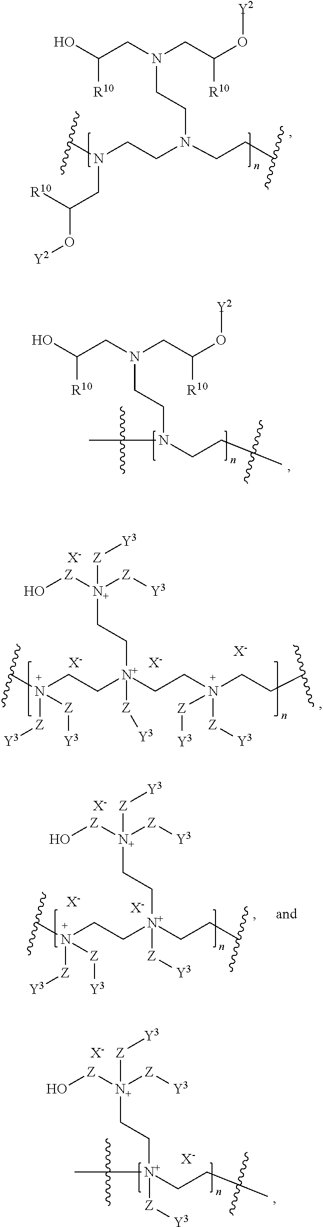
or a copolymer of any two or more thereof,
wherein:
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000;
Z is —(C₂-C₆ alkylene)-;
each R¹⁰ is independently selected from hydrogen; C₁-C₆ alkyl optionally substituted with a substituent selected from —N⁺(R²⁰)₃X⁻, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), or carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); and (2) C₆-C₁₀ aryl optionally substituted with 1-3 substituents independently selected from halogen, —(C₁-C₆ alkyl), and —SiR^{a}(OR^{b})(OR^{c}); wherein each R^{a} is independently —(C₁-C₆ alkyl); and each R^{b} and each R^{c} are independently selected from —(C₁-C₆ alkyl) and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), or carboxy, then the polyethyleneimine intermediate is selected from

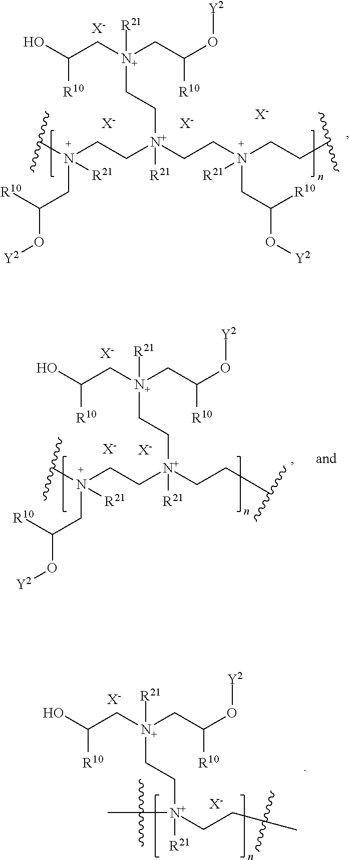

106. The antimicrobial composition of claim 1, wherein the polyethyleneimine intermediate is 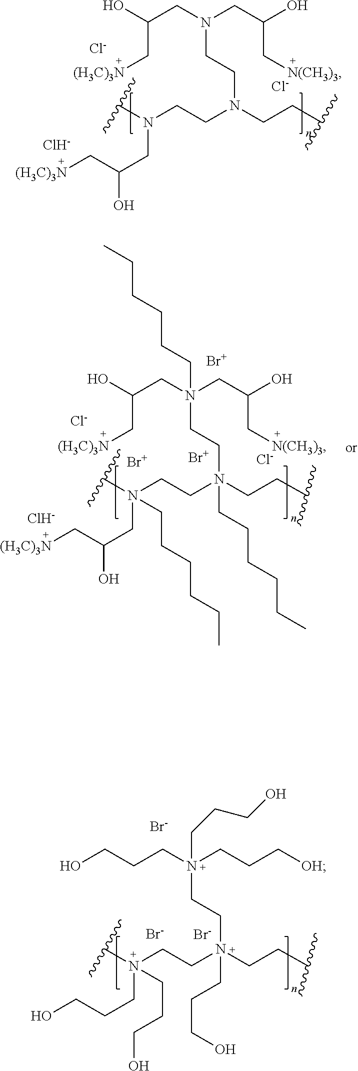
wherein each n is an integer independently selected from 1 to 3000.

107. (canceled)

108. The antimicrobial composition of claim 1, wherein the second adduct is of formula (I): 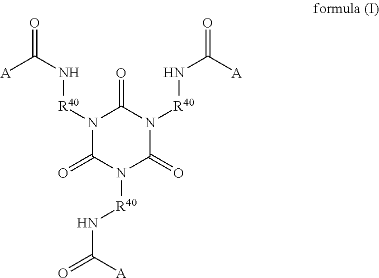
wherein:
each A is independently selected from 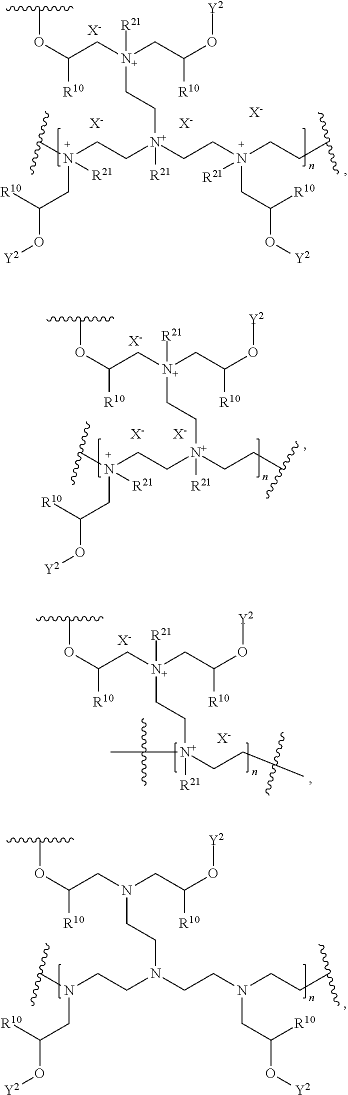 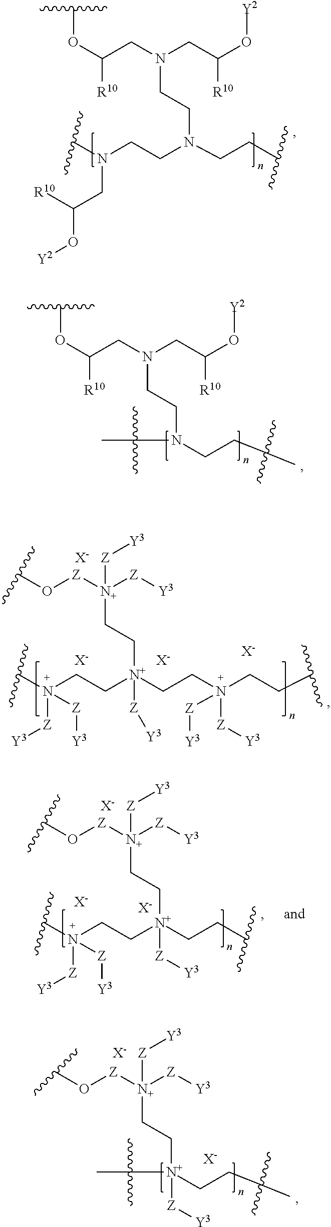
or a copolymer of any two or more thereof, and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000;
Z is —(C₂-C₆ alkylene)-;
each R¹⁰ is independently selected from hydrogen; C₁-C₆ alkyl optionally substituted with a substituent selected from —N⁺(R²⁰)₃X⁻, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), or carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl); (2) C₆-C₁₀ aryl optionally substituted with 1-3 substituents independently selected from halogen, —(C₁-C₆ alkyl), and —SiR^{a}(OR^{b})(OR^{c}); and (3) 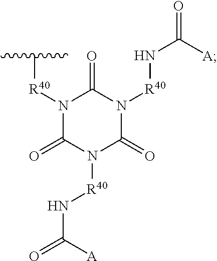
wherein each
R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), or carboxy, then each A is independently selected from

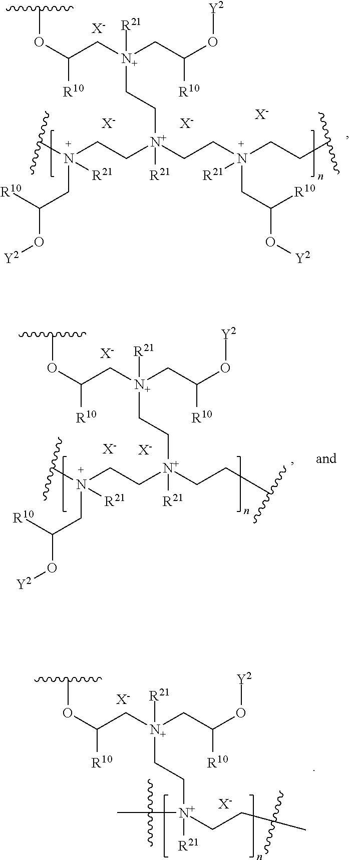

109. The antimicrobial composition of claim 1, wherein the second adduct is of formula (II): 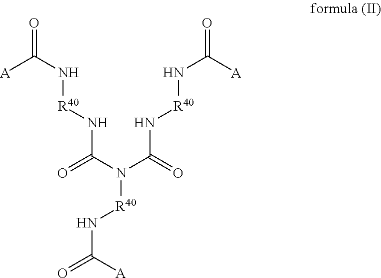
wherein:
each A is independently selected from 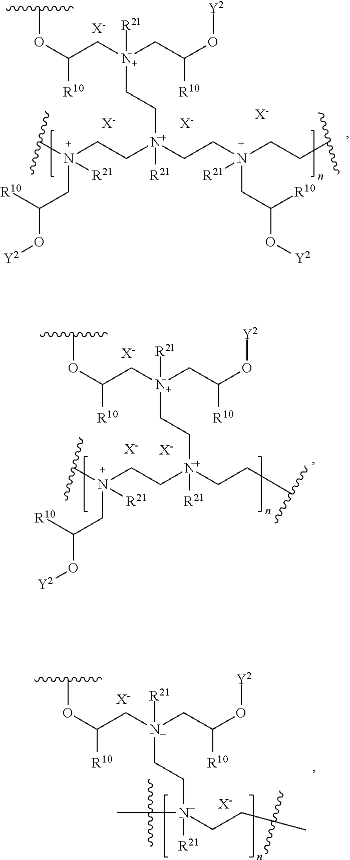 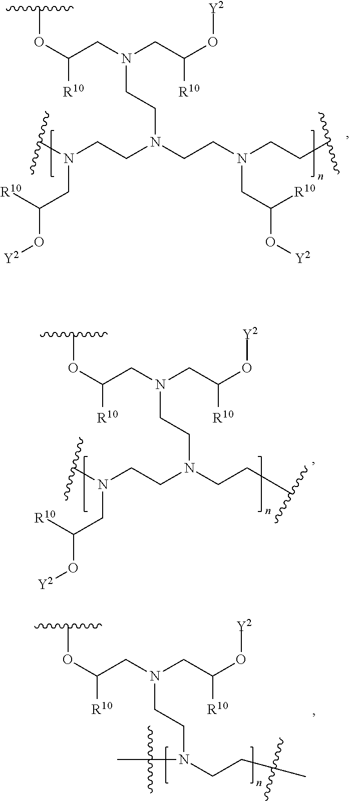 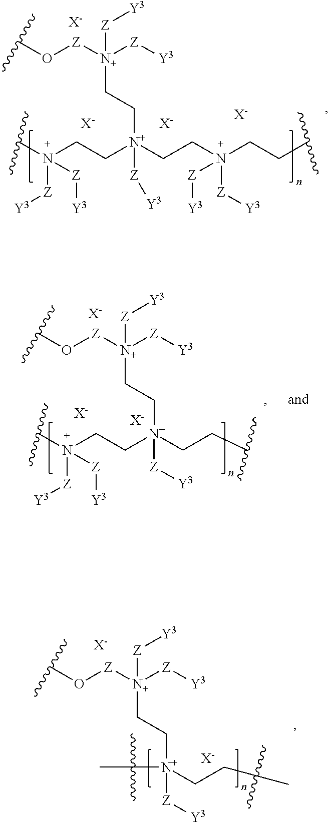
or a copolymer of any two or more thereof, and attachment of each A forms a carbamate linkage;
each Y³ is independently H or —O—Y², wherein every Y³ cannot be H;
each Y² is independently H or —C(O)—NHR³⁰, wherein every Y² cannot be —C(O)—NHR³⁰;
each n is an integer independently selected from 1 to 3000;
Z is —(C₂-C₆ alkylene)-;
each R¹⁰ is independently selected from hydrogen; C₁-C₆ alkyl optionally substituted with a substituent selected from —N⁺(R²⁰)₃X⁻, —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), or carboxy; and each R²⁰ is independently selected from a group consisting of C₁-C₁₈ alkyl; C₁-C₁₈ heteroalkyl having 1 to 4 heteroatoms independently selected from O, S, Si and tertiary-substituted N; and C₆-C₁₀ aryl optionally substituted with —(C₁-C₆ alkyl), —(C₁-C₆ alkoxy), —C(O)O—(C₁-C₆ alkyl), —C(O)NH(C₁-C₆ alkyl), —C(O)N(C₁-C₆ alkyl)₂, or —OC(O)—(C₁-C₆ alkyl);
each R²¹ is independently selected from C₁-C₆ alkyl optionally substituted with a substituent selected from —OH, —(C₁-C₆ alkoxy), carboxy, —(C₆-C₁₀ aryl), —C(O)O(C₁-C₆ alkyl), —C(O)—(C₆-C₁₀ aryl), and —(C₁-C₆ alkoxy) optionally substituted with —OH;
each R³⁰ is independently selected from (1) C₆-C₂₀ alkyl optionally substituted with 1-3 substituents independently selected from halogen, —SiR^{a}(OR^{b})(OR^{c}), and —(C₆-C₁₀ aryl);
(2) C₆-C₁₀ aryl optionally substituted with 1-3 substituents independently selected from halogen, —(C₁-C₆ alkyl), and —SiR^{a}(OR^{b})(OR^{c}); and (3) 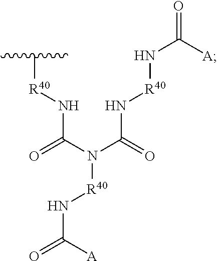
wherein
each R^{a} is independently —(C₁-C₆ alkyl); and each R^{b} and each R^{c} are independently selected from —(C₁-C₆ alkyl) and —Si(C₁-C₆ alkyl)₃;
each R⁴⁰ is independently —(C₁-C₁₀ alkylene)- optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, triflate, and borate, and their organo-substituted derivatives;
provided:
when R¹⁰ is C₁-C₆ alkyl optionally substituted with a substituent selected from —(C₆-C₁₀ aryl), and —(C₁-C₆ alkoxy) optionally substituted with —OH, —(C₁-C₆ alkoxy), —(C₆-C₁₀ aryl) optionally substituted with —(C₁-C₆ alkyl), or carboxy, then each A is independently selected from

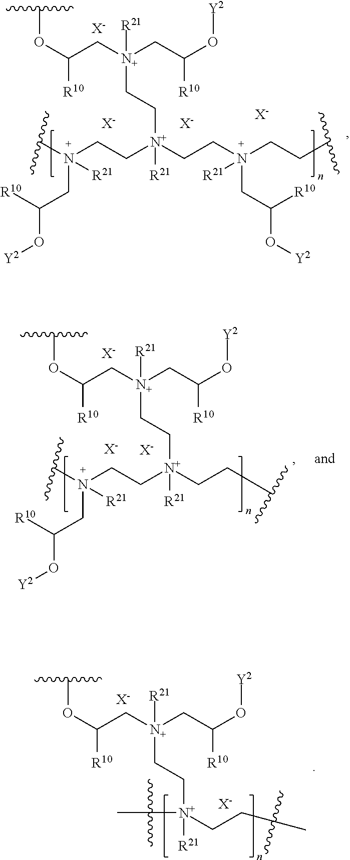

110. A polymer or interpenetrating polymer network comprising a random polymerization/crosslinking product of reagents comprising (i) a first adduct of a first multifunctional crosslinker and a first quaternary ammonium salt; (ii) a polyol; (iii) a polyethyleneimine intermediate or a second adduct of the polyethyleneimine intermediate and a second multifunctional crosslinker; and (iv) optionally a third multifunctional crosslinker.

111.-183. (canceled)

184. A composition comprising the polymer or interpenetrating polymer network of claim 110.

185.-195. (canceled)

196. An antimicrobial coating, coating fluid, or spraying fluid comprising the composition of claim 1.

197. A device, equipment, apparatus, accessory, or personal care aid comprising the coating, the coating fluid or the spraying fluid of claim 196.

198.-202. (canceled)

203. A method to sanitize a surface, to reduce antimicrobial growth on a surface, or to prevent antimicrobial growth on a surface, the method comprising applying the composition of claim 1.

204.-207. (canceled)

208. A polymer or interpenetrating polymer network prepared by:
(a) reacting a first multifunctional crosslinker with a first quaternary ammonium salt to form a first adduct;
(b) optionally reacting a polyethyleneimine intermediate with a second multifunctional crosslinker to form a second adduct;
(c) optionally reacting the first multifunctional crosslinker or a fourth multifunctional crosslinker with a second quaternary ammonium salt to form a third adduct;
(d) combining (i) the first adduct, (ii) the polyethyleneimine intermediate or the second adduct, and (iii) when present, the third adduct, with optionally a polyol and optionally a third multifunctional crosslinker to form an oil phase;
(e) dissolving a water-soluble polymer in water to form an aqueous phase;
(f) combining the oil phase and the aqueous phase to form an oil-in-water emulsion; and
(g) applying the emulsion onto a surface and allowing the emulsion to dry and cure on the surface to form the polymer or interpenetrating polymer network on the surface.

209.-218. (canceled)
